(19) United States
(12) Patent Application Publication
(10) Pub. No.: US 2006/0064233 A1
(43) Pub. Date: Mar. 23, 2006

(54) Traffic information providing system, a traffic information expressing method and device

(75) Inventors: Shinya Adachi, Kanagawa (JP); Rie Ikeda, Tokyo (JP)

Correspondence Address: PEARNE & GORDON LLP, 1801 EAST 9TH SRTEET, SUITE 1200, CLEVELAND, OH, 44114-3108, US

(73) Assignee: Matsushita Electric Industrial Co., Ltd., Kadoma-shi, Osaka (JP)

(21) Appl. No.: 10/542,942

(22) PCT Filed: Jan. 21, 2004
(86) PCT No.: PCT/JP04/00483

§ 371 Date: Jul. 21, 2005

(30) Foreign Application Priority Data
Jan. 22, 2003 (JP) 2003-013746
Jan. 23, 2003 (JP) 2003-014802
Aug. 5, 2003 (JP) 2003-286748

(51) Int. Cl. G08G 1/00

(52) U.S. Cl. 701/117

(57) ABSTRACT

The invention has as an object to provide a traffic information providing system capable of compressing traffic information represented at an arbitrary detail level to a data volume corresponding to a different communications environment. The traffic information providing system includes: traffic information providing apparatus including means for generating sampling data from traffic information represented by a function of distance from a reference position on a road or a function of time and means for performing discrete wavelet transform on the sampling data to convert the traffic information to scaling coefficients and wavelet coefficients; and traffic information utilization apparatus for performing inverse wavelet transform on the scaling coefficients and wavelet coefficients received from the traffic information providing apparatus to restore the traffic information. The receiving party can restore coarse or minute information within the range of the received information even in case the traffic information providing apparatus has provided scaling coefficients and wavelet coefficients without considering the communications environment and reception state.

### TECHNICAL FIELD

The present invention relates to a method for providing traffic information such as congestion and travel time, a system for implementing the method, and apparatus constituting the system, and in particular to such a method, a system and apparatus which facilitates restoration of traffic information at a receiving party.

The present invention also relates to a method for providing traffic information, a system for implementing the method, and apparatus therefor, and in articulate to such a method, a system and apparatus which provides correct speed information of a traffic flow.

### BACKGROUND TECHNOLOGY

### Background Art

VICS (Vehicle Information and Communication System) which currently provides a car navigation system with a traffic information providing system collects and edits traffic information and transmits traffic congestion information and travel time information representing the time required by way of an FM multiplex broadcast or a beacon (refer to Japanese Patent Laid Open No. 2001-194170).

The current VICS information represents the current traffic information as follows:

Traffic situation is displayed in three levels, congestion (ordinary road: ≦10 km/h; expressway: ≦20 km/h); heavy traffic (ordinary road: 10-20 km/h; expressway: 20-40 km/h); and light traffic (ordinary road: ≧20 km/h; expressway: ≧40 km/h).

The traffic congestion information representing the traffic congestion is displayed as

“VICS link number+state (congestion/heavy traffic/light traffic/unknown)” in case the entire VICS link (position information identifier used by VICS) is congested uniformly.

In case only part of the link is congested, the traffic congestion information representing the traffic congestion is displayed as

“VICS link number+congestion head distance (distance from beginning of link)+congestion end (distance from beginning of link)+state (congestion)”

In this case, when the congestion starts from the start end of a link, the head congestion distance is displayed as 0xff. In case different traffic situations coexist in a link, each traffic situation is respectively described in accordance with this method.

The link travel time information representing the travel time of each link is displayed as “VICS link number+travel time”

As prediction information representing the future change trend of traffic situation, an increase/decrease trend graph showing the four states, “increase trend/decrease trend/no change/unknown” is displayed while attached to the current information.

VICS traffic information displays traffic information while identifying a road with a link number. The receiving party of this traffic information grasps the traffic situation of the corresponding road on its map based on the link number. The system where the sending party and receiving party shares link numbers and node numbers to identify a position on the map requires introduction or a change in new link numbers and node numbers each time a road is constructed anew or changed. With this, the data on the digital map from each company needs updating so that the maintenance requires huge social costs.

In order to offset these disadvantages and transmitting a road position independently of a VICS number, a system is present where a sending party arbitrarily sets a plurality of nodes on a road shape and transmits a “shape vector data string” representing the node position by a data string and a receiving party uses the shape vector data string to perform map matching in order to identify a road on a digital map (refer to WO 01/18769 A1).

A system has been proposed which generates traffic information as mentioned below:

As shown in FIG. 41A, a shape vector (road) having a distance of X m is equidistantly segmented from a reference node by a unit block length (Example: 50-500 m) to perform sampling. As shown in FIG. 41B, the average speed of a vehicle passing through each sampling point is obtained. In FIG. 41B, the value of the obtained speed (state volume) is shown in a square representing the quantization unit set through sampling. In this case, the average travel time or congestion rank of a vehicle passing through each sampling interval may be obtained as a state volume instead of the average speed.

The state volume of traffic information changing along a road (FIG. 41B) is communicated to the receiving party. In this practice, the transmission data volume must be reduced. To this end, for example, the state volume is quantized and is represented by a difference from the statistical prediction value and converted to data unevenly distributed around 0, and the obtained data is variable-length encoded.

Or, the state volume of traffic information (FIG. 41B) changing along a road is assumed as a function of distance from the reference node and is converted to a frequency component, then the coefficient value of each frequency component is provided to the receiving party. The receiving party executes inverse transform to reproduce the state volume of traffic information.

The conversion to frequency components uses approaches such as FFT (Fast Fourier Transform) and DCT (Discrete Cosine Transform). For example, the Fourier Transform technique can obtain a Fourier coefficient C(k) from a finite number of discrete values (state volume) represented by a complex function f (by way of Expression 21: Fourier Transform).
C(k)=(1/n) Σf(j)·ω−jk(k=0, 1, 2, . . . ,n−1) (Expression 21)
(Σ means sum from j=0to n−1)

When C(k) is given, a discrete value (state volume) is obtained by way of Expression 22 (Inverse Fourier Transform):
F(j)=ΣC(k)·ωjk(j=0, 1, 2, . . . , n−1) (Expression 22)
(Σ means sum from k=0 to n−1)

A party which provides traffic information converts the state volume of traffic information (FIG. 41B) to n (=2^{N}) coefficients by using (Expression 21) and quantizes the coefficient. The value obtained through the quantization is obtained as follows: a coefficient of a low frequency is divided by 1; as a coefficient pertains to a higher frequency, a larger value than 1 is used to divide the coefficient, and the fraction is rounded. The quantized value is compressed through variable length compression and is then transmitted. In this case, the data structure of traffic information is as shown in FIG. 42B. The traffic information and the shape vector data string information on the target road shown in FIG. 42A are transmitted to the receiving party.

The receiving party which has received the traffic information decodes and dequantizes the coefficients and reproduces the state volume of traffic information by using (Expression 22).

The traffic information providing method has the following problems:

(1) The data used to generate traffic information is collected by using a sensor such as an ultrasonic vehicle sensor installed at a road or a vehicle (probe car) provided with a feature to accommodate/transmit travel data. From a probe car, information such as a vehicle position, travel distance and speed is transmitted to a traffic information center at all times. Thus, minute sate volume of traffic information is collected from a road where a probe car travels frequently or where sensors are densely installed. From a road where sensors are installed at long intervals, only coarse state volume of traffic information is obtained.

In transmitting compressed traffic information to a receiving party, it is necessary to perform encoding/compression of data using a same system even when data is collected by way of different approaches as mentioned above. This process is necessary to allow the receiving party to precisely reproduce traffic information by way of the same processing irrespective of how the data is collected.

Note that, in case the state volume of traffic information is compressed using DCT or FFT, data reproduction accuracy at the receiving party drops when the data is coarse.

(2) In providing traffic information, the data volume which can be retained by the receiving party or transmission capacity is limited, the method for traffic information must have a twist so that more important information, not to say less important information as well, is displayed at the receiving party, without simply letting data in excess overflow.

When such an approach is attempted in a system which converts the traffic state volume to statistically maldistributed data followed by variable length encoding, the sending party must acquire the information on the capability of the receiving party and transmission capacity and change the data creation method accordingly, which is an extreme load on the sending party.

(3) Indicators of traffic congestion provided as traffic information may be “speed,” “unit section travel time,” and “congestion.” At the receiving party of traffic information, the information of “speed” is the easiest to use with respect to display of traffic information and use in path calculation. In case the “speed” information is transmitted as traffic state volume changing along a road, a plurality of state volumes could be averaged to reduce the overall data due to limitation of data reception capacity at the receiving party or transmission capacity of the transmission path. This could acquire a value which does not correspond to the level of congestion the driver is actually experiencing.

For example, assume that a distance of 90 km is traveled at 100 k/m and a distance of 10 km at 4 km/h. The time required in this case is 3.4 hours [=(90÷100)+(10÷4)] and the average speed in this section is 29.4 km/h[=100÷3.4].

When the speed value in this section is simply smoothed (averaged), the value obtained is 90.4 km[=(100×90+4×10)÷(90+10)]. The time required in case a section of 100 km is traveled at this average speed is 1.11 hours. That is, in case a speed value is simply averaged, the value obtained does not correspond to the level of congestion the driver is actually experiencing.

### DISCLOSURE OF THE INVENTION

The invention solves the foregoing related art problems and has as an object to provide a traffic information providing method which can be applied, without changing the compression method, to minute data capable of representing traffic information at a high resolution, which can round off the data depending on the communications environment, and which allows the receiving party to select the minuteness of information to be restored while the data has been transmitted without considering the data reception state, a system and apparatus which implement the method.

Further, the invention has as an object to provide a traffic information providing system which allows the receiving party to select the minuteness of information to be restored while the sending party has transmitted the data without considering the data reception state, a system and apparatus which implement the method.

The traffic information providing method according to the invention performs discrete wavelet transform on the traffic information represented by a function of distance from a reference position on a road and provides traffic information transformed into scaling coefficients and wavelet coefficients.

The traffic information providing method also performs discrete wavelet transform on the traffic information represented by a function of time and provides traffic information transformed into scaling coefficients and wavelet coefficients.

The receiving party can approximately restore traffic information as long as the scaling coefficients are received, even in case only some of the wavelet coefficients are received. The discrete wavelet transform approximates original data so as to average the same. Thus, an overshoot as approximation over the original data or an undershoot as approximation under the original data does not occur. This makes it possible to perform proper approximation irrespective of whether the collected traffic data is coarse or minute.

The invention provides a traffic information providing system comprising: traffic information providing apparatus for generating sampling data from traffic information represented by a function of distance from a reference position on a road, performing one or more discrete wavelet transform processes on the sampling data, converting the traffic information to scaling coefficients and wavelet coefficients, and providing the coefficients; and traffic information utilization apparatus for performing one or more inverse discrete wavelet transform processes on scaling coefficients and wavelet coefficients received from the traffic information providing apparatus in order to restore traffic information.

The invention also provides a traffic information providing system comprising: traffic information providing apparatus for using traffic information measured at a fixed time pitch as sampling data, performing one or more discrete wavelet transform processes on the sampling data to convert the traffic information to scaling coefficients and wavelet coefficients, and providing the coefficients; and traffic information utilization apparatus for performing one or more inverse discrete wavelet transform processes on scaling coefficients and wavelet coefficients received from the traffic information providing apparatus in order to restore traffic information.

In these systems, the receiving party can restore coarse or minute information within the range of the received information even in case the traffic information providing apparatus has provided scaling coefficients and wavelet coefficients without considering the communications environment and reception state.

The traffic information providing apparatus of the invention comprises: traffic information conversion means for generating sampling data from the collected traffic information; traffic information encoding means for performing one or more discrete wavelet transform processes on the sampling data to convert the traffic information to scaling coefficients and wavelet coefficients; and traffic information transmission means for transmitting the scaling coefficients earlier than the wavelet coefficients and transmitting, among the wavelet coefficients, high-order wavelet coefficients earlier than low-order wavelet coefficients.

Thus, the receiving party can restore approximate traffic information as long as scaling coefficients can be received, even in case only some of the wavelet coefficients are received.

The traffic information utilization apparatus of the invention comprises: traffic information reception means for receiving from the traffic information providing apparatus the road section reference data representing the target road of traffic information and scaling coefficients and wavelet coefficients as the traffic information; target road determination means for identifying the target road of the traffic information by using the road section reference data; and traffic information decoding means for performing one or more inverse discrete wavelet transform processes on the scaling coefficients and wavelet coefficients in order to restore the traffic information.

This apparatus identifies the target section of traffic information by way of map matching and restores the traffic information by using the inverse discrete wavelet transform.

As mentioned above, the traffic information providing method of the invention can approximately restore traffic information even in case the receiving party can receive only some of the information provided due to insufficient communications environment or data reception capability, or even in case only data in some of the layers is transmitted due to insufficient transmission capability of the sending party. In such a case, an overshoot or undershoot does not occur at data restoration. This makes it possible to perform proper approximation irrespective of whether the collected traffic data is coarse or minute.

In the traffic information providing system of the invention, the receiving party can restore coarse or minute information within the range of the received information even in case the party which provides traffic information has provided traffic information without considering the communications environment and reception state.

The traffic information providing apparatus and traffic information utilization apparatus of the invention can implement the system.

The traffic information providing method of the invention performs discrete wavelet transform on the reciprocal of speed information represented by a function of distance from a reference position on a road, converts the reciprocal of the speed information to scaling coefficients and wavelet coefficients and provides the coefficients.

The receiving party can approximately restore traffic information as long as the scaling coefficients are received, even in case only some of the wavelet coefficients are received. While original data is averaged to perform approximation in the discrete wavelet transform, the traffic information providing method of the invention obtains the reciprocal of speed information (representing travel time per unit distance) to perform wavelet transform. Thus the arithmetical mean is adequate and reproduces speed information which corresponds to the level of congestion the driver is actually experiencing.

The invention provides a traffic information providing system comprising traffic information providing apparatus for generating sampling data from traffic information represented by a function of distance from a reference position on a road, performing one or more discrete wavelet transform processes on the reciprocal of the sampling data, converting the reciprocal of the traffic information to scaling coefficients and wavelet coefficients, and providing the coefficients; and traffic information utilization apparatus for performing one or more inverse discrete wavelet transform processes on scaling coefficients and wavelet coefficients received from the traffic information providing apparatus in order to restore traffic information by converting the obtained value to its reciprocal.

In this system, the receiving party can restore coarse or minute information within the range of the received information even in case the traffic information providing apparatus has provided scaling coefficients and wavelet coefficients without considering the communications environment and reception state. The restored speed information well matches the level of congestion the driver is actually experiencing.

The traffic information providing apparatus of the invention comprises: traffic information conversion means for generating 2^{N} sampling data items or a multiple of the 2^{N} sampling data items from the collected speed information data; and traffic information encoding means for performing one or more discrete wavelet transform processes on the reciprocal of the sampling data to convert the reciprocal to scaling coefficients and wavelet coefficients; and traffic information transmission means for transmitting the scaling coefficients earlier than the wavelet coefficients and transmitting, among the wavelet coefficients, high-order wavelet coefficients earlier than the low-order coefficients.

The receiving party can thus restore speed information represented at a coarse resolution as long as the scaling coefficients are received, even in case only some of the wavelet coefficients are received.

The traffic information utilization apparatus of the invention comprises: traffic information reception means for receiving from the traffic information providing apparatus road section reference data representing the target road of speed information as well as scaling and wavelet coefficients as speed information; target road determination means for identifying the target road of speed information by using the road section reference data; and traffic information decoding means for performing one or more inverse discrete wavelet transform processes on the scaling coefficients and wavelet coefficients and converting the obtained value to its reciprocal in order to restore the speed information.

This apparatus identifies the target section of speed information by way of map matching and performs inverse discrete wavelet transform and transform of the reciprocal to restore the original data.

### BRIEF DESCRIPTION OF THE DRAWINGS

FIG. 1 shows a general expression for wavelet transform;

FIG. 2A shows a forward transform filter circuit and an inverse transform filter circuit to implement DWT;

FIG. 2B shows an inverse transform filter circuit to implement DWT;

FIG. 3A shows separation of a signal in DWT;

FIG. 3B shows reconstruction of a signal in IDWT;

FIG. 4A shows a filter circuit to implement DWT according to an embodiment of the invention;

FIG. 4B shows a filter circuit to implement IDWT according to an embodiment of the invention;

FIG. 5 is a block diagram showing a traffic information providing system according to the first and fifth embodiments of the invention;

FIG. 6 shows measurement points of a robe car;

FIG. 7 shows measurement data of a probe car;

FIG. 8 shows speeds represented by a function of distance;

FIG. 9 shows congestion ranks generated from sensor information;

FIG. 10 shows travel time information generated from sensor information;

FIG. 11 shows a map displaying congestion ranks;

FIG. 12 shows congestion ranks represented by a function of distance;

FIG. 13 shows travel time represented by a function of distance;

FIG. 14 is a flowchart showing the operation of a traffic information providing system according to the first embodiment of the invention;

FIG. 15 is a flowchart showing the sampling procedure for traffic information according to the first embodiment of the invention;

FIG. 16 shows a method for sampling speed data according to the first embodiment of the invention;

FIG. 17 shows a method for sampling congestion levels according to the first embodiment of the invention;

FIG. 18 is a flowchart showing the DWT procedure for traffic information according to the first embodiment of the invention;

FIG. 19 shows transition of scaling coefficients accompanying DWT according to the first embodiment of the invention;

FIG. 20 shows transition of scaling coefficients accompanying a high-order DWT according to the first embodiment of the invention;

FIG. 21A shows the transmit data generation process by DWT according to the first embodiment of the invention;

FIG. 21B shows the transmit data generation process by DWT according to the first embodiment of the invention;

FIG. 21C shows the transmit data generation process by DWT according to the first embodiment of the invention;

FIG. 21D shows the transmit data generation process by DWT according to the first embodiment of the invention;

FIG. 21E shows the transmit data generation process by DWT according to the first embodiment of the invention;

FIG. 21F shows the transmit data generation process by DWT according to the first embodiment of the invention;

FIG. 21G shows the transmit data generation process by DWT according to the first embodiment of the invention;

FIG. 22A shows the data structure of transmit data according to the first embodiment of the invention;

FIG. 22B shows the data structure of transmit data according to the first embodiment of the invention;

FIG. 22C shows the data structure of transmit data according to the first embodiment of the invention;

FIG. 23 shows an IDWT procedure for traffic information according to the first embodiment of the invention;

FIG. 24 shows a data restoration process by IDWT according to the first embodiment of the invention;

FIG. 25A shows original data and restored data in DWT/IDWT according to the first embodiment of the invention;

FIG. 25B shows original data and restored data in DWT/IDWT according to the first embodiment of the invention;

FIG. 26 illustrates restored data which can be generated from part of the transmit data FIG. 25A shows original data and restored data according to the first embodiment of the invention;

FIG. 27 illustrates restored data in DWT according to the first embodiment of the invention;

FIG. 28 illustrates restored data in DWT;

FIG. 29A illustrates road section reference data;

FIG. 29B illustrates road section reference data;

FIG. 29C illustrates road section reference data;

FIG. 30 illustrates bit plane decomposition according to the second embodiment of the invention;

FIG. 31 shows a transmit data generation procedure according to the second embodiment of the invention;

FIG. 32 shows encryption in the traffic information providing system according to the second embodiment of the invention;

FIG. 33 shows the configuration of a traffic information providing system according to the third embodiment of the invention;

FIG. 34 illustrates traffic information provided in the fourth embodiment of the invention;

FIG. 35 shows a transmit data generation procedure according to the fourth embodiment of the invention;

FIG. 36 shows an IDWT procedure for traffic information according to the fourth embodiment of the invention;

FIG. 37 shows restored data according to the fourth embodiment of the invention;

FIG. 38 restored data according to the fourth embodiment of the invention with coordinate axes exchanged with each other;

FIG. 39 illustrates locus information in a space-time;

FIG. 40 illustrates locus information displayed on a space plane;

FIG. 41 illustrates traffic information as a state volume changing along a road;

FIG. 42 shows the data structure of traffic information provided;

FIG. 43 shows the relationship between original data and a scaling coefficient generated by a first-order DWT;

FIG. 44 shows the relationship between original data and a scaling coefficient generated by a high-order DWT;

FIG. 45 is a flowchart showing the operation of a traffic information providing system according to the fifth embodiment of the invention;

FIG. 46 is a flowchart showing the sampling procedure for speed information according to the fifth embodiment of the invention;

FIG. 47 is a flowchart showing the sampling procedure for speed data according to the fifth embodiment of the invention;

FIG. 48 shows a DWT procedure for speed information according to the fifth embodiment of the invention;

FIG. 49A shows a specific example of application of DWT and IDWT according to the fifth embodiment of the invention;

FIG. 49B shows another specific example of application of DWT and IDWT according to the fifth embodiment of the invention;

FIG. 49C shows another specific example of application of DWT and IDWT according to the fifth embodiment of the invention;

FIG. 49D shows another specific example of application of DWT and IDWT according to the fifth embodiment of the invention;

FIG. 49E shows another specific example of application of DWT and IDWT according to the fifth embodiment of the invention;

FIG. 49F shows another specific example of application of DWT and IDWT according to the fifth embodiment of the invention;

FIG. 49G shows another specific example of application of DWT and IDWT according to the fifth embodiment of the invention;

FIG. 49H shows another specific example of application of DWT and IDWT according to the fifth embodiment of the invention;

FIG. 49I shows another specific example of application of DWT and IDWT according to the fifth embodiment of the invention;

FIG. 49J shows another specific example of application of DVFT and IDWT according to the fifth embodiment-of the invention;

FIG. 50 shows original data and restored data of speed information according to the first embodiment of the invention;

FIG. 51 shows original data and restored data of the reciprocals of speed information according to the first embodiment of the invention;

FIG. 52A shows the data structure of transmit data according to the fifth embodiment of the invention;

FIG. 52B shows the data structure of transmit data according to the fifth embodiment of the invention;

FIG. 52C shows the data structure of transmit data according to the fifth embodiment of the invention;

FIG. 53 is a flowchart showing the IDWT procedure for speed information according to the fifth embodiment of the invention;

FIG. 54 shows restored data obtained by multiplying the reciprocals of speed information according to the fifth embodiment of the invention by a small constant;

FIG. 55A illustrates road section reference data;

FIG. 55B illustrates road section reference data;

FIG. 55C illustrates road section reference data;

FIG. 56 is a flowchart showing the DWT procedure according to the sixth embodiment of the invention;

FIG. 57 illustrates noise to be removed by the traffic information providing method according to the sixth embodiment of the invention;

FIG. 58 shows original data and restored data of speed information according to the sixth embodiment of the invention;

FIG. 59 shows the configuration of a traffic information providing system according to the seventh embodiment of the invention;

Reference numerals throughout the figures represent: 10: Traffic information measurement apparatus; 11: Sensor processor A; 12: Sensor processor B; 13: Sensor processor C; 14: Traffic information calculator; 15: Traffic information transmitter; 21: Sensor A (ultrasonic vehicle sensor); 22: Sensor B (AVI sensor); 23: Sensor C (probe car); 30: Traffic information transmitter; 31: Traffic information collector; 32: Quantization unit determination section; 33: Traffic information converter; 34: DWT encoder; 35: Information transmitter; 36: Digital map database; 50: Encoding table creating section; 51: Encoding table calculator; 53: Traffic information quantization table; 54: Distance quantization unit parameter table; 60: Receiving party apparatus; 61: Information receiver; 62: Decoder; 63: Map matching and section determination section; 64: Traffic information reflecting section; 66: Link cost table; 67: Information utilization section; 68: Local vehicle position determination section; 69: GPS antenna; 70: Gyroscope; 71: Guidance apparatus; 80: Probe car collection system; 81: Travel locus measurement information utilization section; 82: Encoded data decoder; 83: Travel locus receiver; 84: Encoding table transmitter; 85: Encoding table selector; 86: Encoding table data; 87: Measurement information data inverse transform section; 90: Probe-car-mounted machine; 91: Travel locus transmitter; 92: DWT encoder, 93: Local vehicle position determination section; 94: Encoding table receiver; 95: Encoding Stable data, 96: Travel locus measurement information accumulating section; 97: Measurement information data converter; 98: Sensor information collector; 101: GPS antenna; 102: Gyroscope; 106: Sensor A; 107: Sensor B; 108: Sensor C; 181: Low-pass filter; 182: High-pass filter; 183: Thinning circuit; 184: Low-pass filter; 185: High-pass filter; 186: Thinning circuit; 187: Adder circuit; 191: Filter circuit; 192: Filter circuit; 193: Filter circuit

### BEST MODE FOR CARRYING OUT THE INVENTION

Embodiments of the application will be described referring to drawings.

### First embodiment

<Discrete Wavelet Transform>

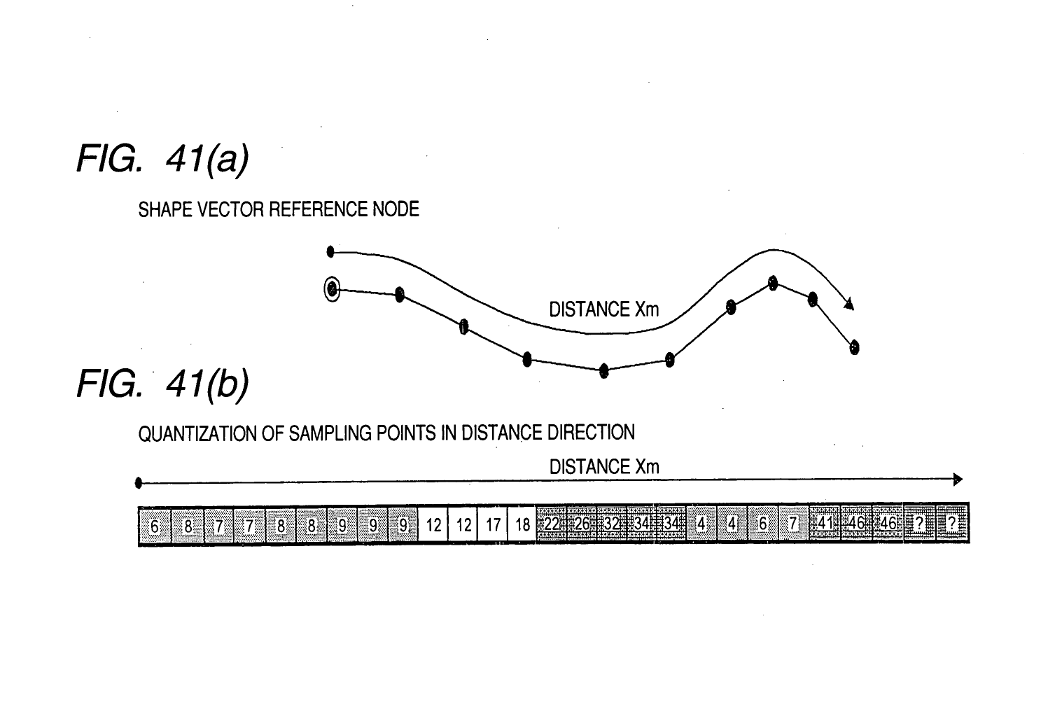

The invention compresses the state volume changing along a road (FIG. 41B) by using discrete wavelet transform (DWT) employed as a system for compressing image data or voice data

DWT may use a variety of filters. The following describes a case where a 2×2 filter for DWT (a filter which generates a single wavelet coefficient from two inputs and a single scaling coefficient from two inputs). The 2×2 filter thins out sampling data by half so that the number of data items must be a multiple of 2^{N}.

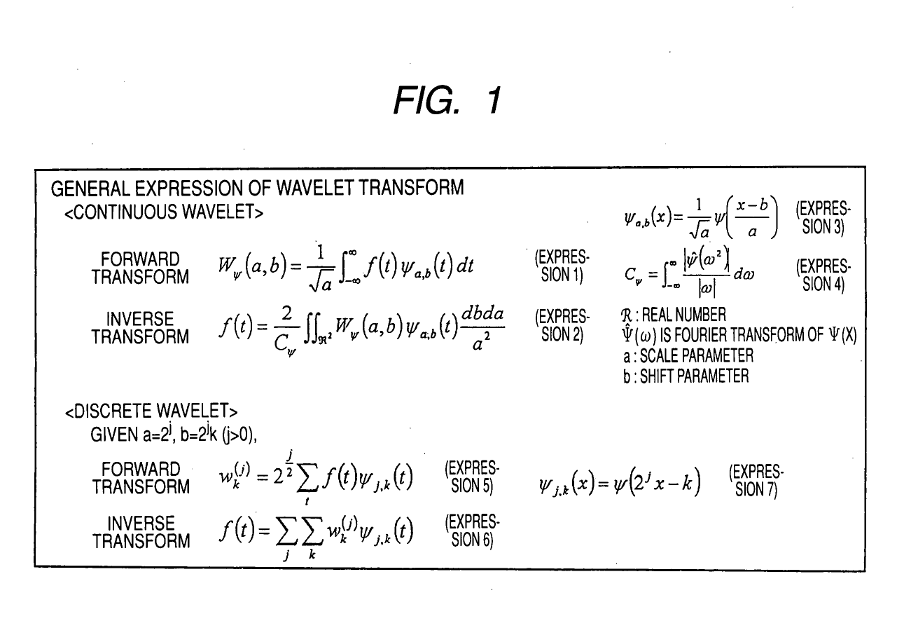

The general expression of DWT is shown in FIG. 1.

Wavelet refers to a set of functions such as (Expression 3) obtained by multiplying by a (scaling operation) on a time axis, and shifting by b in terms of time on a function Ψ(t) called basic wavelet which is present within a range in terms of time and frequency. By using this function, it is possible to extract the frequency and time components of a signal corresponding to the parameters a, b. This operation is called wavelet transform.

Wavelet transform includes continuous wavelet transform and discrete wavelet transform. Forward transform of continuous wavelet transform is shown in (Expression 1) and inverse transform thereof is shown in (Expression 2). Given the real numbers a=2j and b=2jk (j>0), forward transform of discrete wavelet transform (DWT) is as shown in (Expression 5) and inverse transform thereof (IDWT) is as shown in (Expression 6). Ψ

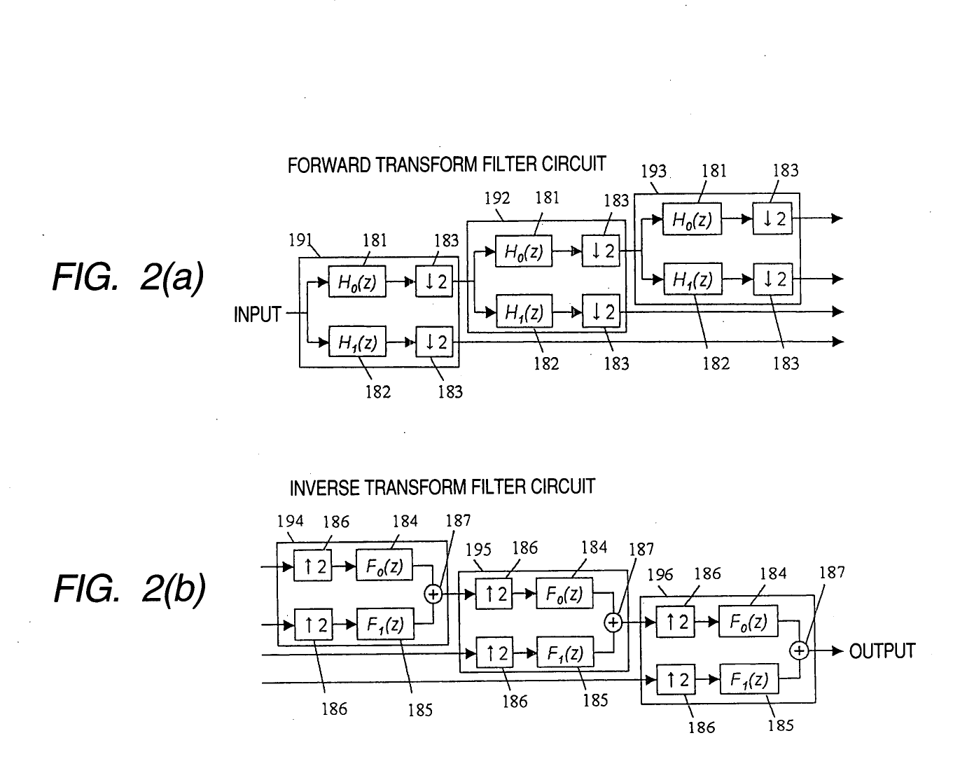

The DWT is performed with a filter circuit which reciprocally splits a low frequency range. IDWT is performed with a filter circuit which repeats synthesis opposite to the splitting process. FIG. 2A shows a DWT filter circuit. The DWT circuit comprises a cascade connection of a plurality of circuits 191, 192, 193 each including a low-pass filter 181, a high-pass filter 182, and a thinning circuit 183 for thinning out a signal by half. The high-frequency components of a signal input to the circuit 191 pass through the high-pass filer 182, thinned out by half in the thinning g circuit 183 and output therefrom. The low-frequency components pass through the low-pass filer 181 and thinned out by half in the thinning circuit 183 and input to the next circuit 192. In the circuit 192, same as the circuit 191, the high-frequency components are thinned out and output, and the low-frequency components are thinned out and input to the next circuit 193 and are similarly split into high-frequency components and low-frequency components.

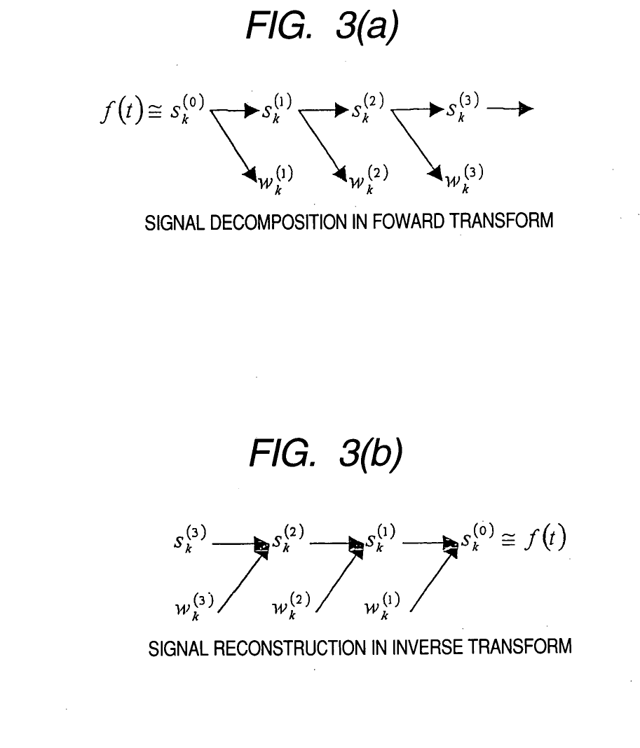

FIG. 3A shows signals decomposed by the DWT circuits 191, 192, 193. An input signal f(t)(≡Sk⁽⁰⁾; where a superscript represents a number of order) is split, in the circuit 191, into a signal Wk⁽¹⁾ which has passed the high-pass filter 182 and a signal Sk⁽¹⁾ which has passed the low-pass filter 181. The signal Sk⁽¹⁾ is split, in the circuit 192, into a signal Wk⁽²⁾ which has passed the high-pass filter 182 and a signal Sk⁽²⁾ which has passed the low-pass filter 181. The signal Sk⁽²⁾ is split, in the circuit 193, into a signal Wk⁽³⁾ which has passed the high-pass filter 182 and a signal Sk⁽³⁾ which has passed the low-pass filter 181. The S(t) is called a scaling coefficient (or a low-pass filter) while W(t) is called a wavelet coefficient (or a high-pass filter).

The following (Expression 8) and (Expression 9) show DWT transform expressions used in the embodiments of the invention.
Step 1: w(t)=f(2t+1)−[{f(2t)+f(2t+2)}/2] (Expression 8)
Step 2: s(t)=f(2t)+[{w(t)+w(t−1)+2}/4] (Expression 9)

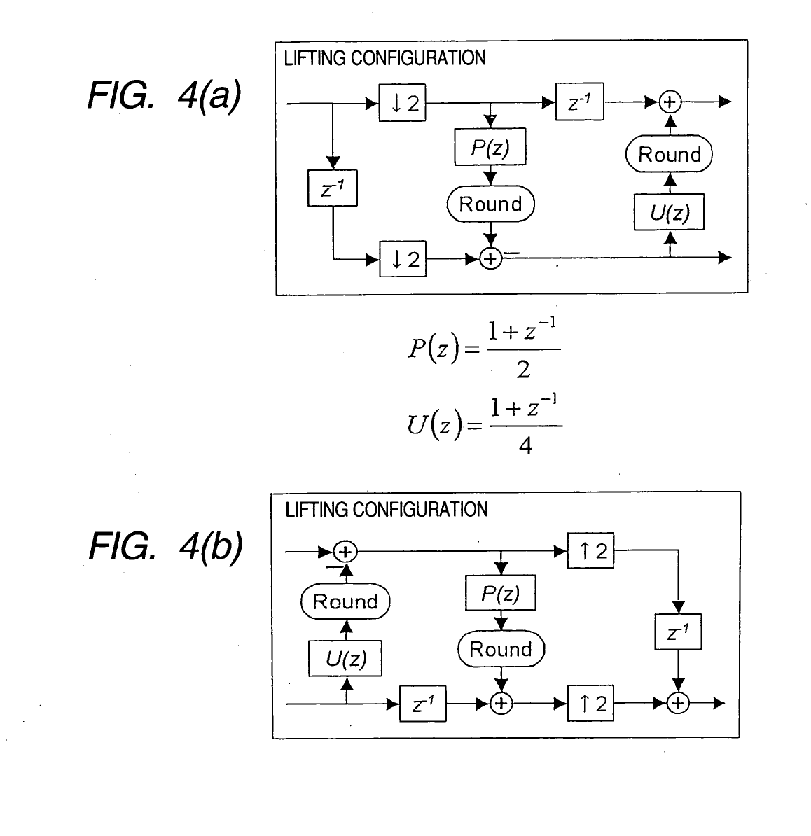

The nth-order forward transform converts a (n−1)th scaling coefficient by way of steps of (Expression 8) and (Expression 9). Configuration (2×2 filter) of each DWT circuit 191, 192, 193 to perform this conversion is shown in FIG. 4A. “Round” in the figure indicates a rounding process.

FIG. 2B shows an IDWT filter circuit. The IDWT circuit comprises a cascade connection of a plurality of circuits 194, 195, 196 each including an interpolation circuit 186 for interpolating a signal twice, a low-pass filter 184, a high-pass filter 185, and an adder for adding the outputs of the low-pass filter 184 and the high-pass filter 185. Signals of a low-frequency components and high-frequency components input to the circuit 194 are interpolated twice, added then input to the next circuit 195, where the signals are added to high-frequency components, added to high-frequency components in the next circuit 196, and output.

FIG. 3B shows signals reconstructed by the IDWT circuits 194, 195, 196. In the circuit 194, a scaling coefficient Sk⁽³⁾ is added to a wavelet coefficient Wk⁽³⁾ to generate a scaling coefficient Sk⁽²⁾. In the next circuit 195, the scaling coefficient Sk⁽²⁾ is added to the wavelet coefficient Wk⁽²⁾ to generate a scaling coefficient Sk⁽¹⁾. In the next circuit 196, the scaling coefficient Sk⁽¹⁾ is added to the wavelet coefficient Wk⁽¹⁾ to generate Sk⁽⁰⁾(≡f(t)).

The following (Expression 10) and (Expression 11) shows the IDWT transform expressions used in the embodiments of the invention.
Step 1: f(2t)=s(t)+[{w(t)+w(t−1)+2}/4] (Expression 10)
Step 2: f(2t+1)=w(t)−[{f(2t)+f(2t+2)}/2] (Expression 11)

The nth-order inverse transform uses signals transformed by way of the (n+1)th IDWT as a scaling coefficient to perform conversion in accordance with the steps of (Expression 10) and (Expression 11). Configuration of each IDWT circuit 194, 195, 196 to perform this conversion is shown in FIG. 4B.

<Traffic Information Providing System>

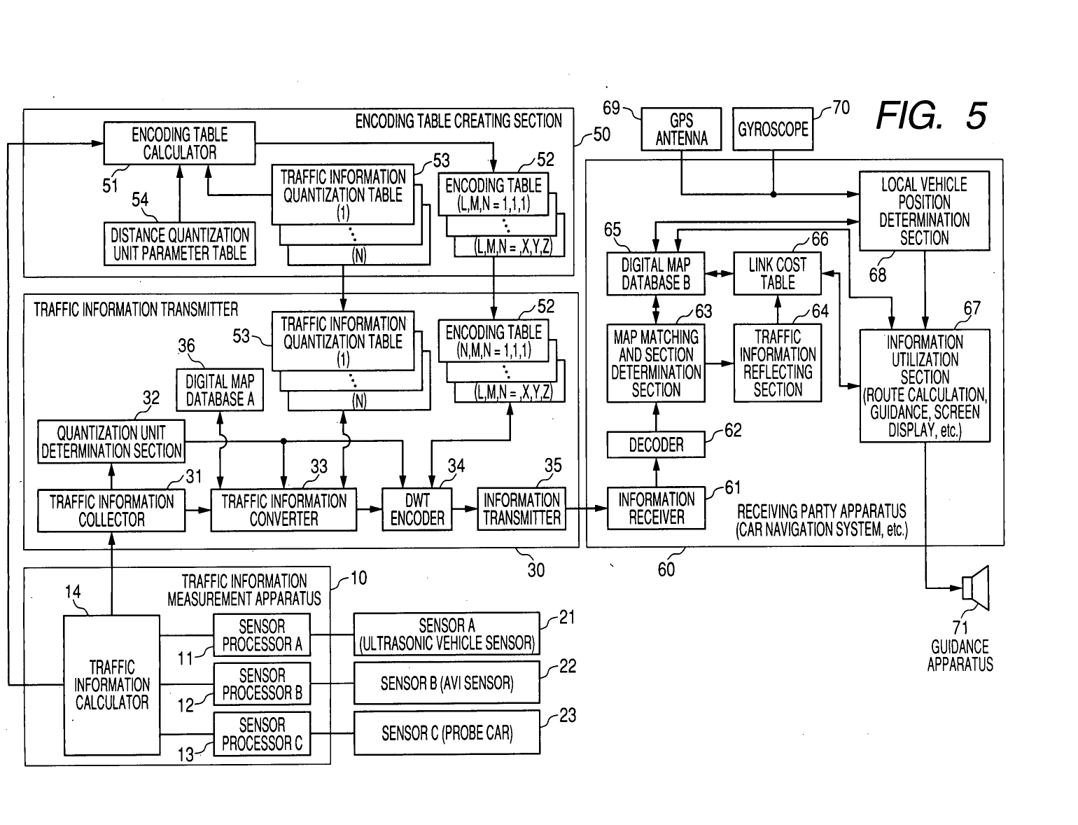

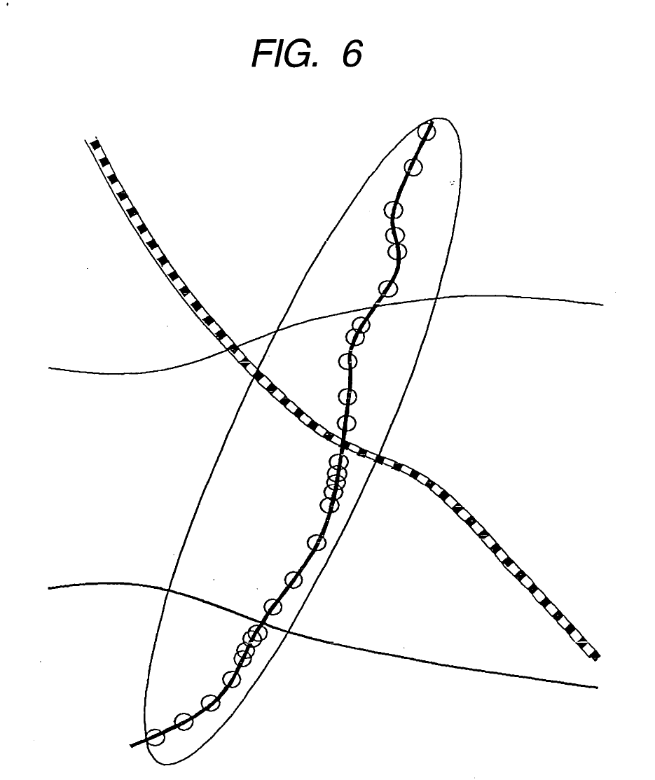

An example of traffic information providing system is shown in FIG. 5. This system comprises: traffic information measurement apparatus 10 for measuring traffic information by using a sensor A (ultrasonic vehicle sensor); a sensor B (AVI sensor) 22 and a sensor C (probe car) 23; an encoding table creating section 50 for creating, by using past traffic information, an encoding table to encode traffic information; a traffic information/attribute information generator/transmitter 30 for encoding traffic information and information on the target section and transmitting the resulting information; and receiving party apparatus 1060 such as car navigation apparatus for receiving and utilizing the transmitted information.

The traffic information measurement apparatus 10 comprises: a sensor processor A (11), a sensor processor B (12) and a sensor processor C (13) for collecting data from the sensors 21, 22, 23; and traffic information calculator 14 for processing the data transmitted from the sensor processors 11, 12, 13 to output data indicating the target section and the corresponding traffic information data.

The encoding table creating section 50 comprises plural types of traffic information quantization tables 53 used for quantization of scaling coefficients and wavelet coefficients generated by way of DWT, a distance quantization unit parameter table 54 for specifying plural types of sampling point intervals (unit block length); and an encoding table calculator 51 for creating various encoding tables 52 for variable-length encoding scaling coefficients and wavelet coefficients.

The traffic information transmitter 30 comprises: a traffic information collector 31 for receiving traffic information from the traffic information measurement apparatus 10; a quantization unit determination section 32 for determining the traffic situation based on the received traffic information, determining the unit block length of a sampling point interval (distance quantization unit) as well as a quantization table and an encoding table to be used; traffic information converter 33 for converting shape vector data on the target section to a statistical prediction difference value and determining sampling data used to generate traffic information; a DWT encoder 34 for performing DWT on the traffic information and encoding the shape vector of the target section; an information transmitter 35 for transmitting the encoded traffic information data and shape vector data; and a digital map database 36.

The receiving party apparatus 60 comprises: an information receiver 61 for receiving the information provided by the traffic information transmitter 30; a decoder 62 for decoding the received information to restore traffic information and a shape vector; a map matching and section determination section 63 for performing map matching of a shape vector by using the data in the digital map database 65 to determine the target section of traffic information; a traffic information reflecting section 64 for reflecting the received traffic information into the data for the target section in the link cost table 66; a local vehicle position determination section 68 for determining the local vehicle position by using a GPS antenna 69 and a gyroscope 70; an information utilization section 67 for utilizing the link cost table 66 for route search from the local vehicle position to the destination; and guidance apparatus 71 for performing voice guidance based on the route search result.

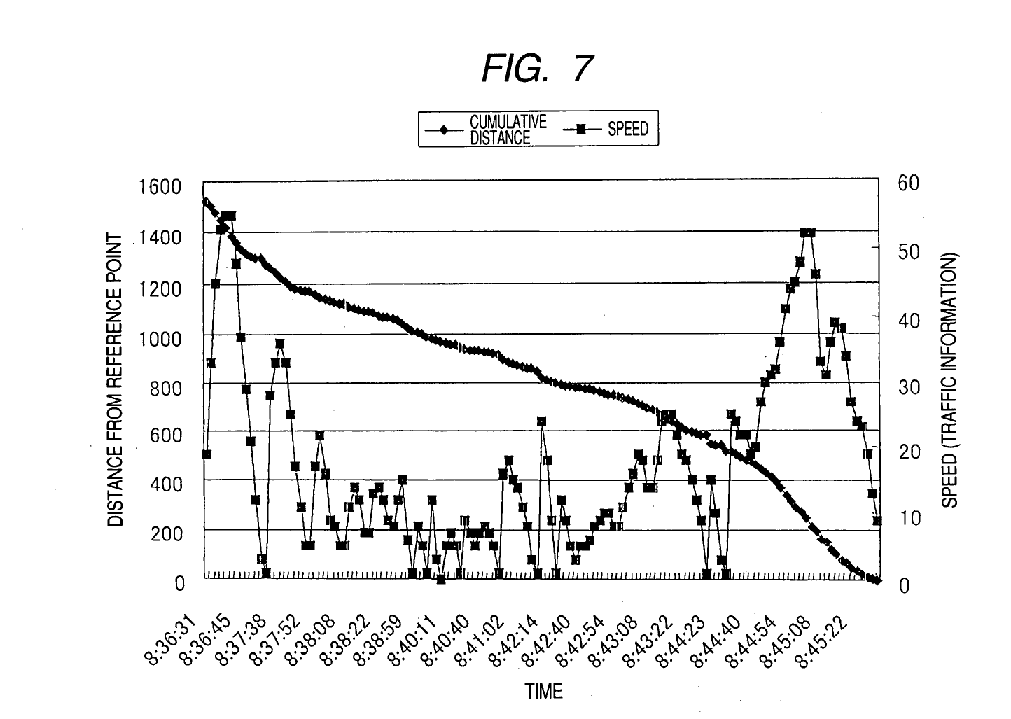

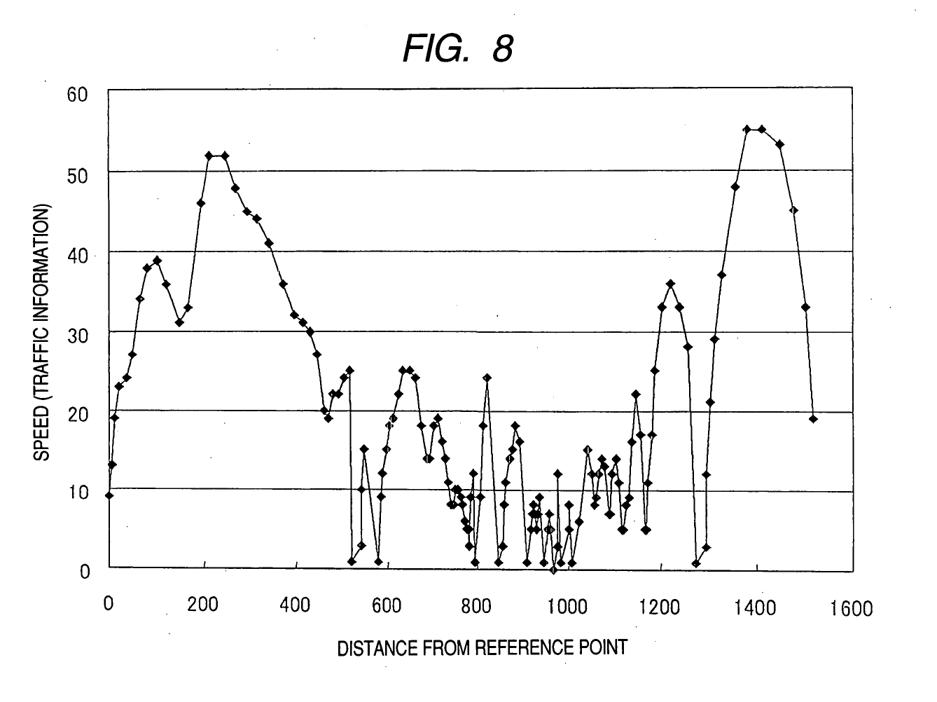

The sensor processor C 13 of the traffic information measurement apparatus 10 collects information such as the position coordinates, travel distance and speed of a vehicle measured by the probe car 23 in time units. FIG. 6 shows measurement point of the probe car 23 in circles. FIG. 7 is a graph showing the relationship between the cumulative travel distance and speed of the probe car created based on the data measured by the probe car 23 for example in units of 1 second. As shown in FIG. 8 the traffic information calculator 14 converts the speed to a function of distance from a reference point and outputs the data to the traffic information transmitter 30 and the encoding table creating section 50.

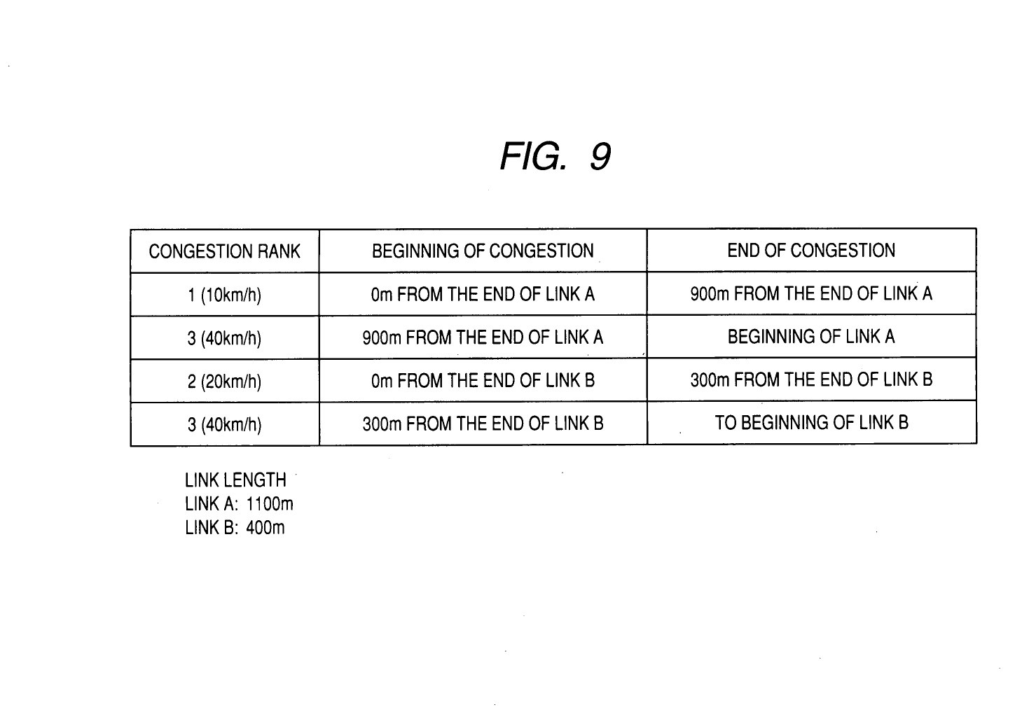

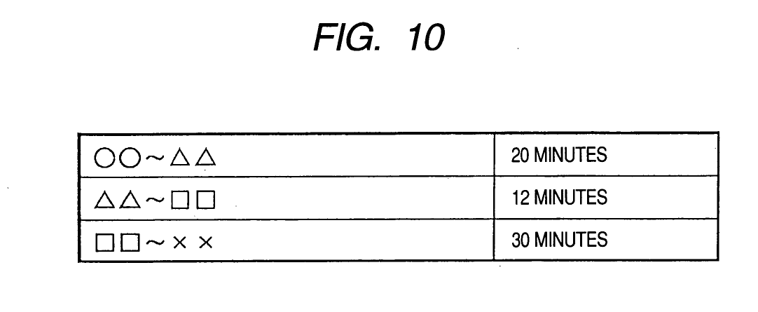

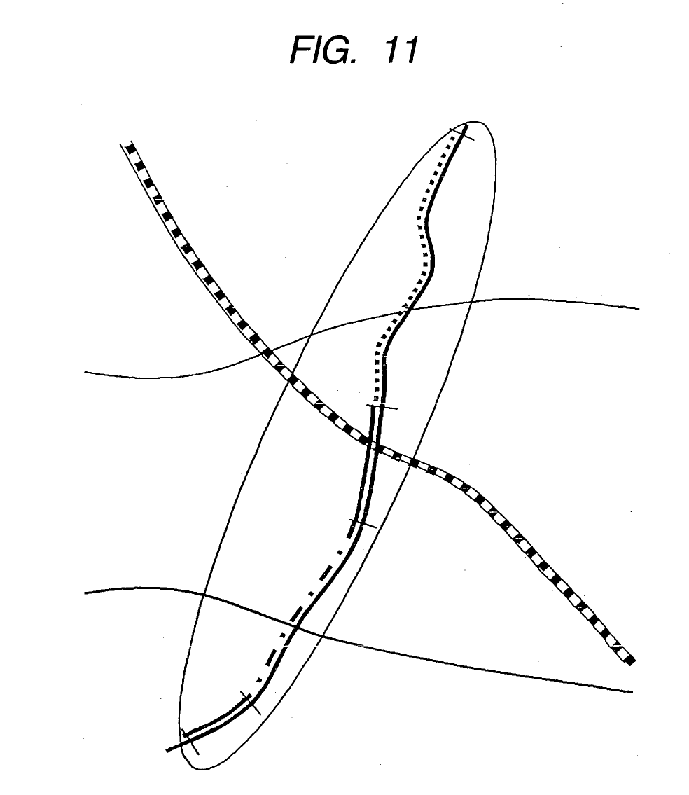

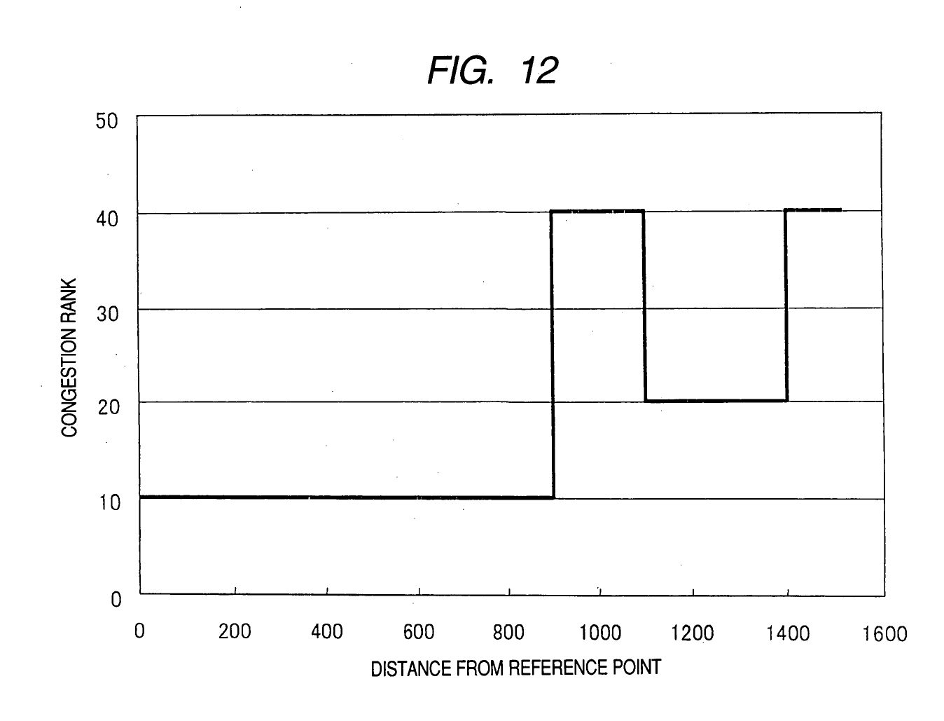

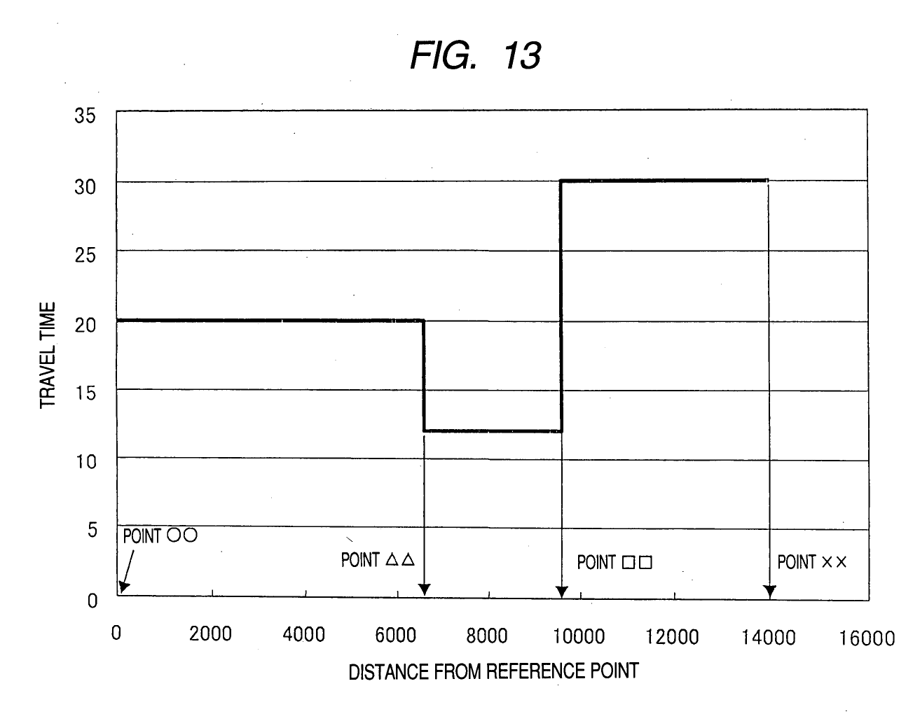

The sensor processor A11 and the sensor processor A12 of the traffic information measurement apparatus 10 collects information from sensors installed in various locations of a road and obtains the congestion rank of the road section as shown in FIG. 9 and travel time between the points is shown in FIG. 10. FIG. 11 shows a case where the congestion ranks created from the sensor information are displayed on the map in sold lines and dotted lines. The traffic information calculator 14 represents, as shown in FIG. 12, the congestion rank information as a function of distance from a reference point and outputs the data to the traffic information transmitter 30 and the encoding table creating section 50. The traffic information calculator 14 assumes a uniform function in sections of the same congestion rank. Similarly, the traffic information calculator 14 represents travel time information as a function of distance from a reference point and outputs the data to the traffic information transmitter 30 and the encoding table creating section 50. The traffic information calculator 14 assumes a uniform function for a travel time in the same section.

The travel time information may be a time required to pass through a sampling point interval (travel time divided by sampling point interval).

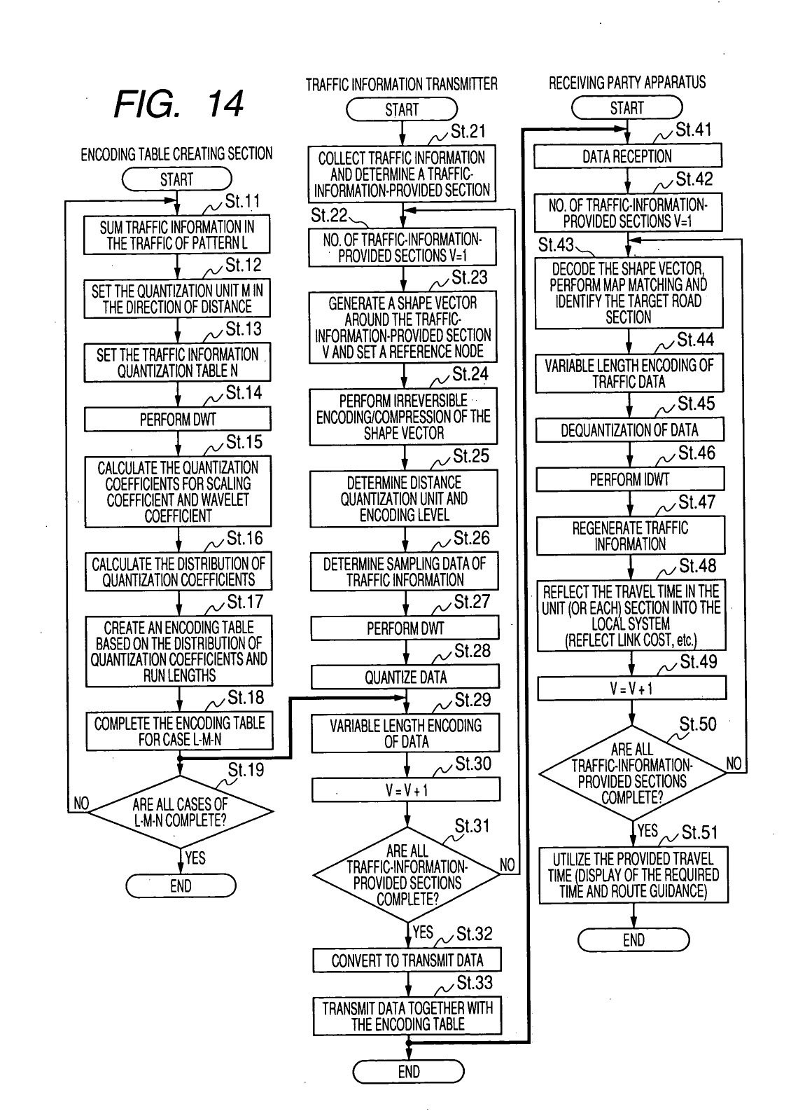

The flowchart of FIG. 14 shows the operation of the encoding table creating section 50, the traffic information transmitter 30 and the receiving party apparatus 60.

The encoding table calculator 51 of the encoding table creating section 50 analyzes the traffic patterns of traffic information transmitted from the traffic information measurement apparatus 10 and sums traffic information by pattern.

To create an encoding table, the encoding table calculator 51 sums traffic information in the traffic of pattern L (step 11), sets a distance quantization unit M from among the quantization units of the direction of distance (distance quantization units) described in the distance quantization unit parameter table 54 (step 12), and sets a traffic information quantization table N used to quantize scaling coefficients and wavelet coefficients from the traffic information quantization table 53 (step 13). Next, the encoding table calculator 51 calculates a value at each sampling point per interval M from the traffic information of the traffic at pattern L, and performs DWT on the value to obtain scaling coefficients and wavelet coefficients (step 14). The details of this procedure are given in the procedure of the traffic information transmitter 30.

Next, the encoding table calculator 51 uses the value specified in the traffic information quantization table N to quantize the scaling coefficients and wavelet coefficients and calculates the quantization coefficients of scaling coefficients and wavelet coefficients (step 15). Next, the encoding table calculator 51 calculates the distribution of the quantization coefficients (step 16) and creates the encoding table used to variable-length encode the quantization coefficients of scaling coefficients and wavelet coefficients based on the distribution of quantization coefficients and run lengths (step 17), (step 18).

This procedure is repeated until the encoding table 52 corresponding to all combinations of L, M and N is created (step 19).

In this way, numerous encoding tables 52 corresponding to various traffic patters and resolutions of traffic information representation are previously created and retained.

The traffic information transmitter 30 collects traffic information and determines the traffic-information-provided section (step 21). The traffic information transmitter 30 selects a traffic-information-provided section V as a target and creates a shape vector around the target traffic-information-provided section V and sets a reference node (step 23). Next, the traffic information transmitter 30 performs irreversible encoding/compression on the shape vector (step 24). The irreversible encoding/compression method is detailed in the Japanese Patent Laid-Open No. 2003-23357.

The quantization unit determination section 32 determines the traffic situation and determines the unit block length of sampling point interval and data count to specify the position resolution as well as the traffic information quantization table 523 and the encoding table 52 to specify the resolution of traffic information (step 25).

The following are to be noted in determining the position resolution:

For determination of congestion and travel time, a resolution as a unit of collection of various types of information (for example 10 m) prespecified in an existing system may be used. This adequately represents a break between congestions and travel times.

For a route distant from the information transmission point, the distance resolution may be previously set to a coarse value depending on the importance.

Raw traffic information such as the speed collected from a probe car does not represent important traffic information such as the beginning and end of congestion, so that the position resolution may be determined based on the data count.

The data count must be set to 2^{N} in data compression using FFT (fast Fourier transform). For DWT using a 2×2 filter, the data count is desirably 2^{N} or a multiple of 2^{N} (that is, k×2^{N}, where k and N are positive integers). Note that, when data count does not reach k×2^{N} due to distance resolution, a value of “0” or an appropriate value (such as the last value of valid data) should be inserted until the data count reaches k×2^{N}.

Note the following when determining the resolution of traffic information:

Resolution of travel time and congestion information is in units of 5 minutes/3-rank display in an existing system. A value double, triple, etc. the existing resolution should be used as respective resolutions.

Set the resolution of raw data such as the speed to an integral multiple of an accuracy while considering the measurement accuracy.

A less important route has coarser measurement intervals and lower measurement accuracy than an important route. Prediction information on the far future has lower prediction accuracy. Thus, resolution may be previously set to a coarse value for such information.

Rounding of data should be made depending on the resolution before sampling.

The final position resolution and traffic information resolution are determined depending on the transmission order in accordance with the importance of data at the sending party and the data reception volume and processing speed at the receiving party.

The traffic information converter 33 determines the sampling data of traffic information based on the unit block length of the distance quantization unit (step 26).

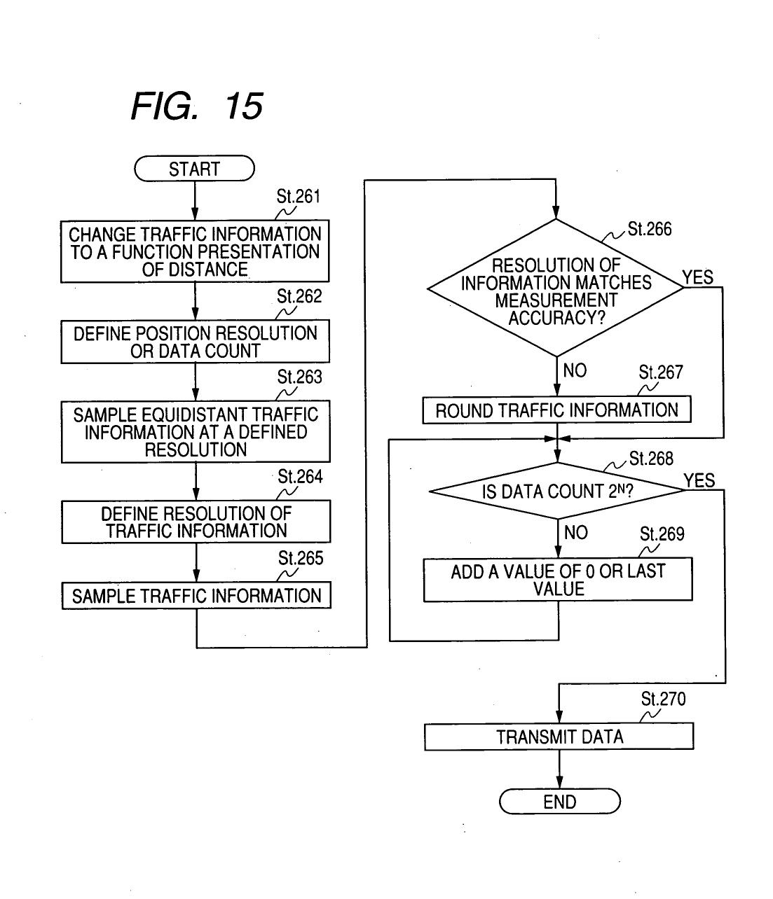

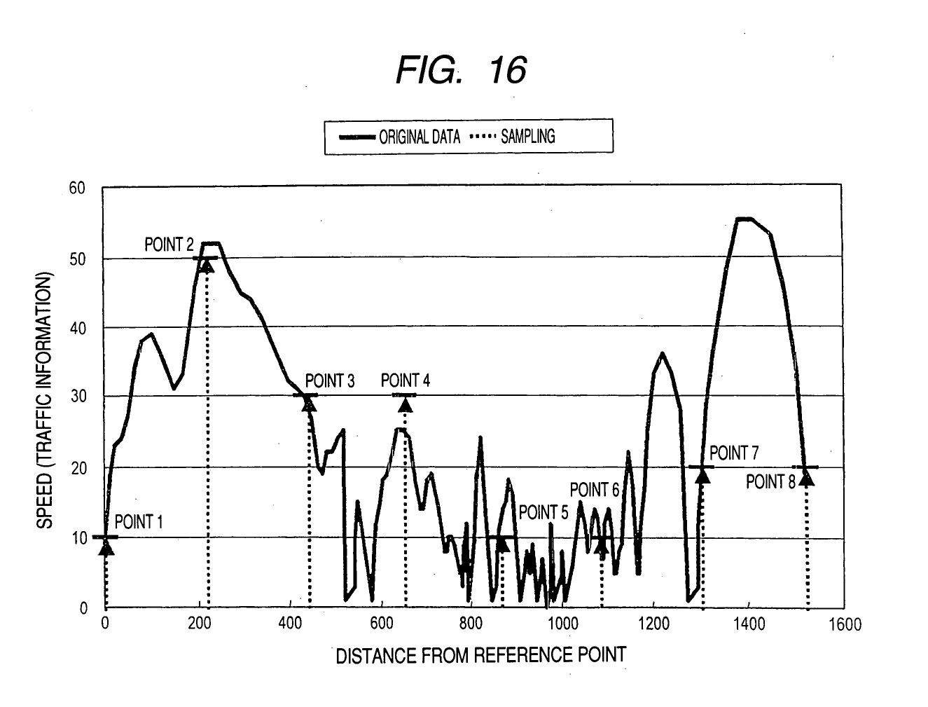

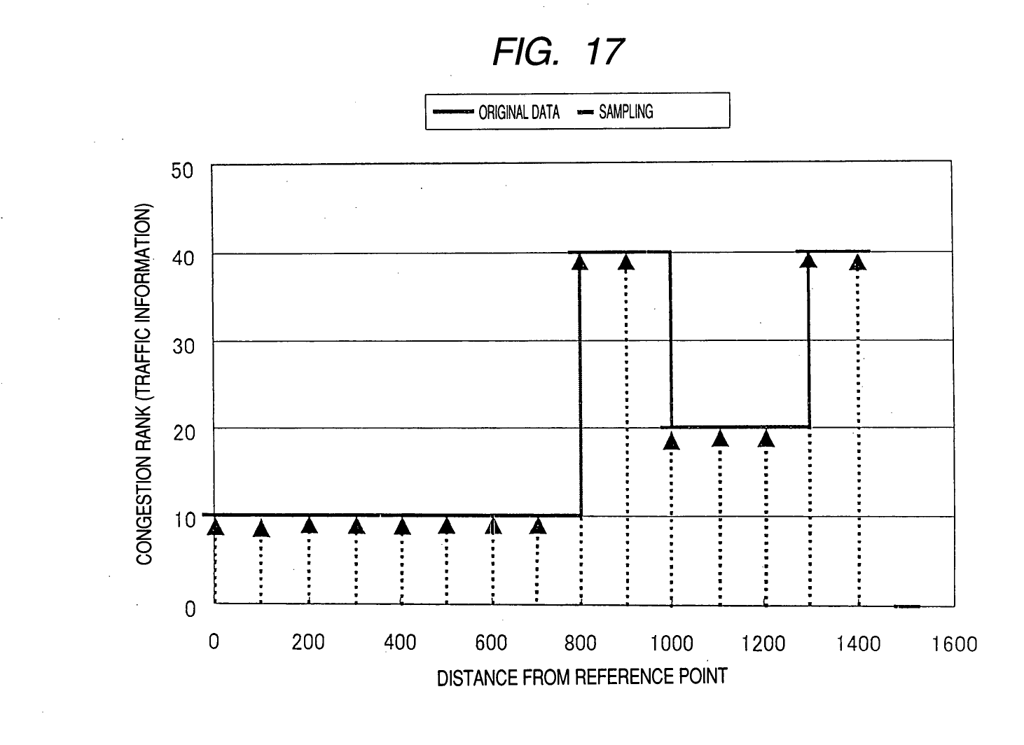

FIG. 15 shows a detailed procedure for setting the sampling data of traffic information. FIG. 16 shows a case where sampling data is determined from the traffic information collected by a probe car. FIG. 17 shows a case where sampling data is determined from the traffic information colected by a sensor.

The traffic information is represented by a function of distance by the traffic information calculator 14 (step 261). The unit block length of distance quantization unit (position resolution) or data count is defined by the quantization unit determination section 32 (step 262). The traffic information converter 33 equidistantly samples the traffic information represented by a function of distance by way of a defined resolution (step 263).

The quantization unit determination section 32 defines the resolution of traffic information which determines the coarseness of traffic information (for example, whether to represent speed information in units of 10 km or 1 km) (step 264). The traffic information converter 33 focuses on the data sampled in step 263 (step 265) and identifies whether the measurement accuracy matches the resolution of information (step 266), and in case matching is not obtained (such as in case the defined traffic information resolution is in units of 10 km and data is represented in units of 1 km), rounds the traffic information (step 267).

FIG. 16 shows a case where original data is rounded to obtain sampling data in units of 10 km. In FIG. 17, congestion rank information matches the unit of resolution so that rounding is skipped.

Next, the traffic information converter 33 identifies whether the sampling data count is k×2^{N} (step 269). In case it is not k×2^{N}, the traffic information converter 33 adds a value of 0 or the last numeral and sets the sampling data count to k×2^{N} (this example assumes k=1) (step 269). The traffic information converter 33 transmits the sampling data thus generated to the DWT encoder 34 (step 270).

In the case of FIG. 16, the data count is 8 (=2³) so that sampling data is not added. In the case of FIG. 17, the data count is 15, which is smaller than 16 (=2⁴) by 1 so that a value of 0 is added.

Referring to FIG. 14 again, the DWT encoder 34 performs DWT on the sampling data.

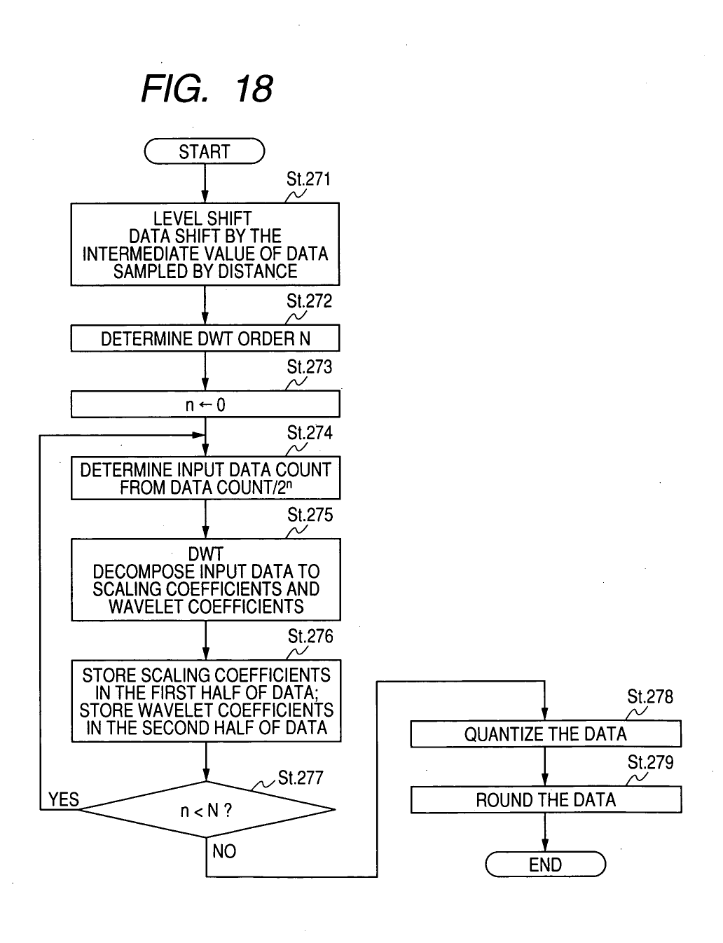

FIG. 18 shows a detailed DWT procedure. In order to reduce the absolute value of data, the data level is shifted by the intermediate value of data sampled by distance (step 271). For FIG. 16, the maximum value of sampling data is 50, the minimum value is 10, the intermediate value is 30. Thus the data at point 1 is level shifted by −20, data at point 2 incremented by 20 and data at point 3 by 0.

Next, the DWT order N is determined. In case the sampling data count is 2^{m}, the order N can be set to a value equal to or less than m (step 272). Next, beginning with the 0th order (n=0) (step 273), the input data count is determined from data count/2n (step 274) and DWT in accordance with (Expression 8) and (Expression 9) given earlier is applied to the sampling data to decompose the input data into scaling coefficients and wavelet coefficients (step 275). In this practice, the data count of scaling coefficients and wavelet coefficients are respectively half the input data count.

The obtained scaling coefficients and wavelet coefficients are stored in the first half of the data and in the second half of the data, respectively (step 276). In case n<N (step 277), execution returns to step 274, where the order is incremented by 1 and the input data count is determined from the data count/2ⁿ. In this case, only the scaling coefficients stored in the first half of the data in step 276 serve as the next input data.

Steps 274 through 276 are repeated until n reaches N (step 277). When N=n, repeating DWT until the mth order results in a single scaling coefficient.

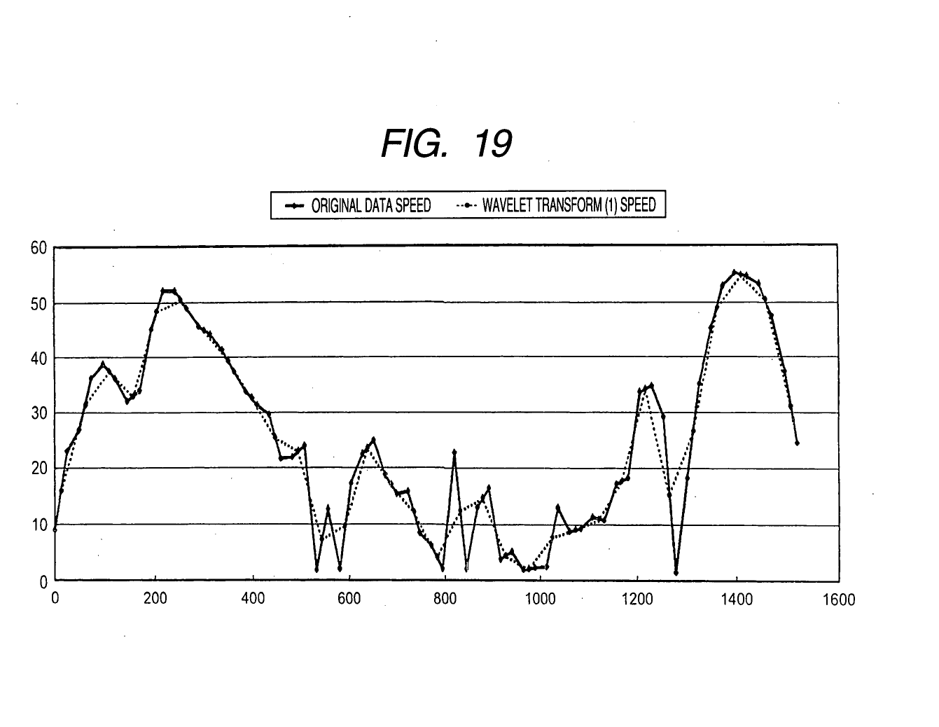

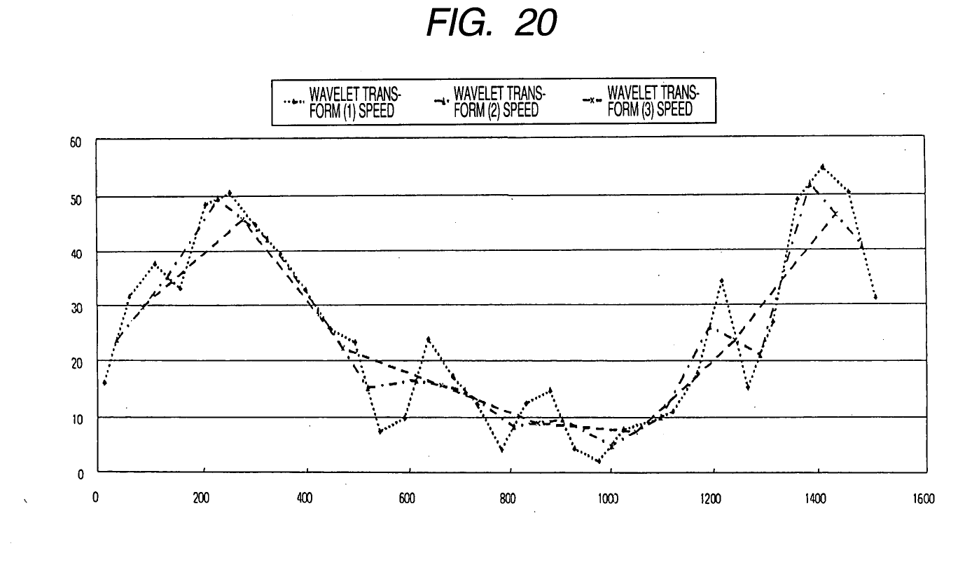

FIG. 19 shows original data (solid lines) and first-order scaling coefficients (dotted lines) used to perform a single DWT thereon. FIG. 20 shows the first-order scaling coefficients (dotted lines) and second-order scaling coefficients (alternate long and short dashed lines) and third-order scaling coefficients (dashed lines) assumed when DWT is repeated. The distance quantization unit of the first-order scaling coefficient is double the distance quantization unit of original data and the value of the first-order scaling coefficient is an average of the original data included in the distance quantization unit. That is, the distance quantization unit of an nth-order scaling coefficient is double the distance quantization unit of the (n−1)th-order scaling coefficients and the value of the nth-order scaling coefficient is an average of the (n−1)th-order scaling coefficient values included in the distance quantization unit. The value of the sole m-order scaling coefficient is an average of all the original data.

Next, the DWT encoder 34 quantizes the scaling coefficients and wavelet coefficients by using the traffic information quantization table 53 determined by the quantization determination section 32 (step 278). The traffic-information quantization table 53 specifies a value p used to divide a scaling coefficient and a value q (≧p) used to divide a wavelet coefficient In the quantization processing, a scaling coefficient is divided by p and a wavelet coefficient is divided by q, and the data obtained is rounded (step 279). The quantization processing may be skipped (corresponding to a case where p=q=1) and only rounding of data may be made. Instead of quantization, inverse quantization may be performed to multiply a scaling coefficient and a wavelet coefficient by a predetermined integer.

The DWT encoder 34 further variable-length encodes the quantized (or inverse-quantized) data by using the encoding table 52 determined by the quantization determination section 32 (step 29). The variable-length encoding may also be skipped.

The DWT encoder 34 executes the above processing for all the traffic-information-provided sections (steps 30, 31).

The information transmitter 35 converts the encoded data to transmit data (step 32) and transmits the data together with the encoding table (step 33).

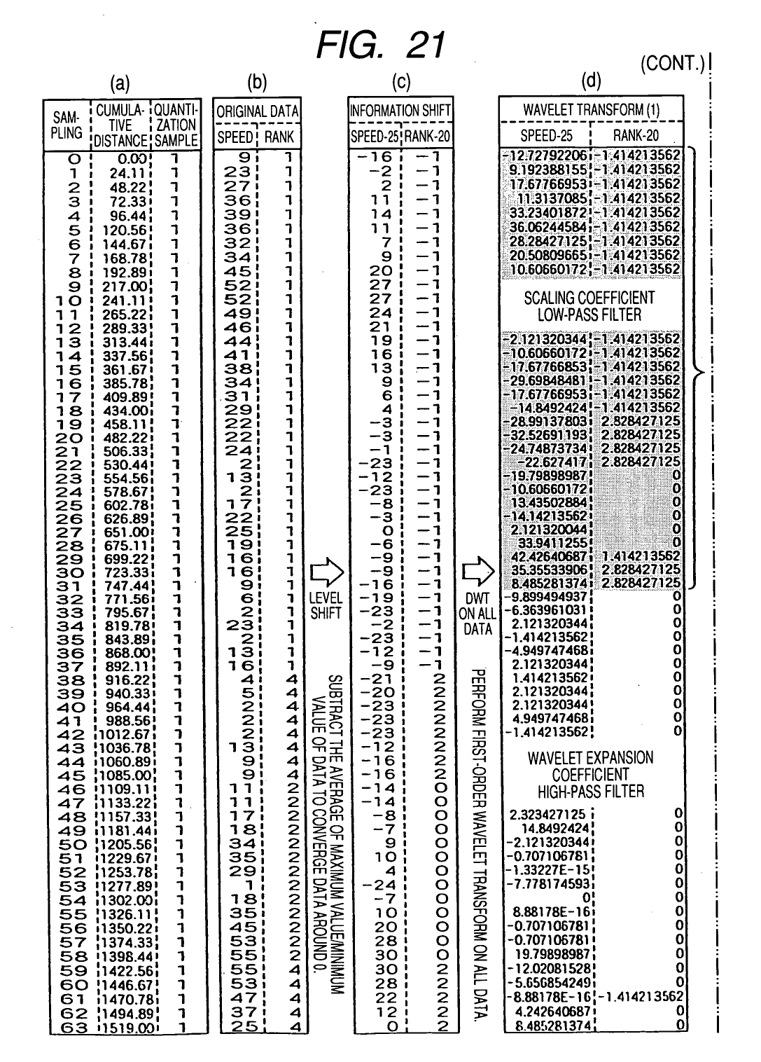

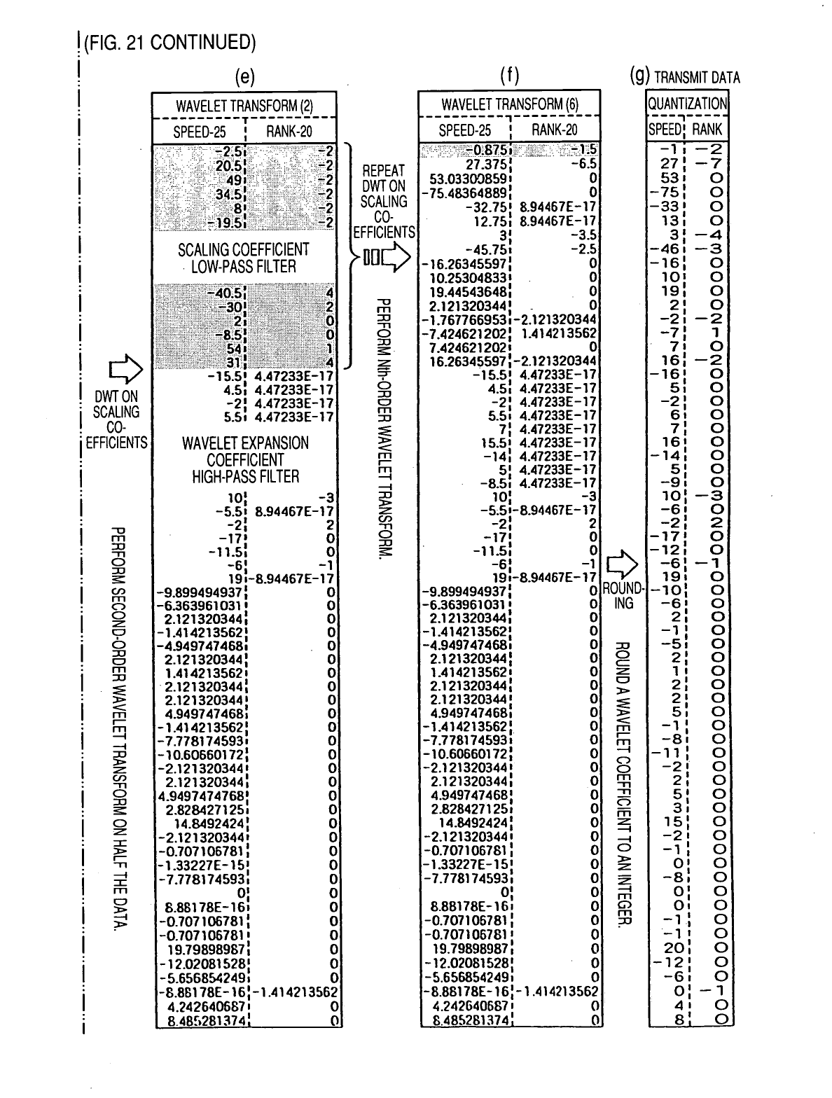

FIG. 21 shows a specific example where 6th-order DWT is performed on 64 (2⁶) sampling data items to generate transmit data. The original data (FIG. 21B) is the data of speed and congestion rank over the cumulative distance shown in FIG. 21A. FIG. 21C shows the values obtained by subtracting the average maximum and minimum values from the original data and level-shifting the resulting values so that the data will converge to the value of 0. FIG. 21D shows the first-order scaling coefficients and first-order wavelet coefficients obtained by performing first-order DWT on all the level-shifted data. FIG. 21E shows the result obtained by performing second-order DWT on the first-order scaling coefficients and splitting the first-order scaling coefficients into second-order scaling coefficients and second-order wavelet coefficients. FIG. 21F shows the result of sixth-order DWT. Only one sixth-order coefficient is obtained. The data in FIG. 21F is divided by the quantization sample value 1 shown in FIG. 21A and then rounded. The result is shown in FIG. 21G.

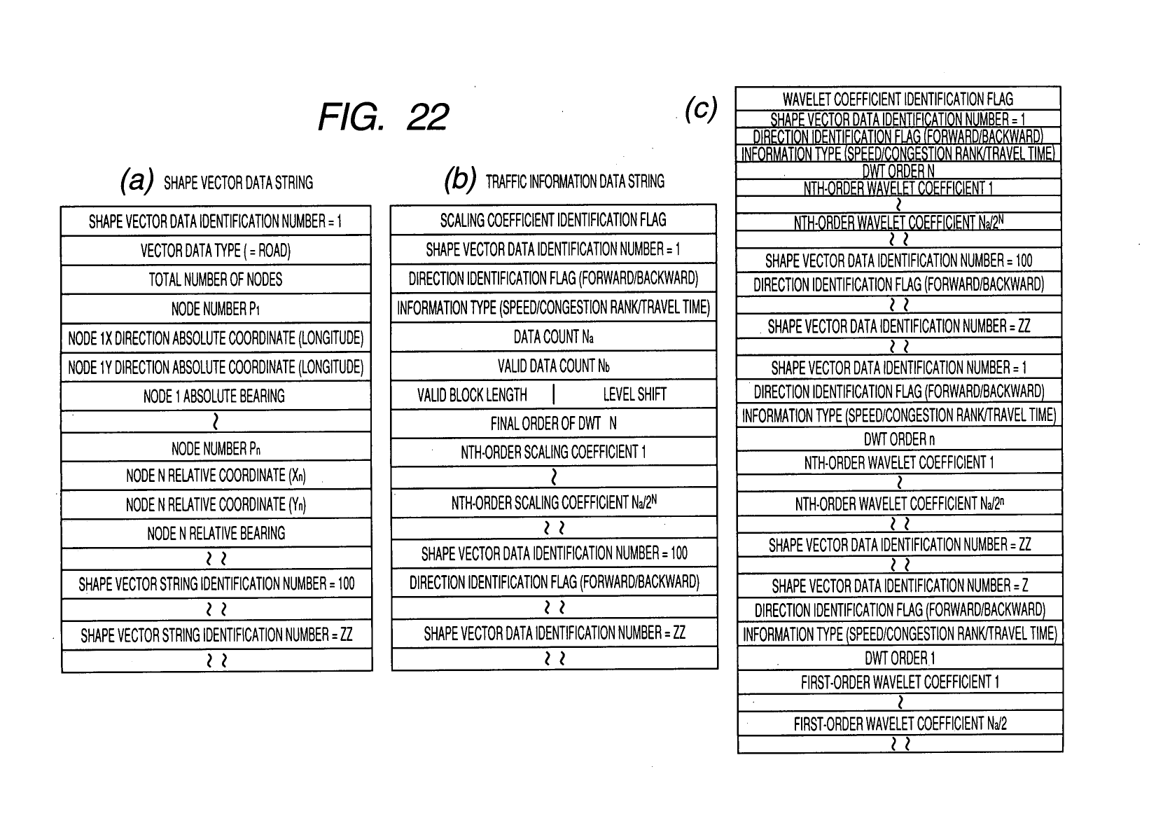

FIG. 22 shows an exemplary structure of data transmitted from the traffic information transmitter 30. FIG. 22A shows a shape vector data string representing the target road section of traffic information. FIG. 22B is a traffic information data string including only the scaling coefficients of the target road sections. This data string describes Nth order scaling coefficients where N is the final order of DWT. In case the sampling data count is k×2^{N}, the number of the nth scaling coefficients is k. FIG. 22C is a traffic information data string including only the wavelet coefficients of the target road sections. This data string describes wavelet coefficients used for each order of DWT. The information transmitter 35 transmits the information of the shape vector data string (FIG. 22A) together with the traffic information describing the scaling coefficients of the target road sections (FIG. 22B), then transmits the traffic information concerning wavelet coefficients (FIG. 22C), from highest to lowest DWT order.

As shown in FIG. 14, in the receiving party apparatus 60, when the traffic information receiver 61 receives data (step 41), the decoder 62 decodes the shape vector for each traffic-information-provided section V (step 42) and the map matching and section determination section 63 performs map matching on its digital map database 65 to identify the target road section (step 43). The decoder 62 references an encoding table to perform variable-length decoding (step 44) or inverse quantization (quantization in case inverse quantization has been made by the sending party) (step 45), and then performs IDWT (step 46).

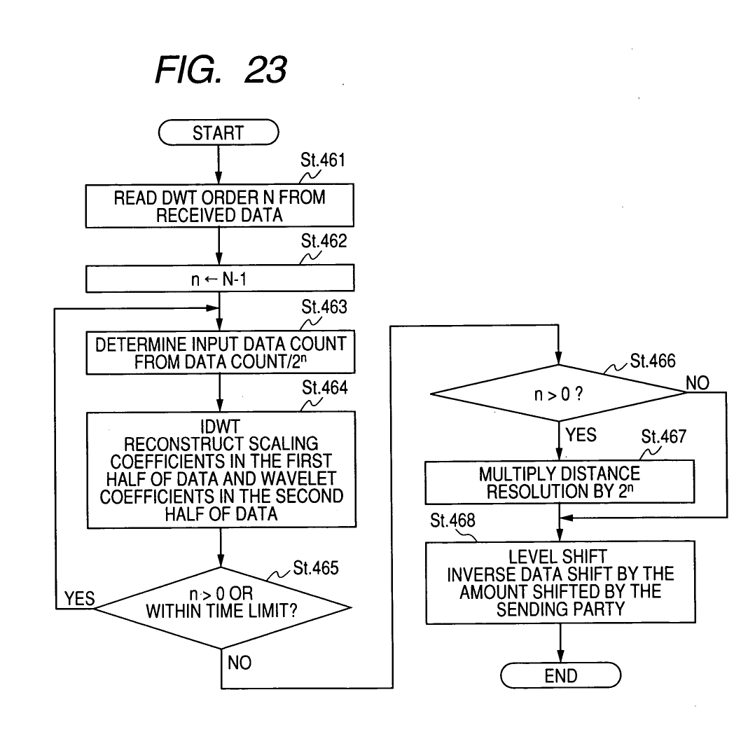

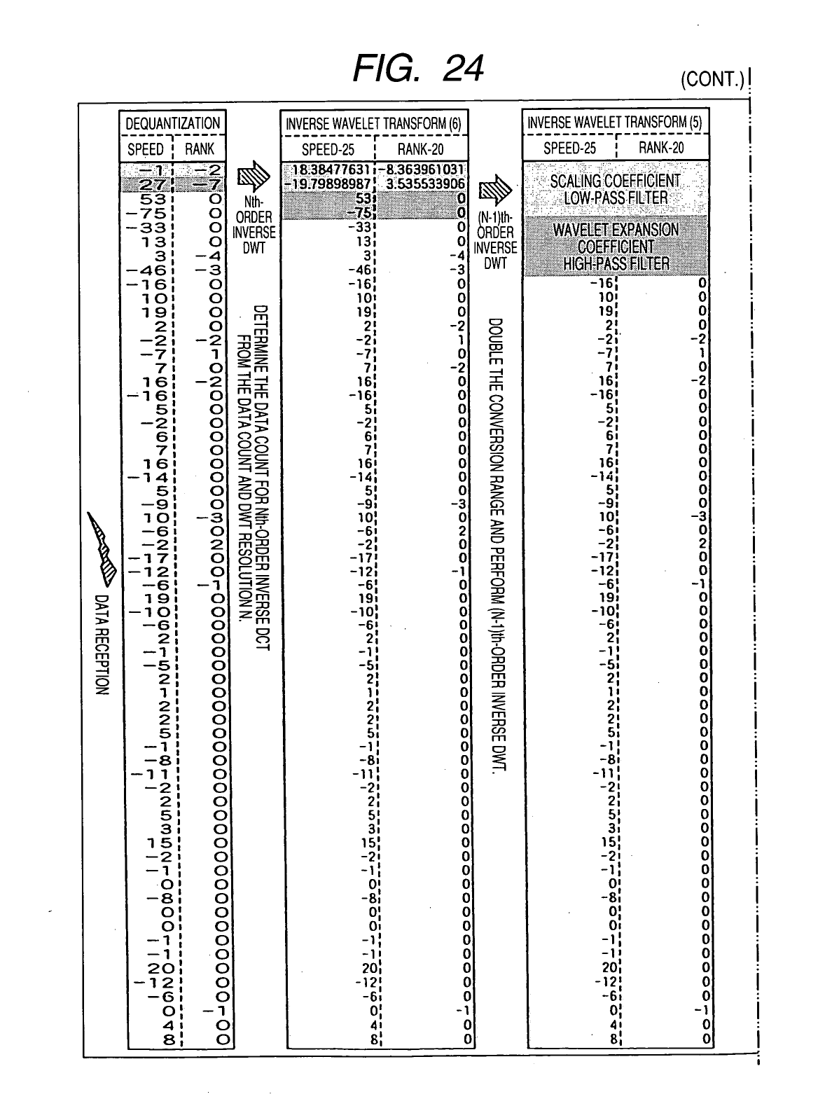

FIG. 23 shows a detailed IDWT procedure. The decoder 62 reads the DWT order N from the traffic information data received (step 461), sets n to N−1 (step 462), and determines the input data count by way of data count/2ⁿ (step 463). Then, by storing the scaling coefficients in the first half of the input data and wavelet coefficients in the second half of the input data, the decoder 62 rearranges the data by way of (Expression 10) and (Expression 11) (step 464).

In case n>0 or within a time limit, execution returns to step 463, where the decoder 62 decrements n by 1 and repeats steps 463 and 464 (step 465). When n=0 and IDWT is over, the decoder 62 inverse-shifts the data by the amount the sending party has shifted the data (step 468).

When a time limit has elapsed, the encoder 62 completes IDWT even when n>0 and sets the unit length of the distance quantization unit (distance resolution) to 2ⁿ (step 467), then inverse-shifts the data by the amount the sending party has shifted the data (step 468) in order to display the lower-resolution traffic information by using the traffic information data obtained so far.

This reproduces the traffic information (step 47).

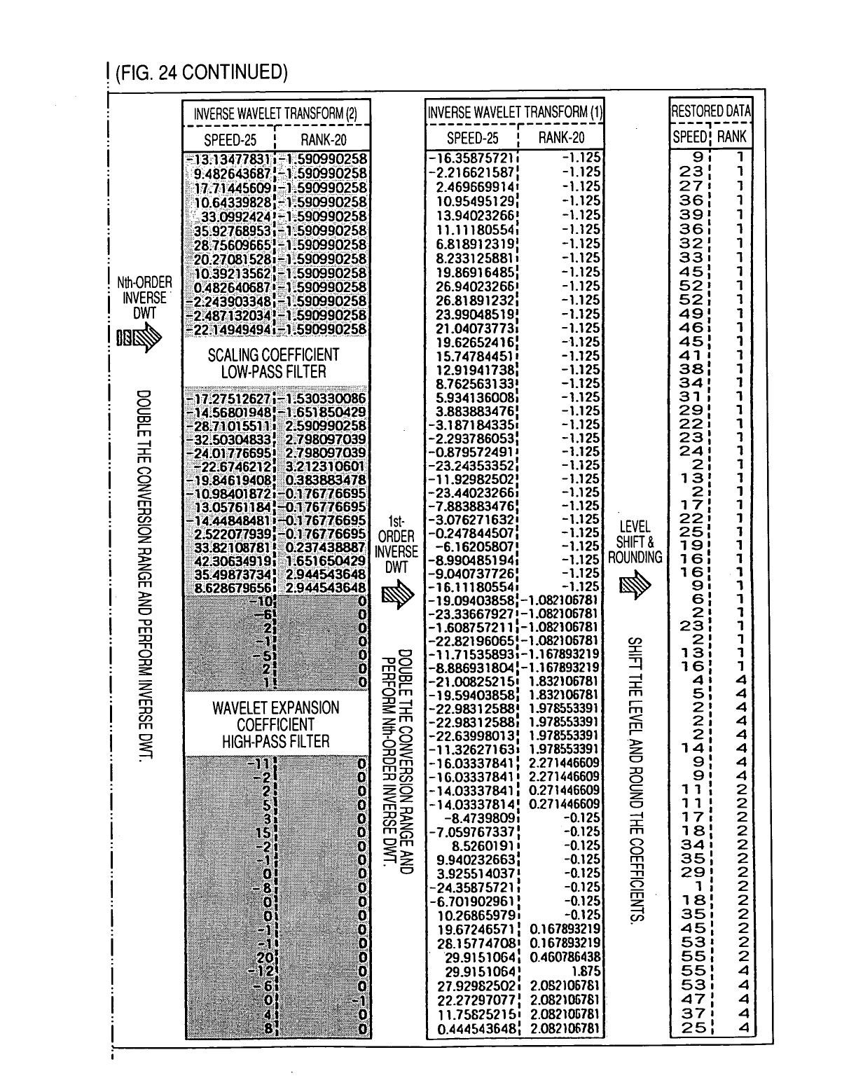

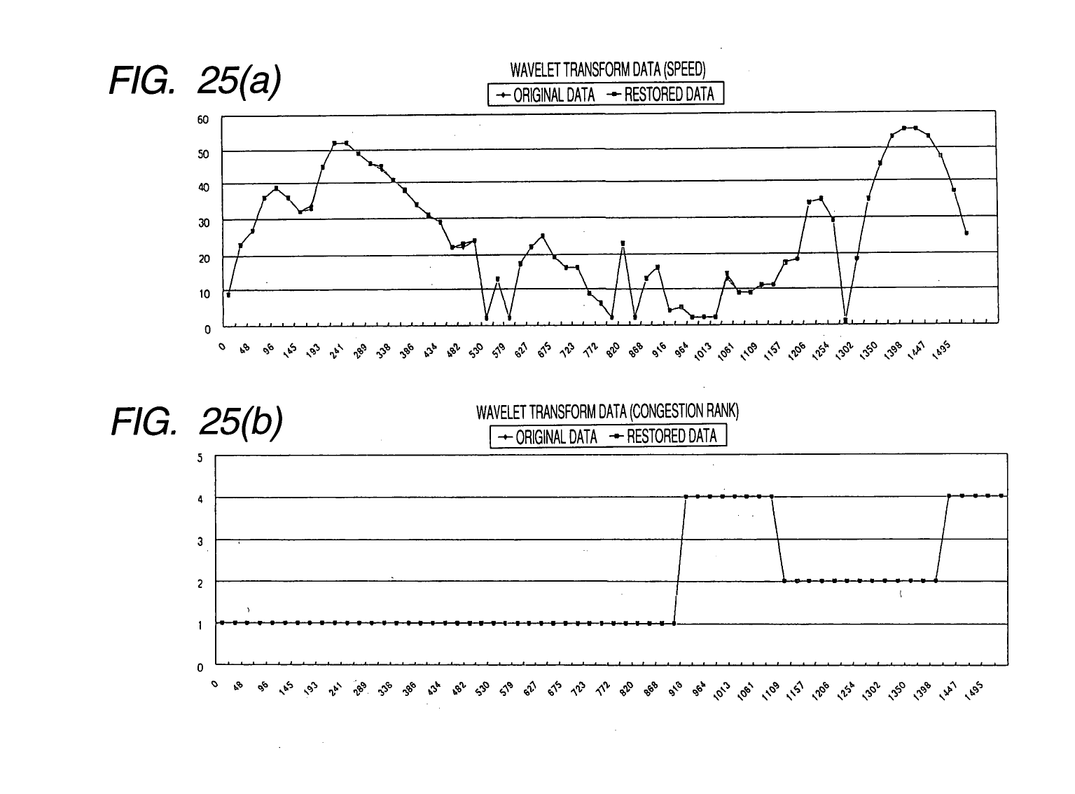

FIG. 24 shows a change in the data during six IDWT processes on the transmit data (FIG. 21G) in order to restore the data. FIG. 25A shows the original data and restored data of speed information in a superimposed fashion. Although slight dislocation is observed near the cumulative distances 193, 338 and 1061, the original data and restored data well match each other.

FIG. 25B shows the original data and restored data of congestion ranks in a superimposed fashion. The figure shows a perfect match.

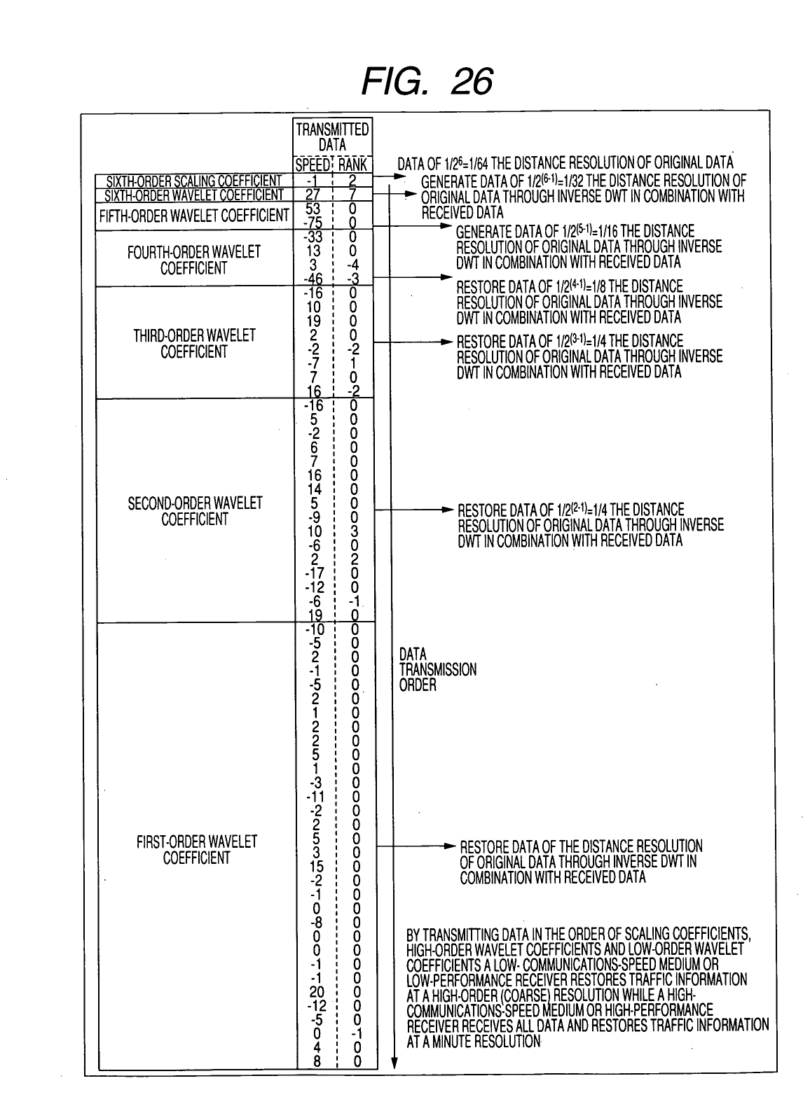

FIG. 26 shows data which can be restored in case only the transmit data in FIG. 21G is received only partially. The transmit data is sent, in the order of sixth-order scaling coefficients, sixth-order wavelet coefficients, fifth-order wavelet coefficients, fourth-order wavelet coefficients, third-order wavelet coefficients, second-order wavelet coefficients, and first-order wavelet coefficients.

In case only the sixth-order scaling coefficients are received, data of ½⁶= 1/64 the distance resolution of original data can be restored.

When up to the sixth-order wavelet coefficients are received, data of ½⁵= 1/32 the distance resolution of original data can be restored, by performing IDWT in combination with the received data (in this case sixth-order scaling coefficients).

When up to the fifth-order wavelet coefficients are received, data of ½⁴= 1/16 the distance resolution of original data can be restored, by performing IDWT in combination with the received data.

When up to the fourth-order wavelet coefficients are received, data of ½³=⅛ of the distance resolution of original data, that is, data shown by the dashed lines in FIG. 20 can be restored, by performing IDWT in combination with the received data.

When up to the third-order wavelet coefficients are received, data of ½²=¼ the distance resolution of original data, that is, data shown by the alternate long and short dashed lines in FIG. 20 can be restored, by performing IDWT in combination with the received data.

When up to the second wavelet coefficients are received, data of ½ the distance resolution of original data, that is, data shown by the dotted lines in FIG. 20 can be restored, by performing IDWT in combination with the received data.

When up to the first wavelet coefficients are received, the distance resolution data of original data, that is, data shown by the dotted lines in FIG. 20 can be restored, by performing IDWT in combination with the received data.

The traffic information reflecting section 64 reflects the decoded traffic information into the link cost of the system (step 48). This processing is executed for all traffic-information-provided sections (steps 49, 50). The information utilization section 1067 utilizes the provided traffic information to execute display of the required time and route guidance (step 51).

In this way, the DWT-processed data has layers. In case the data received by the receiving party has some data loss, it is possible to restore information at a low resolution. When the sending party sets priorities to the layers and transmits data in the order of scaling coefficients, high-order wavelet coefficients and low-order wavelet coefficients without considering the communications environment or reception performance, the receiving party can reproduce minute or coarse traffic information depending on the received data. In other words, a low- communications-speed medium or low-performance receiver restores traffic information at a high-order (coarse) resolution while a high-communications-speed medium or high-performance receiver receives all data and restores traffic information at a minute resolution.

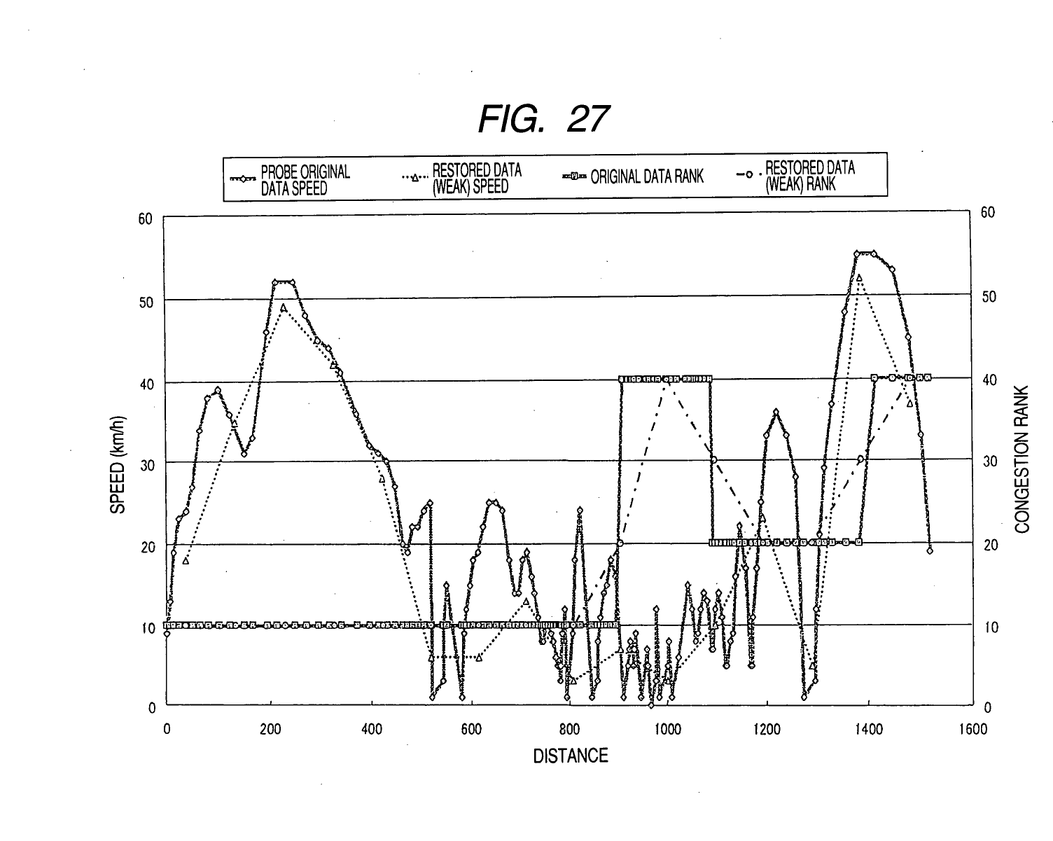

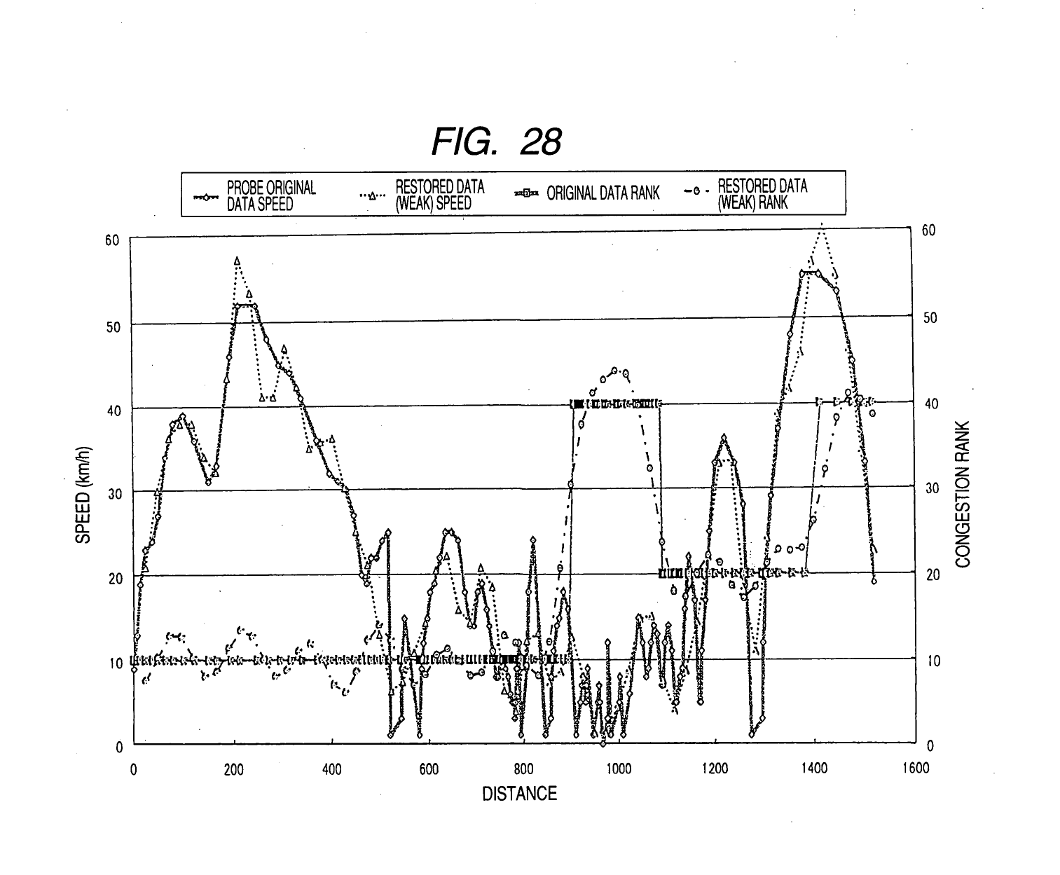

The data restored from some of the layers indicates the average value of the original data included in the extended distance quantization unit in the case of DWT. Thus, an overshoot which exceeds the original data or an undershoot which lowers the original data does not occur. FIG. 27 shows a case where the original data is compressed by DWT and data is restored using some of the compressed data. Original data of speed and congestion levels is represented by solid lines. Restored data of speed is represented by dotted lines and restored data of congestion levels by alternate long and short dashed lines. FIG. 28 shows a case where the original data is compressed by DCT and data is restored using some of the compressed data. Same as FIG. 27, original data of speed and congestion levels is represented by solid lines, and restored data of speed is represented by dotted lines and restored data of congestion levels by alternate long and short dashed lines. As understood from comparison between these figures, compression with DCT involves an overshoot and an undershoot, but compression with DWT does not.

In case traffic information is provided on a chargeable basis, the layer of data which can be decoded may be different depending on the charge. A system may be provided where only coarse traffic information is obtained at a low charge and minute traffic information is obtained at a high charge.

<Advantage of Using DWT>

Use of DWT in compression of traffic information has the following advantages:

Applicable to coarse information such as a congestion level and minute traffic information such as probe car information

Lossless (reversible conversion) compression using data of all layers is available; also available is lossy (irreversible conversion) compression. Either reversible or irreversible conversion may be selected.

It is possible to change the DWT order and the number of scaling coefficients depending on the complexity of traffic information.

It is possible to change base of wavelet and perform conversion by using a base function appropriate for the information.

Application of multiple DWT processes can generate deviated data, which facilitates encoding.

Traffic information can be decomposed into multiple resolution levels to sequentially synthesize information. The receiving party can fetch data in units of k×2ⁿ data items and sequentially synthesize information to gradually generate high-resolution traffic information. Depending on the data transmission method, information can be displayed such as in the progressive mode of images.

While the 2×2 filter for DWT has been described, the invention allows use of a 5×3 filter (a filter which generates one wavelet coefficient from five inputs and one scaling coefficient from three inputs) or a 9×7 filter (a filter which generates one wavelet coefficient from nine inputs and one scaling coefficient from seven inputs) to execute DWT.

<Types of Road Section Reference Data>

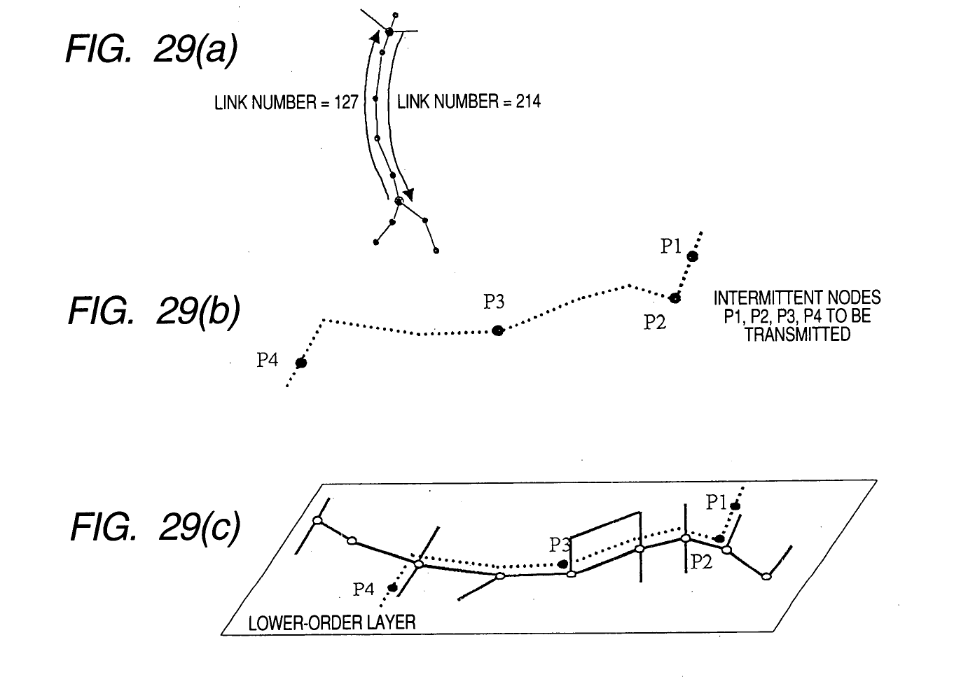

While a case has been described where a shape vector data string is communicated to the receiving party in order to notify the target road section, and the receiving party references the shape vector data string to identify the target road section of traffic information, the data to identify a road section (road section reference data) may be other than a shape vector data string. For example, as shown in FIG. 29A, a uniformly specified road section identifier (link number) or intersection identifier (nor number) may be used instead.

In case both the providing party and the receiving party reference the same map the providing party can communicate the latitude/longitude data to the receiving party and the receiving party can used the data to identify the road section.

Or, as shown in FIG. 29B, the providing party may transmit to the receiving party the latitude/longitude data (data having attribute information such as names and road types) to reference positions of intermittent nodes P1, P2, P3, P4 extracted from an intersection or a road in the middle of a link in order to communicate the target road. In this example, P1 is a link midpoint, P2 is an intersection, P3 is a link midpoint, and P4 is a link midpoint. To identify a road section, as shown in FIG. 29C, the position of each of P1, P2, P3 and P4 is identified, and each section are interconnected through path search to identify the target road.

Road section reference data to identify a target road may be other than the aforementioned shape vector data string, road section identifier and intersection identifier. For example, an identifier assigned to each tile-shaped segment of a road map, a kilo post installed at a road, a road name, an address, and a ZIP code may be used as position reference information to identify a target road section of traffic information.

### Second Embodiment

Concerning the third embodiment of the invention, a system is described which performs bit plane decomposition in data transmission.

Bit plane decomposition is an encoding system used to compress an image. By using this system, the receiving party can acquire coarse data in an early stage such as in the progressive mode of images.

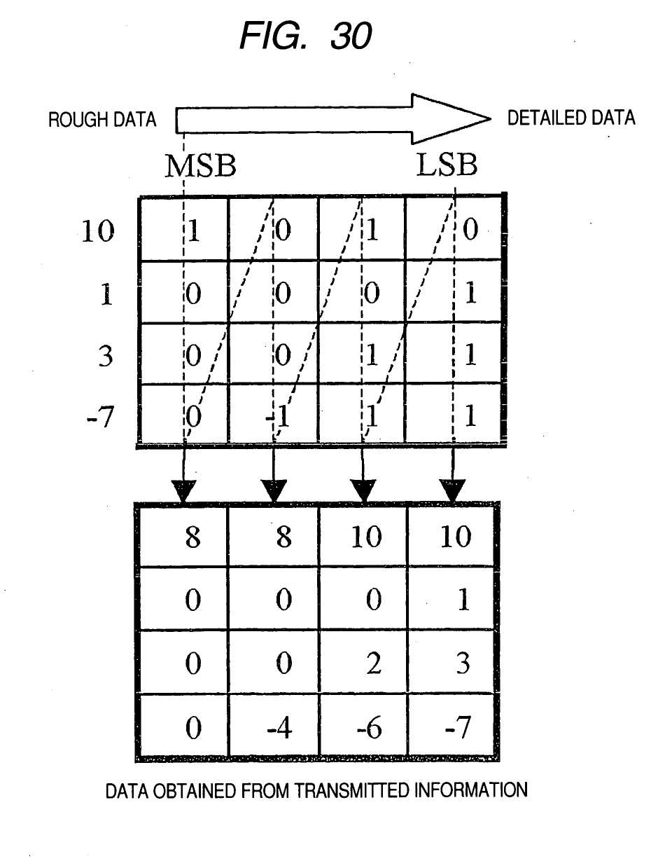

For example, when transmitting a numerical string (10, 1, 3, −7), the numerals are represented by binary numbers such as shown in FIG. 30:

10=1010

1=0001

3=001 1

−7=0−111

Typically the numerical string “1010 0001 0011 0-111” is transmitted. In bit plane decomposition, as shown by an arrow in FIG. 30, the numerical string “1000 000-1 1011 0111” is transmitted in the order of MSB, second bit, third bit and LSB of each numeral.

The receiving party, on receiving “1000”, identifies that the string

1000=8

0000=0

0000=0

0000=0

has been transmitted. The receiving party, on receiving “000-1”, identifies that the string

1000=8

0000=0

0000=0

0-100=−4

has been transmitted. The receiving party, on receiving “1011”, identifies that the string

1010=10

0000=0

0010=2

0-110=−6

as been transmitted. The receiving party, on receiving the final “0111”, identifies that the string

1010=10

0001=1

0011=3

0-111=−7

has been transmitted. In this way, by performing bit plane decomposition and sequentially transmitting information in descending order of number of digits, the receiving party can represent a rough traffic situation while transmission of the information is under way.

The traffic information transmitter 30 of the system performs bit plane decomposition on the transmit data shown in FIG. 21G and executes arithmetic encoding such as variable-length encoding on the resulting binary data.

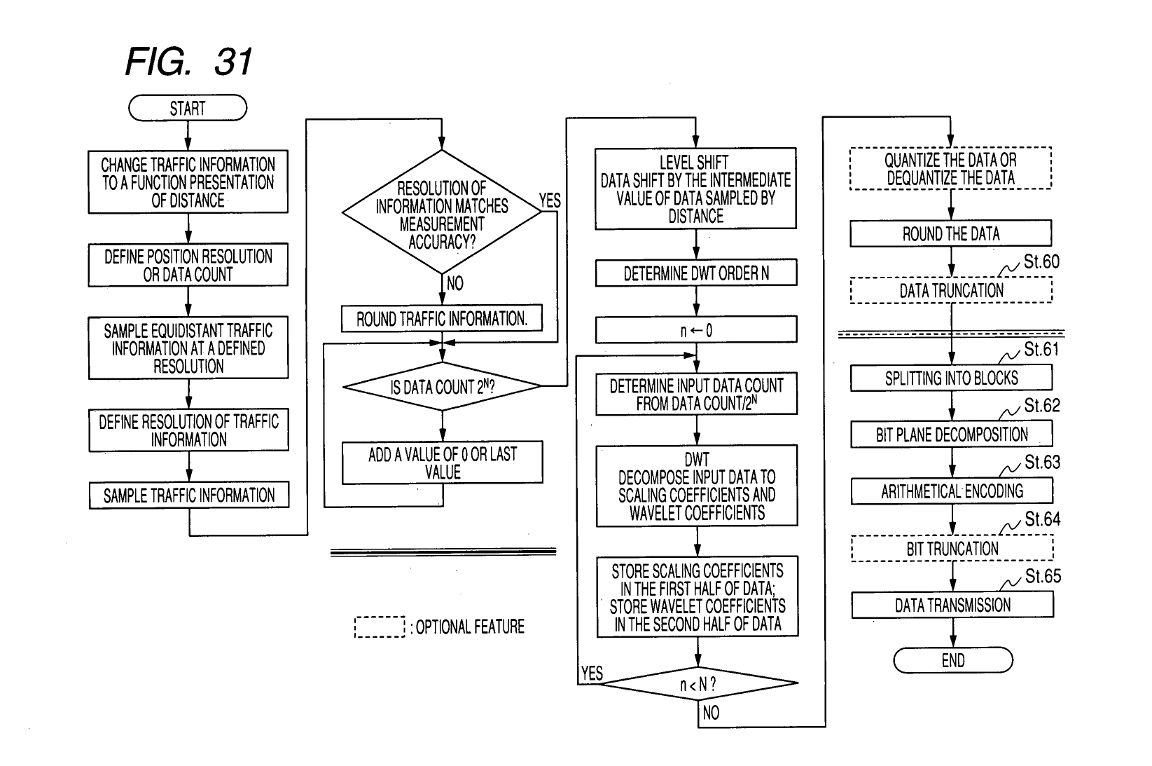

FIG. 31 shows a procedure by the traffic information transmitter 30 for generating/transmitting transmit data including bit plane decomposition. The traffic information transmitter 30 splits the data generated through DWT into blocks in units of shape information type (step 61), performs bit plane decomposition on the data in each block (step 62), executes arithmetic encoding of the binary data (step 63), and transmits the resulting data (step 65). Depending on the data capacity, data may be truncated (step 60) or bits may be truncated (step 64) in order to control the code volume.

It is readily possible to append copyright information to the bit-plane-decomposed data by using the electronic watermark technology. By encrypting the low-order bit layers of the bit-plane-decomposed data, it is possible to provide traffic information from which only a member having a decoding key can restore minute data. By encrypting the low-order bit layers of the bit-plane-decomposed data, it is possible to make coarser the traffic information which can be restored without using a decoding key. By encrypting the most significant bit layer, it is possible to encrypt the traffic information to those who do not own a decoding key.

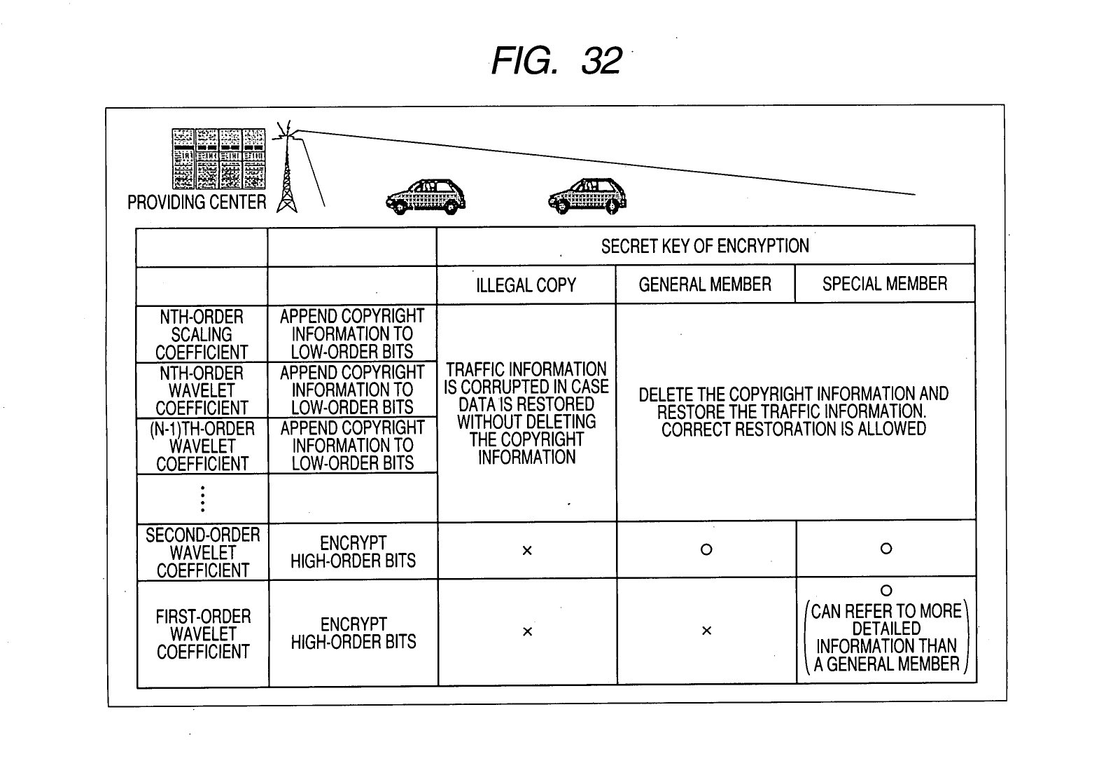

FIG. 32 shows a method for differentiating information or preventing illegal copy in a system which provides traffic information utilizing DWT or bit plane decomposition by way of a broadcast medium of an FM multiplex broadcast. To a general member and a special member, a key to decode the encrypted traffic information is previously provided in accordance with the membership level. To a general member and a special member is previously communicated how to restore traffic information where copyright information has been appended.

(1) The providing center provides traffic information where copyright information is appended to lower bits such as Nth-order scaling coefficients, Nth-order wavelet coefficients and (N−1) wavelet coefficients of the traffic information.

A general member or a special member can correctly restore traffic information by deleting the copyright section and restoring traffic information. When an illegal copy is attempted, the copyright section is not deleted before the traffic information is restored, since the copyright section is not known. This results in corruption of traffic information.

(2) The providing center encrypts the high-order bits of the second-order wavelet coefficients of the traffic information to be provided.

A general member or a special member who owns the corresponding decoding key can decode the encrypted second-order wavelet coefficients- and add the resulting wavelet coefficients to reproduce the traffic information. When an illegal copy is attempted, the encrypted information is added to the traffic information so that the original traffic information cannot be reproduced.

(3) The providing center encrypts the high-order bits of the first-order wavelet coefficients of the traffic information in order to differentiate the information to be provided.

A special member who owns the corresponding decoding key can decode the encrypted first order wavelet coefficients to correctly reproduce the traffic information, thereby acquiring more detailed traffic information than a general member.

The providing center provides traffic information to which one or more processes of (1), (2) and (3) have been applied in order to enhance protection against a possible illegal copy as well as differentiate the traffic information providing service depending on the membership level.

### Third Embodiment

While the first and second embodiments of the invention pertain to a case where the traffic information providing apparatus as a center provides traffic information to traffic information utilization apparatus such as a car-mounted machine, the traffic information providing method of the invention is also applicable to a system where a car-mounted machine on a probe car which provides travel data serves as traffic information providing apparatus and a center which collects information from the probe car serves as traffic information utilization apparatus. Concerning the third embodiment of the invention, this system is described.

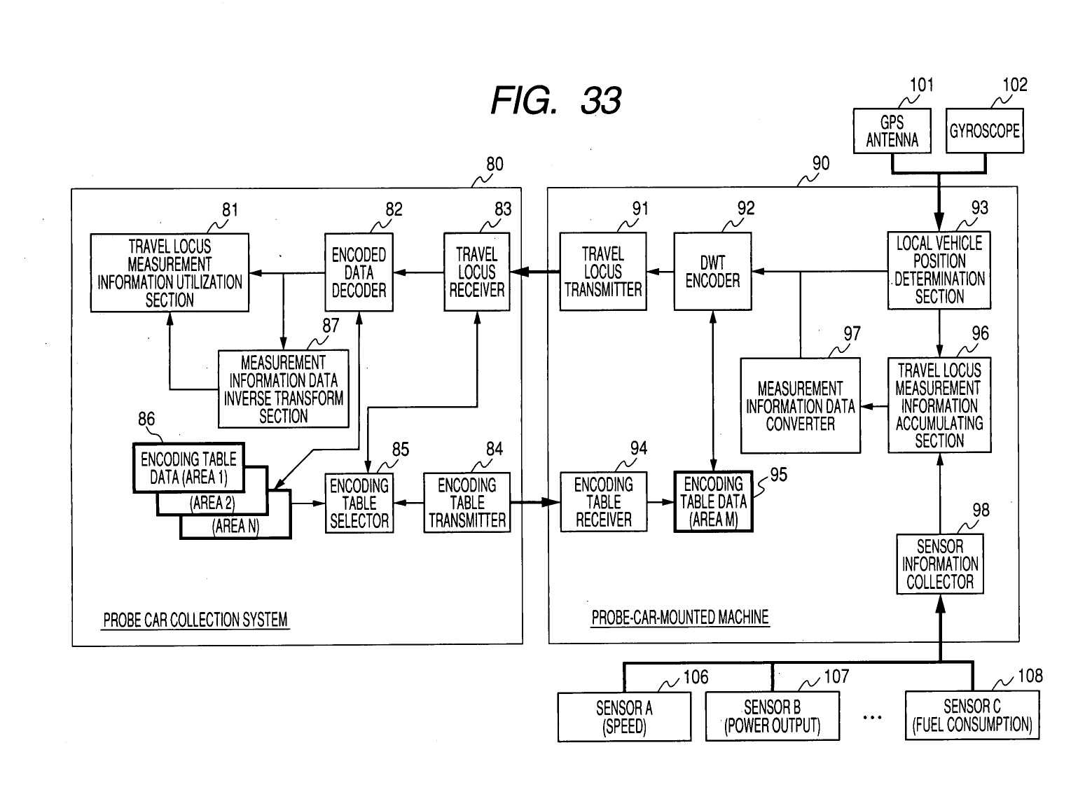

As shown in FIG. 33, the system comprises a probe-car-mounted machine 90 for measuring and providing travel data and a probe car collection system 80 for collecting data. The probe-car-mounted machine 90 comprises: an encoding table receiver 94 for receiving an encoding table used to encode transmit data from the probe car collection system 80; a sensor information collector 98 for collecting information detected by a sensor A 106 for detecting a speed, a sensor B 107 for detecting power output and a sensor C 108 for detecting fuel consumption; a local vehicle position determination section 93 for determining the local vehicle position by using the information received by a GPS antenna 101 and information from a gyroscope 102; a travel locus measurement information accumulating section 96 for accumulating the travel locus of the local vehicle and the measurement information from the sensors A, B, C; a measurement information data converter 97 for generating sampling data of measurement information; a DWT encoder 92 for performing DWT on the sampling data of measurement information to convert the data to scaling coefficients and wavelet coefficients and encoding the scaling coefficients and wavelet coefficients as well as the travel locus data by using the received encoding table data 95; and a travel locus transmitter 91 for transmitting the encoded data to the probe car collection system 80.

The probe car collection system 80 comprises: a travel locus receiver 83 for receiving travel data from the probe-car-mounted machine 90; an encoded data decoder 82 for decoding the received data by using the encoding table data 86; a measurement information data inverse transform section 87 for performing IDWT on the scaling coefficients and wavelet coefficients to restore measurement information; a travel locus measurement information utilization section 81 for utilizing the restored measurement information and travel locus data; an encoding table selector 85 for selecting an encoding table to be provided to the probe-car-mounted machine 90 depending on the current position of the probe car; and an encoding table transmitter 84 for transmitting the selected encoding table to the probe car.

The local vehicle position determination section 93 of the probe-car-mounted machine 90 identifies the local vehicle position by using the information received by the GSP antenna 101 and information from the gyroscope 102. The sensor information collector 98 collects measurement values such as speed information detected by the sensor A 106, engine load detected by the sensor B 107, and gasoline consumption detected by the sensor C 108. The measurement information collected by the sensor information collector 98 is stored into the travel locus measurement information accumulating section 96 in association with the local vehicle position identified by the local vehicle position determination section 93.

The measurement information data converter 97 represents the measurement information accumulated in the travel locus measurement information accumulating section 96 by a function of distance from a measurement start point (reference position) on the travel road and generates sampling data of measurement information. The DWT encoder 92 performs DWT on the sampling data to convert the measurement information to scaling coefficients and wavelet coefficients and encodes the travel locus data and converted scaling coefficients and wavelet coefficients by using the received encoding table data 95. The encoded travel locus data and measurement information are transmitted to the probe car collection system 80. The probe-car-mounted machine 90 transmits the measurement information in the order of scaling coefficients, high-order wavelet coefficients and low-order wavelet coefficients.

In the probe car collection system 80 which has received data, the encoded data decoder 82 decodes the encoded travel locus data and measurement information by using the encoding table data 86. The measurement information data inverse transform section 87 performs IDWT on the decoded scaling coefficients and wavelet coefficients to restore measurement information. The travel locus measurement information utilization section 81 utilizes the restored measurement information for creation of traffic information on the road on which the probe car has traveled.

In this way, DWT can be also used for compression of information to be uploaded from a probe-car-mounted machine. Even in case the data processing capability of the probe-car-mounted machine or transmission capacity is insufficient and only scaling coefficients and part of wavelet coefficients can be transmitted from the probe-car-mounted machine, the probe car collection system can restore rough measurement information from the received information.

### Fourth Embodiment

While the probe car system has been described where a probe-car-mounted machine represents measurement information such as the speed by a function of distance from a reference position on the road, performs DWT on the data and transmits the resulting data in the third embodiment, a probe car system will be described, concerning the fourth embodiment of the invention, where a probe-car-mounted machine measures measurement information at a fixed time pitch and performs DWT on the measurement information represented by a function of time and transmits the resulting data.

As shown in FIG. 39, the measurement information measured by a probe car while traveling is scattered on a locus in the time-space. As mentioned in the first embodiment, the measurement information can be represented on coordinates which uses the space axis (distance from a reference point) as a base axis or as a function of time by using the time axis as a base axis. By generating sampling data of fixed intervals from the measurement information represented by the function of time, it is possible to apply DWT mentioned in the first through third embodiments to the sampling data.

The measurement information measured by a probe car at fixed intervals may be used as the sampling data of fixed intervals.

For example, in case the probe-car-mounted machine transmits speed information as traffic information to the center, the probe-car-mounted machine measures the travel distance of the probe car at a fixed time pitch (for example in 2 to 4 seconds), performs DWT on the data and transmits the resulting data to the center.

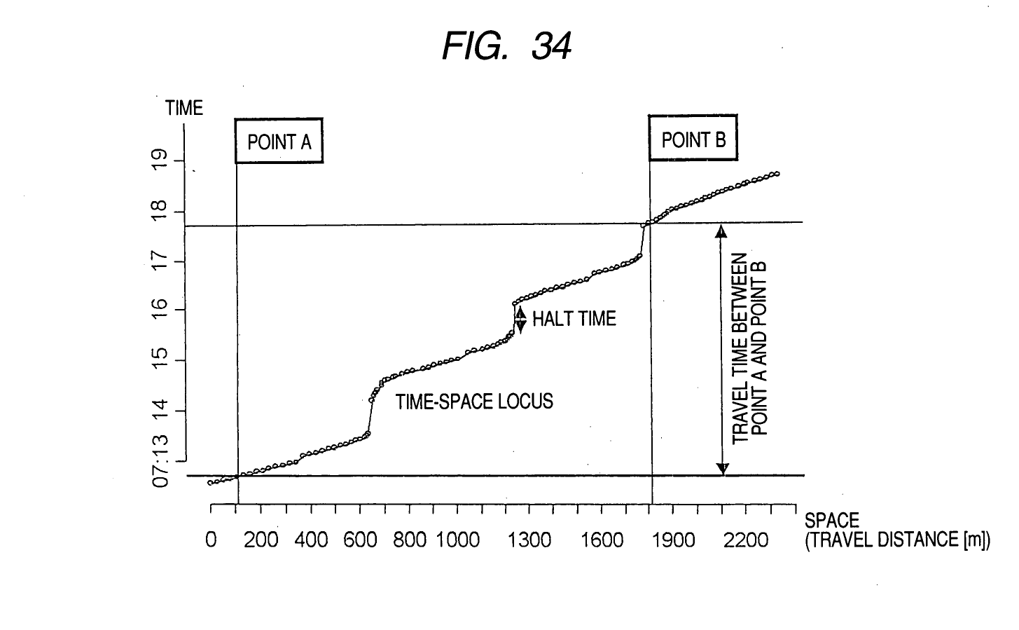

FIG. 34 shows a locus of measurement information measured by the probe-car-mounted machine on the time-space plane whose vertical axis represents the time and horizontal axis the travel distance. The locus information on the time-space plane represents the state of speed 0, that is, the state where the travel distance within a fixed pitch is 0, unlike the case where the locus is displayed as it is projected onto a plane including the space axis alone. Thus, the center which has received the measurement information and road section reference data can readily obtain the halt positions and halt count, halt time and travel speed between halts of the vehicle from the reproduced information as well as generate detailed congestion information from the obtained information and reflect the obtained information into control of traffic signals. It is also possible to readily calculate the travel time between fixed points (Point A and Point B) from this information.

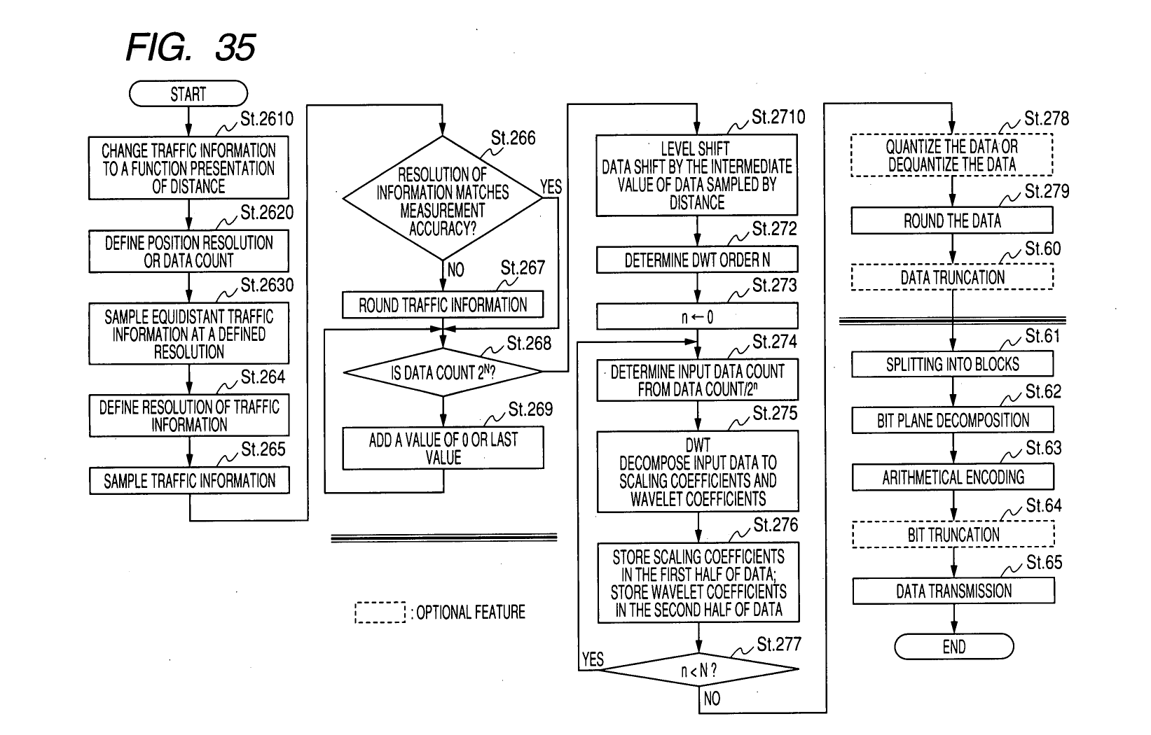

FIG. 35 shows the procedure for generating and transmitting the transmit data of the probe-car-mounted machine. Steps 2610 through 269 of the sampling data setting procedure are basically same as steps 261 through 270 in FIG. 15, except that the traffic information (measurement information) is represented by a function of time (step 2610) and the resolution of time (fixed time pitch) or data count is defined (step 2610) to sample traffic information at equal time intervals with defined resolution (step 2630). As mentioned earlier, in case the probe car measures measurement information at a defined fixed time pitch, the obtained data may be used as sampling data.

Steps 2710 through 279 of DWT procedure are basically same as steps 271 through 279 in FIG. 18, except that the data to be level-shifted and undergo DWT is the data sampled at equal time intervals (step 2710).

After DWT processing, the procedure of steps 60 through 65 of data truncation and bit plane decomposition followed by data transmission are same as that in FIG. 31.

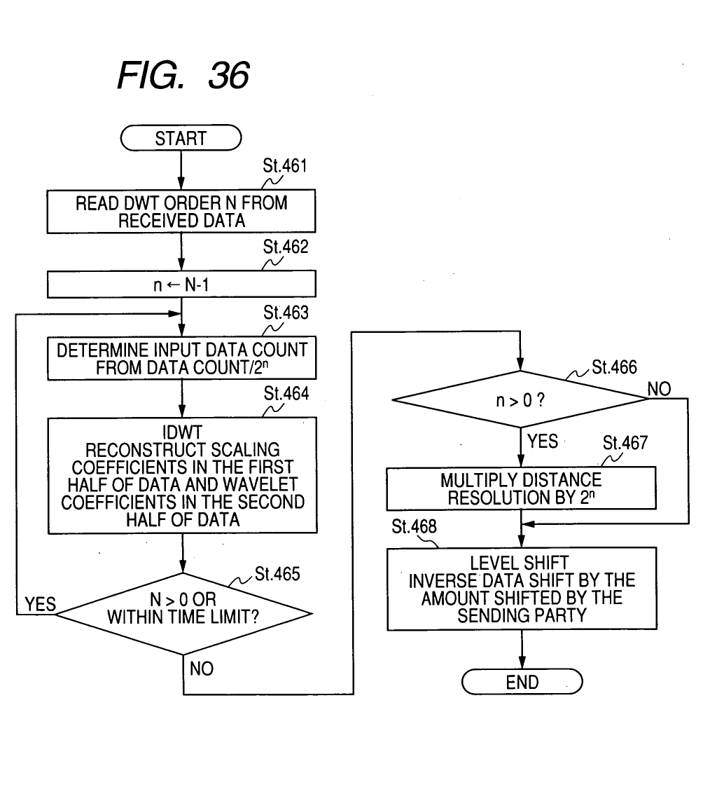

FIG. 36 shows the IDWT procedure to be followed by the center apparatus which has received measurement information from a probe-car-mounted machine. The procedure of steps 461 through 468 is basically the same as that in FIG. 23, except that IDWT is terminated when the IDWT time limit has elapsed and the time resolution is set to 2ⁿ-fold in order to display lower-resolution traffic information by using the obtained traffic information data (step 4670).

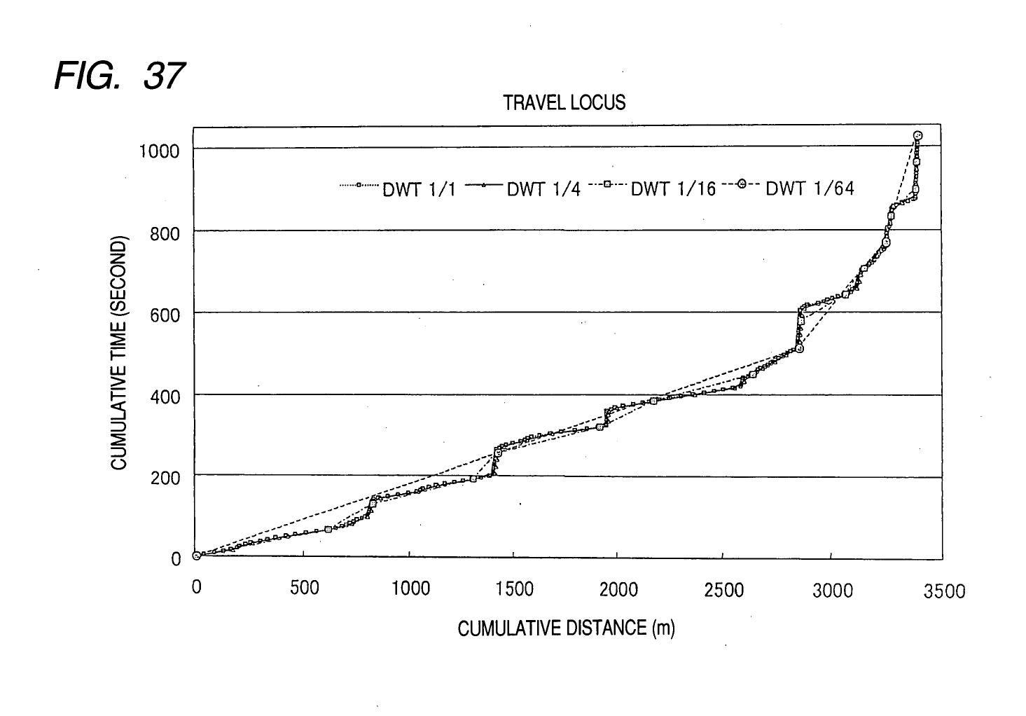

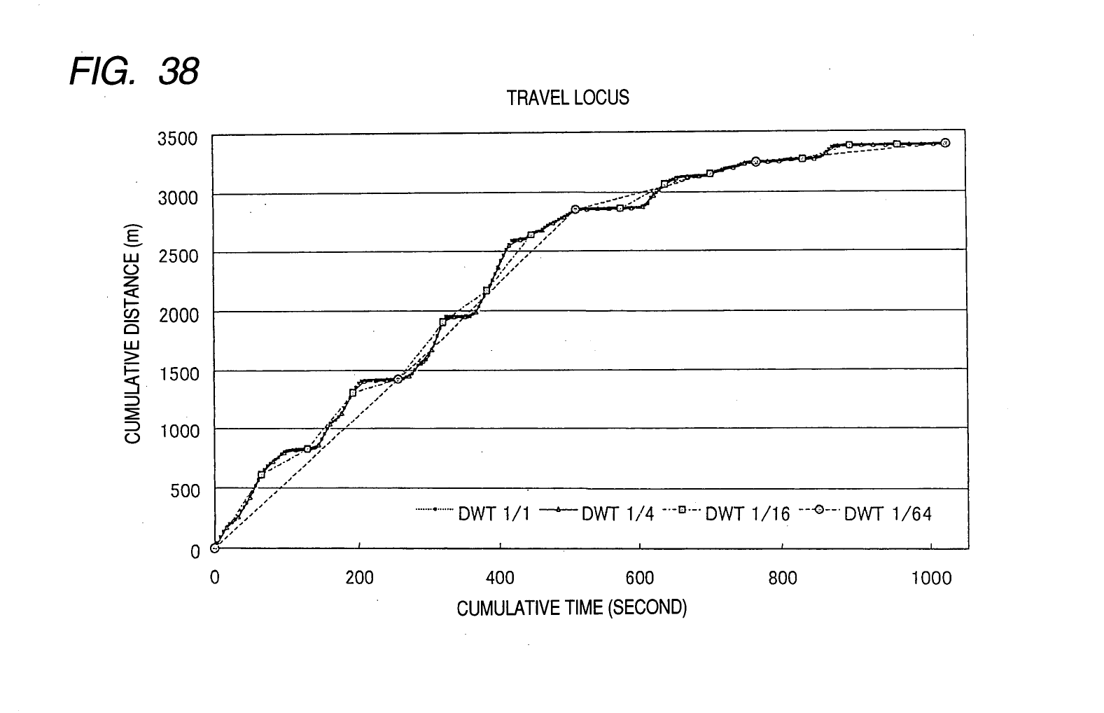

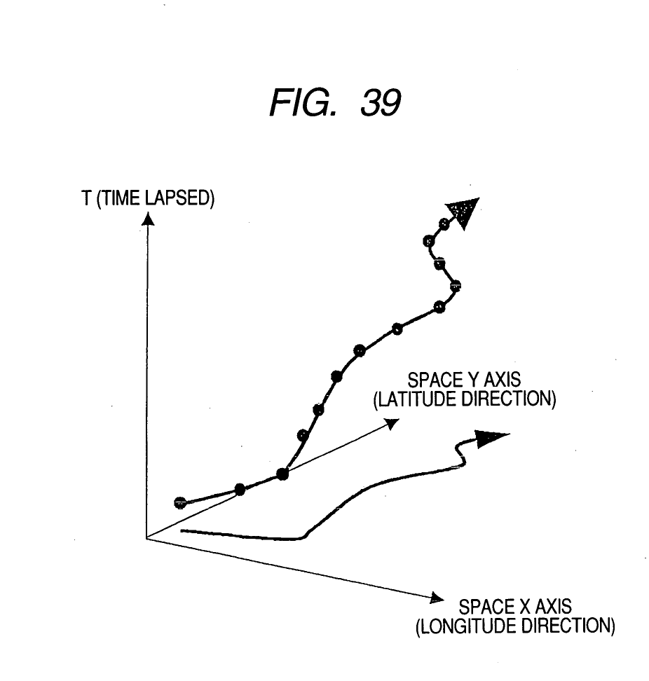

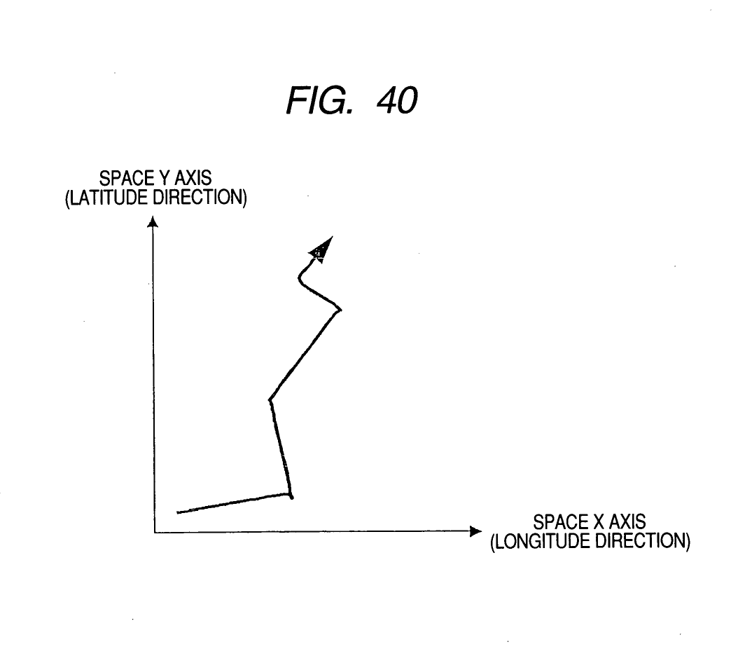

FIG. 37 shows a graph where DWT is performed on the travel distance data (original data) actually measured at a fixed time pitch of four seconds, and the data is restored, then the cumulative distance is obtained to reproduce a time-space locus. In the figure, thin doted lines show a time-space locus restored using all the data obtained through DWT (up to first-order wavelet coefficients). The solid lines show a time-space locus restored using ¼ of the data obtained through DWT (up to third-order wavelet coefficients). These loci are displayed in an overlapped fashion on the graph and are not clearly discriminated from each other. The original data displayed on the graph well matches these loci. The alternate long and short dashed lines show a time-space locus restored using 1/16 of the data obtained through DWT (up to fifth-order wavelet coefficients). The dashed lines show a time-space locus restored using 1/64 of the data obtained through DWT (up to sixth-order wavelet coefficients). As far as this graph is concerned, it is obvious that the halt position can be substantially reproduced even in case the information volume is reduced to some ¼. The horizontal axis and the vertical axis in FIG. 37 may be replaced with each other to provide representation in FIG. 38.

In this way, in the probe car system, the probe-car-mounted machine can represent measurement information by a function of time, perform DWT on the data and transmit the resulting data to the center. By using this method, the center can adequately grasp the state where the probe car speed is 0 (such as the halt position and halt time).

### Fifth Embodiment

(Discrete Wavelet Transform>

According to the traffic information providing method of the invention, the sensing party converts the speed information (V) to be provided to its inverse (1/V), performs discrete wavelet transform (DWT) on the data to compress the data, and transmits the compressed data. The receiving party decompresses the received speed information by using inverse wavelet transform (IDWT), converts the data to its inverse, and displays or utilizes the resulting data.

DWT is a data compression system used for image compression and voice compression. The general expression of wavelet transform is as shown in FIG. 1. The specific wavelet transform method has been described in the first embodiment.

<Meaning of Conversion of Speed Data to its Reciprocal>

This embodiment uses the reciprocal of speed information included in the “traffic information.”

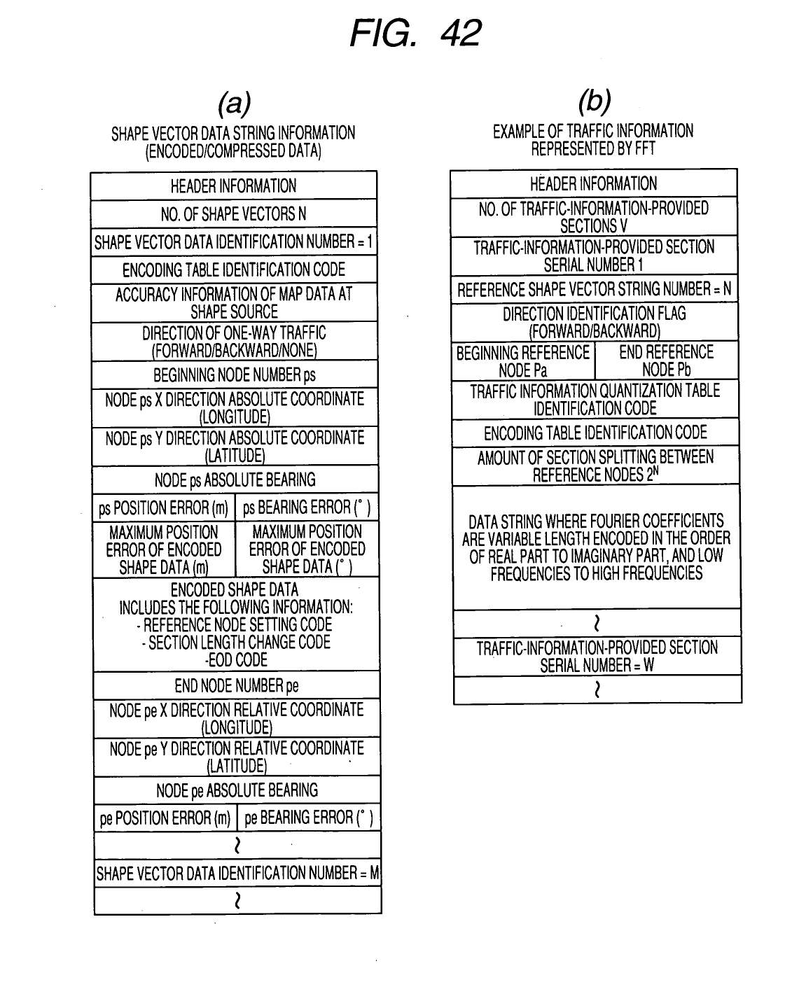

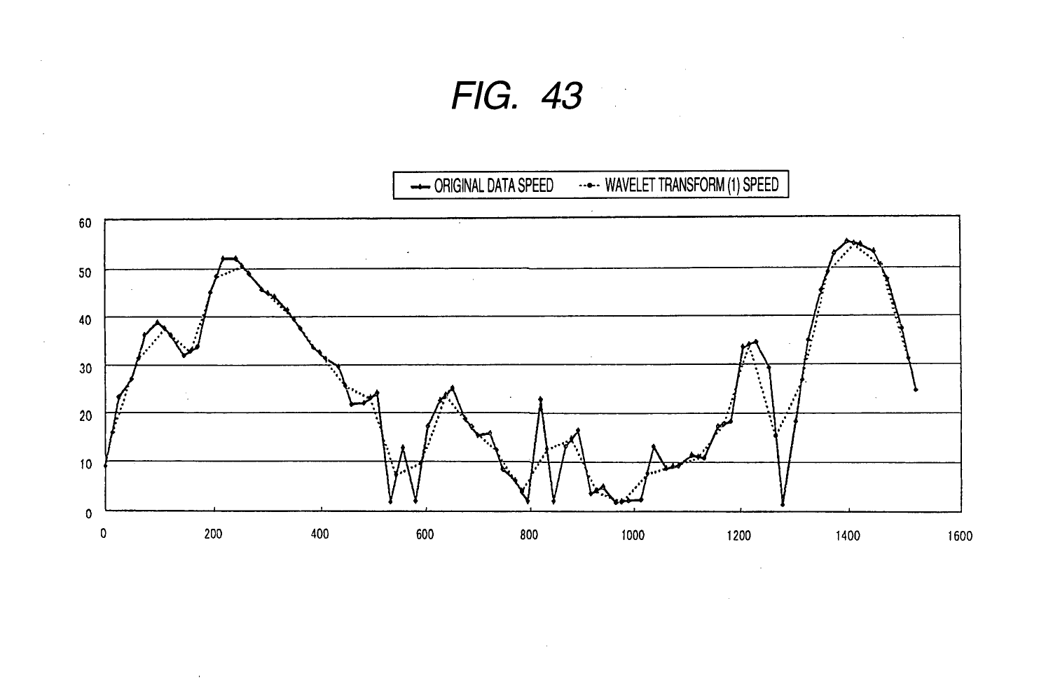

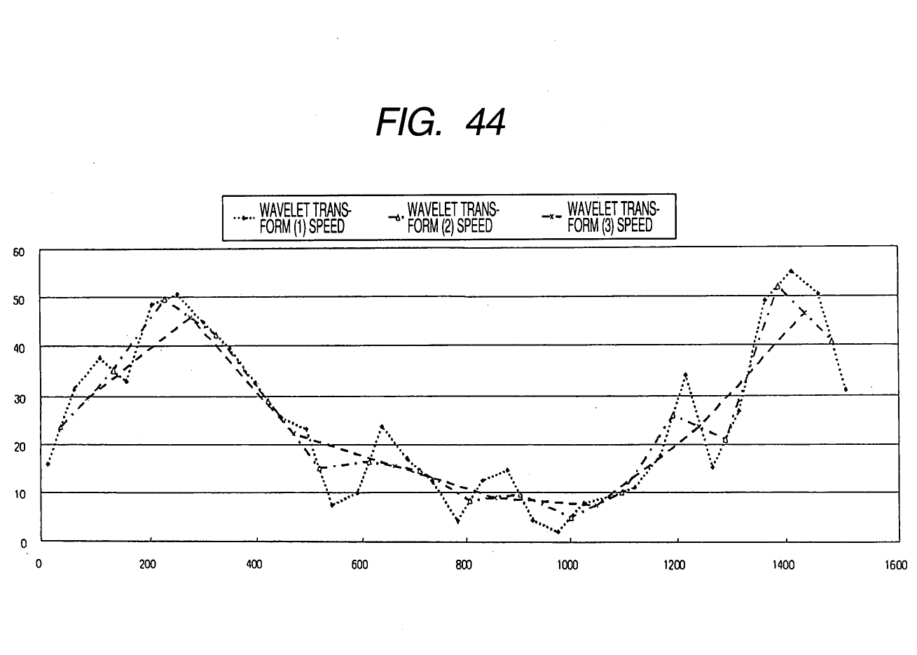

FIG. 43 shows original data (solid lines) and first-order scaling coefficients (dotted lines) obtained by performing one DWT process on the original data. FIG. 44 shows the first-order scaling coefficients (dotted lines) as well as the second-order scaling coefficients (alternate long and short dashed lines) and the third-order scaling coefficients (dashed lines) obtained by repeating the DWT process.

A scaling coefficient is obtained by smoothing the variations in the original data. As DWT is repeated and the order of the scaling coefficient becomes higher, the smoothing process advances. The scaling coefficient approximately represents the original data and thus helps recognize the rough state of the original data. The receiving party can reproduce rough variations in the original data by restoring the scaling coefficients at a certain level included in the data received, even when it has failed to receive all the data from the sensing party since the reception capacity or transmission capacity is insufficient.

The distance quantization unit of the first-order scaling coefficient is twice that of the original data. The value of the scaling coefficient is an average of original data values included in the distance quantization unit. The distance quantization unit of the second-order scaling coefficient is twice that of the first-order scaling coefficient. The value of the second-order scaling coefficient is an average of the first-order scaling coefficient values included in the distance quantization unit. That is, the distance quantization unit of an nth-order scaling coefficient is double the distance quantization unit of the (n−1)th-order scaling coefficients and the value of the nth-order scaling coefficient is an average of the (n−1)th-order scaling coefficient values included in the distance quantization unit.

Assuming that the original data is speed data, as mentioned earlier, a value obtained by simple arithmetic averaging does not correspond to the level of congestion the driver is actually experiencing.

To offset this disadvantage, the invention obtains the reciprocal (1/V) of speed data (V) and performs DWT on the reciprocal. In this case the reciprocal of speed data (1/V) represents a travel time per unit distance so that arithmetical mean is adequate.

<Traffic Information Providing System>

Configuration of the traffic information providing system of this embodiment is almost the same as that of the first embodiment shown in FIG. 5, except that the information transmitter 35 transmits speed information data and shape vector data.

The receiving party apparatus 60 comprises: an information receiver 61 for receiving the traffic information provided by the traffic information transmitter 30; a decoder 62 for decoding the received information to restore speed information and a shape vector; a map matching and section determination section 63 for performing map matching of a shape vector by using the data in the digital map database 65 to determine the target section of speed information; a traffic information reflecting section 64 for reflecting the received speed information into the data for the target section in the link cost table 66; a local vehicle position determination section 68 for determining the local vehicle position by using a GPS antenna 69 and a gyroscope 70; an information utilization section 67 for utilizing the link cost table 66 for route search from the local vehicle position to the destination; and guidance apparatus 71 for performing voice guidance based on the route search result.

Configuration of the traffic information measurement apparatus is the same as that in the first embodiment.

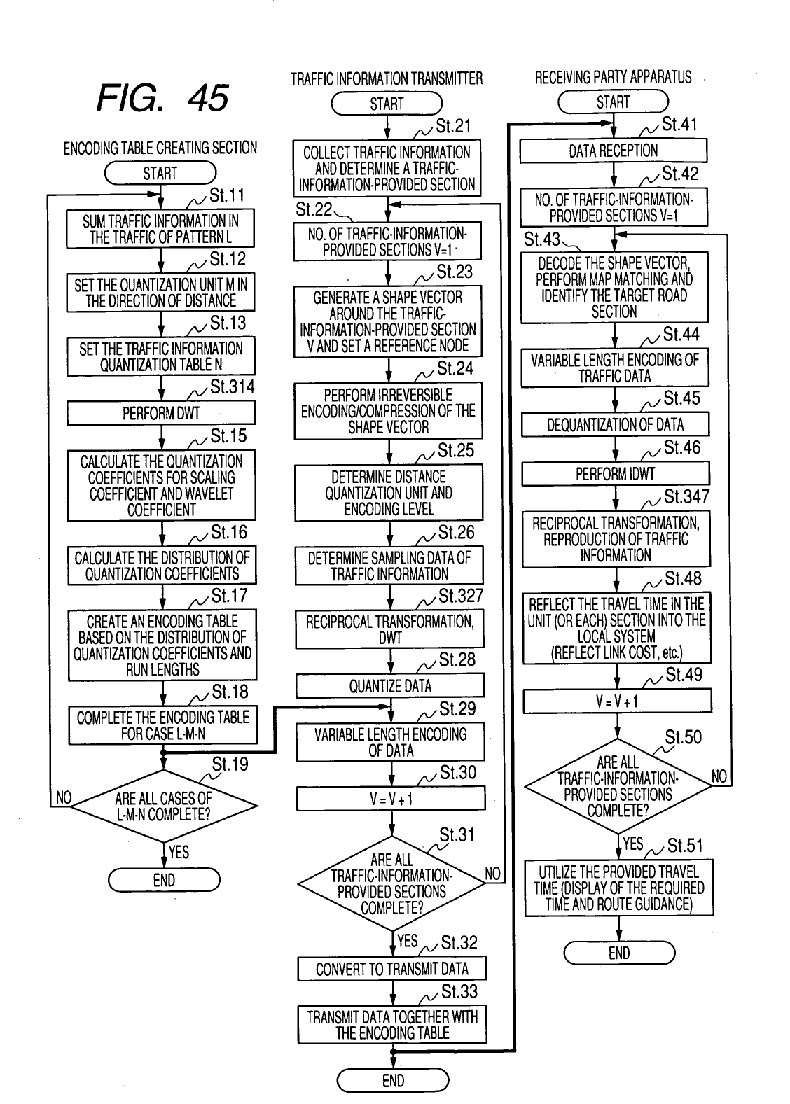

The flowchart of FIG. 45 shows the operation of the encoding table creating section 50, the traffic information transmitter 30 and the receiving party apparatus 60.

The encoding table calculator 51 of the encoding table creating section 50 analyzes the traffic patterns of traffic information transmitted from the traffic information measurement apparatus 10 and sums traffic information by pattern.

To create an encoding table, the encoding table calculator 51 sums traffic information in the traffic of pattern L (speed information) (step 11), sets a distance quantization unit M from among the quantization units of the direction of distance (distance quantization units) described in the distance quantization unit parameter table 54 (step 12), and sets a traffic information quantization table N used to quantize scaling coefficients and wavelet coefficients from the traffic information quantization table 53 (step 13). Next, the encoding table calculator 51 calculates a value (speed data in this embodiment) at each sampling point per interval M from the traffic information of the traffic pattern L, calculates the reciprocal of this value, and performs DWT on the reciprocal to obtain scaling coefficients and wavelet coefficients (step 314). The details of this procedure are given in the procedure of the traffic information transmitter 30.

Next, the encoding table calculator 51 uses the value specified in the traffic information quantization table N to quantize the scaling coefficients and wavelet coefficients and calculates the quantization coefficients of scaling coefficients and wavelet coefficients (step 15). Next, the encoding table calculator 51 calculates the distribution of the quantization coefficients (step 16) and creates the encoding table 52 used to variable-length encode the quantization coefficients of scaling coefficients and wavelet coefficients based on the distribution of quantization coefficients and run lengths (step 17), (step 18).

This procedure is repeated until the encoding table 52 corresponding to all combinations of L, M and N is created (step 19).

In this way, numerous encoding tables 52 corresponding to various traffic patters and resolutions of information representation are previously created and retained.

The traffic information transmitter 30 collects traffic information and determines the traffic-information-provided section (step 21). The traffic information transmitter 30 selects a traffic-information-provided section V as a target and creates a shape vector around the target traffic-information-provided section V and sets a reference node (step 23). Next, the traffic information transmitter 30 performs irreversible encoding/compression on the shape vector (step 24).

The quantization unit determination section 32 determines the traffic situation and determines the unit block length and data count of a sampling point interval to specify the position resolution as well as the traffic information quantization table 53 to specify the resolution of traffic information (speed information) and the encoding table 52 (step 25).

The following are to be noted in determining the position resolution:

A resolution as a unit of collection of information such as a travel time (for example 10 m) prespecified in an existing system may be used.

For a route distant from the information transmission point the distance resolution may be previously set to a coarse value depending on the importance.

Raw speed information collected from a probe car does not represent important information such as the beginning and end of congestion, so that the position resolution may be determined based on the data count.

The data count must be set to 2^{N} in data compression using FFT (fast Fourier transform). For DWT, the data count is desirably 2^{N} or a multiple of 2^{N} (that is, k×2^{N}, where k and N are positive integers). Note that, when data count does not reach k×2^{N} due to distance resolution, a value of “0” or an appropriate value (such as the last value of valid data) should be inserted until the data count reaches k×2^{N}.

Note the following when determining the resolution of speed information:

Resolution must be set to a multiple of accuracy, considering the measurement accuracy of speed.

A coarser resolution may be previously set to a less important route.

Rounding of data should be made depending on the resolution before sampling.

The final position resolution and traffic information resolution are determined depending on the transmission order in accordance with the importance of data at the sending party and the data reception volume and processing speed at the receiving party.

The traffic information converter 33 determines the sampling data of speed information based on the unit block length of the distance quantization unit determined by the quantization unit determination section 32 (step 26).

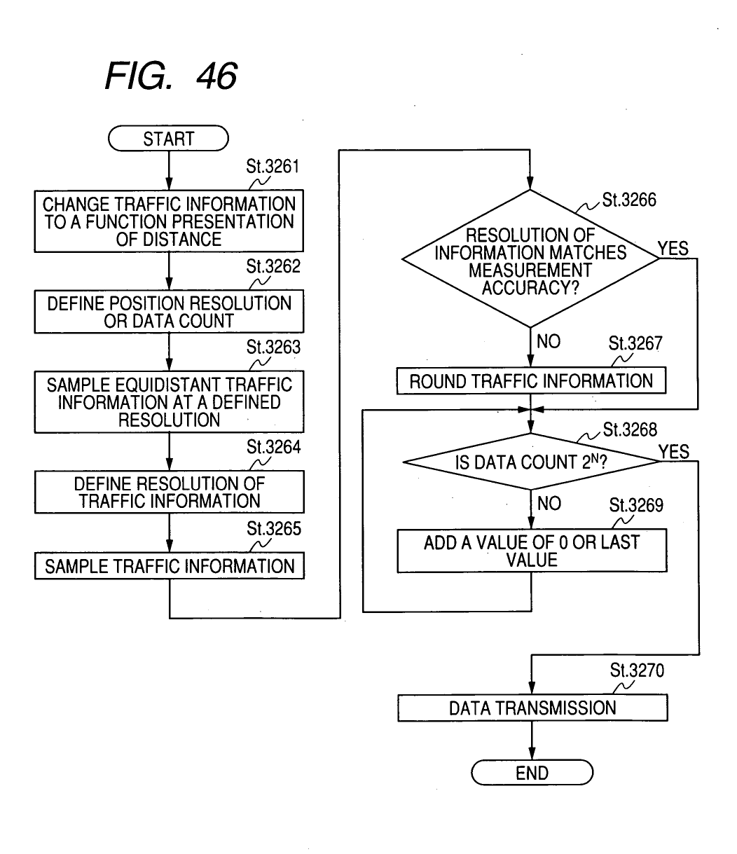

FIG. 46 shows a detailed procedure for setting the sampling data of traffic information. FIG. 47 shows sampling data (dotted lines) determined from the speed information (solid lines) collected by a probe car.

The speed information is represented by a function of distance by the traffic information calculator 14 (step 3261). The unit block length of distance quantization unit (position resolution) or data count is defined by the quantization unit determination section 32 (step 3262). The traffic information converter 33 equidistantly samples the speed information represented by a function of distance by way of a defined resolution (step 3263).

The quantization unit determination section 32 defines the resolution of traffic information which determines the coarseness of speed information (for example, whether to represent speed information in units of 10 km/h or 1 km/h) (step 3264). The traffic information converter 33 focuses on the data sampled in step 3263 (step 3265) and identifies whether the measurement accuracy matches the resolution of speed information (step 3266), and in case matching is not obtained (such as in case the defined traffic information resolution is in units of 10 km/h and data is represented in units of 1 km/h), rounds the traffic information (step 3267).

FIG. 47 shows a case where original data is rounded to obtain sampling data in units of 10 km/h.

Next, the traffic information converter 33 identifies whether the sampling data count is k×2^{N} (step 3269). In case it is not k×2^{N}, the traffic information converter 33 adds a value of 0 or the last numeral and sets the sampling data count to k×2^{N} (this example assumes k=1) (step 3269). The traffic information converter 33 transmits the sampling data thus generated to the DWT encoder 34 (step 3270).

In the case of FIG. 37, the data count is 8 (=2³) so that sampling data is not added.

Referring to FIG. 45 again, the DWT encoder 34 calculates the reciprocal of the sampling data and performs DWT on the reciprocal (step 327).

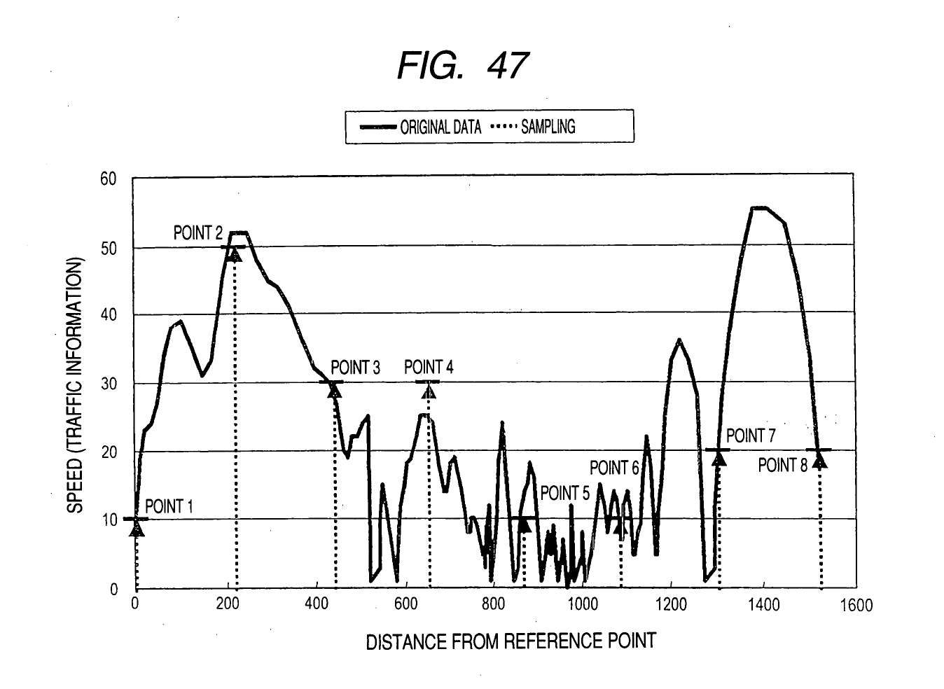

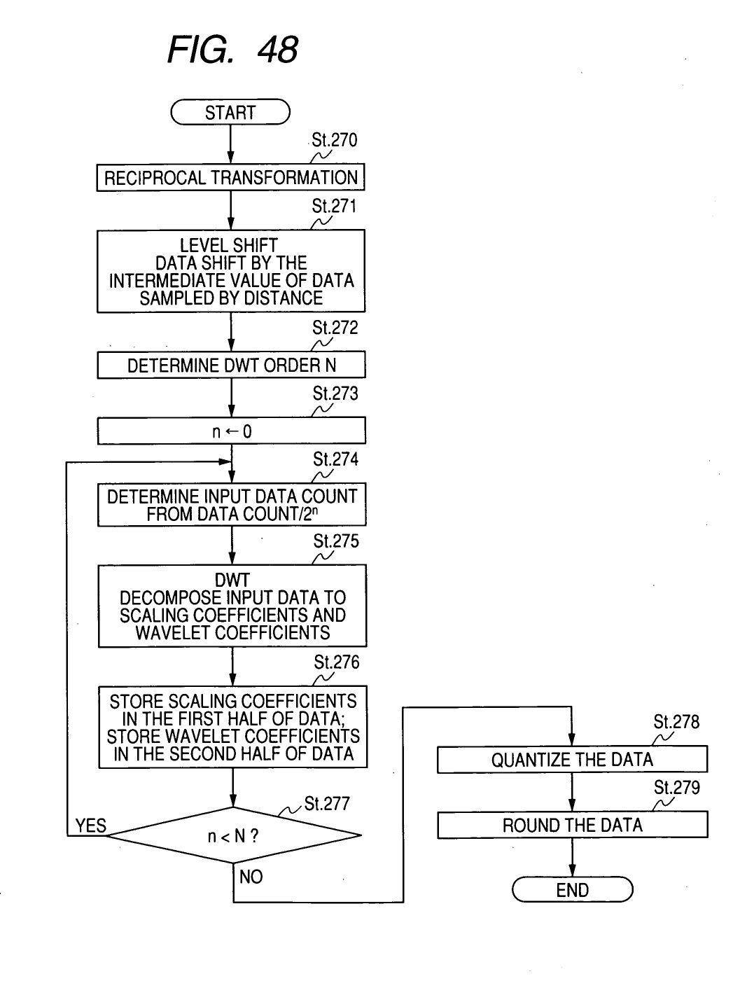

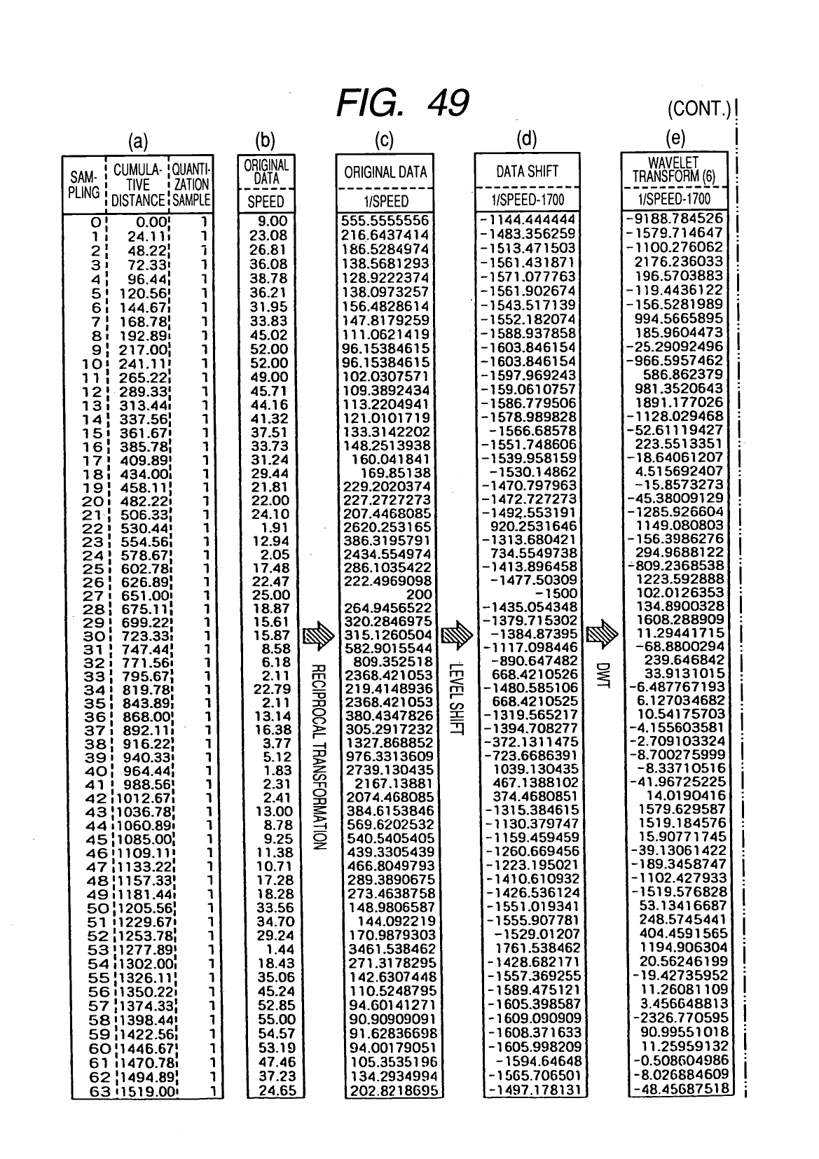

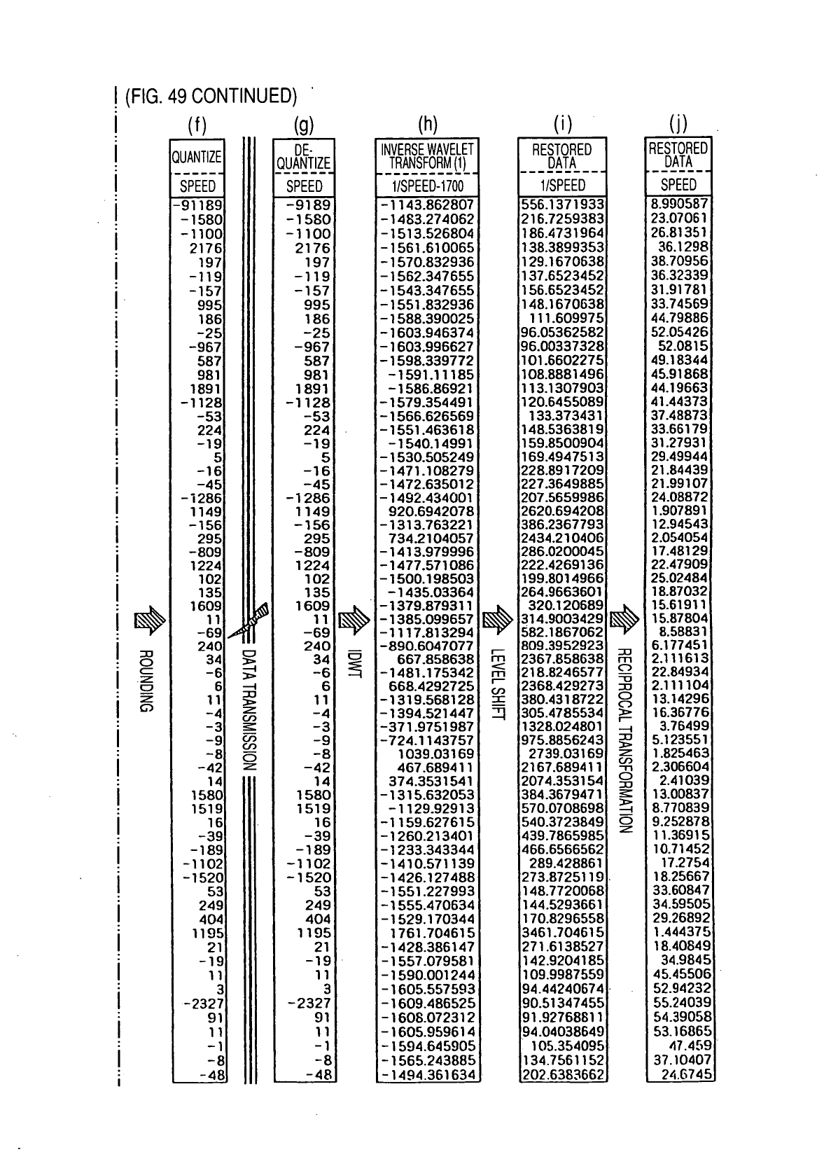

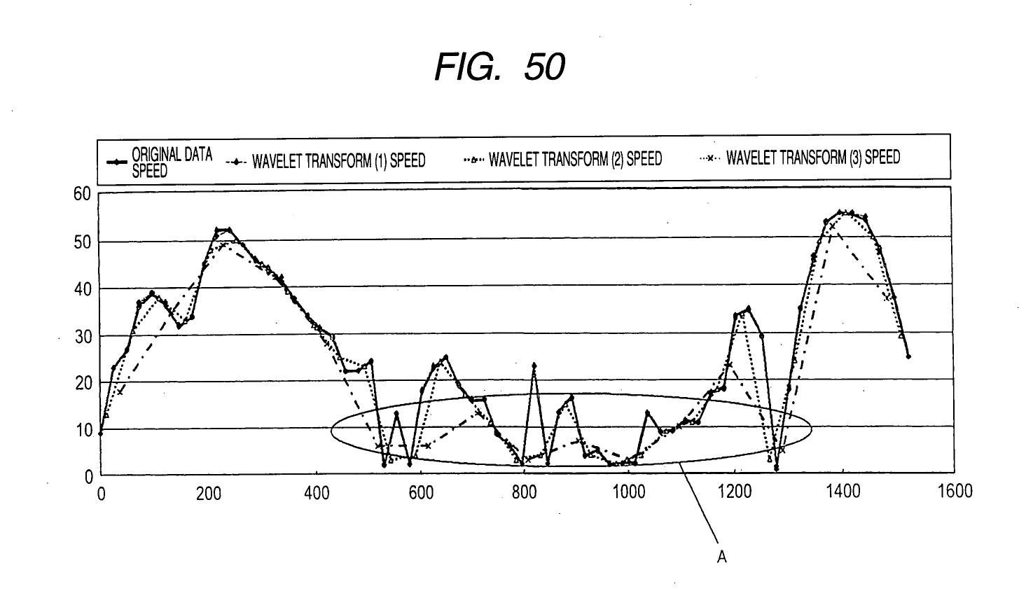

FIG. 48 shows a detailed DWT procedure. As shown in FIG. 49A, 64 (=2⁶) speed data items measure at intervals of 24.11 m are extracted as sampling data, whose raw data is shown in FIG. 49B. FIG. 50 shows a graph of this raw data in solid lines.

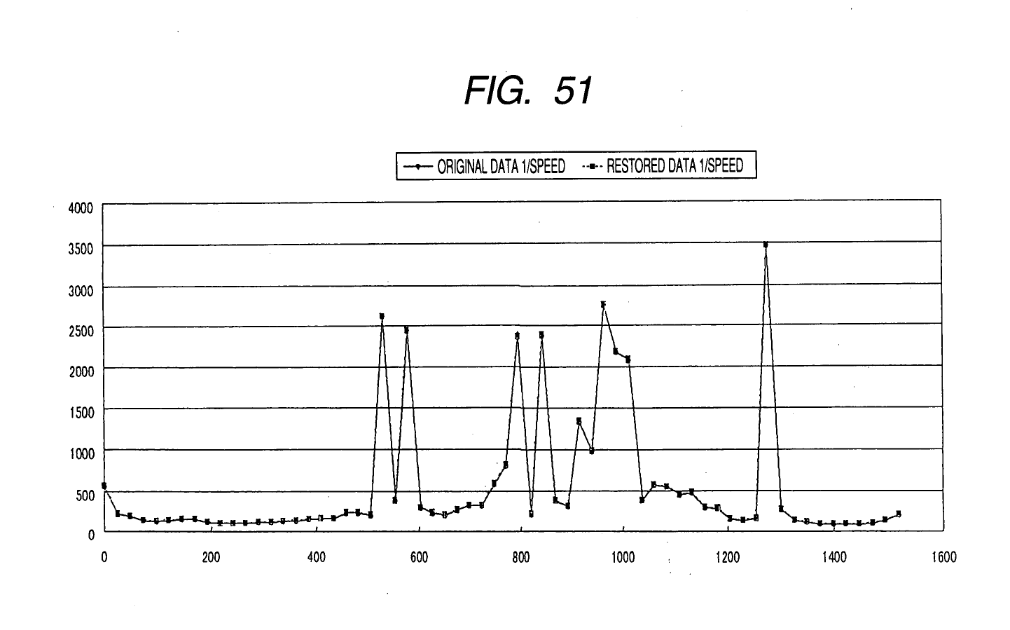

The DWT encoder 34 converts the sampling data to its reciprocal and multiplies the reciprocal by a constant so that the reciprocal will have a value equal to or larger than 1 (step 270). Multiplication of the reciprocal by a constant is made so that the reciprocal whose fraction is rounded off in a subsequent process will be an integral value. The constant is for example 1000 or 5000. The larger the constant is, the smaller the degradation of information becomes and data can be represented irrespective of the speed. When this constant is smaller, the information in a higher frequency becomes coarser. FIG. 49C shows the sampling data whose reciprocal is multiplied by 5000. FIG. 51 is a graph showing the reciprocal multiplied by the constant in solid lines.

Next, in order to reduce the absolute value of data converter to its reciprocal, the intermediate value between the maximum value and minimum value of data is set to a reference (0) and all the data levels are shifted by the intermediate value (step 271). In FIG. 49, the intermediate value is set to 1700 and 1700 is subtracted from the value in FIG. 49C (FIG. 49D).

Next, the DWT order N is determined. In case the sampling data count is 2^{m}, the order N can be set to a value at maximum (step 272). In the case of FIG. 49, the sampling data count is 2⁶ so that the maximum order is 6.

Then, n=0 is set (step 273) and the input data count is determined by way of the sampling data count/2ⁿ (step 274), and DWT using (Expression 8) and (Expression 9) mentioned earlier is applied to the sampling data to generate first-order scaling coefficients and first-order wavelet coefficients from the input data (step 275).

In the case of FIG. 49, the data count when n=0 is 64. DWT on the 64 data items generates 32 first-order scaling coefficients being half the input data count and 32 first-order wavelet coefficients.

The obtained scaling coefficients and wavelet coefficients are stored in the first half of the data and in the second half of the data, respectively (step 276). As shown in FIG. 49, in case 64 data items are arranged vertically, 32 higher-order data items are first-order scaling coefficients and 32 lower-order data items are first-order wavelet coefficients.

In case n are N are compared with each other and n<N (step 277), execution returns to step 274, where the order is incremented by 1 and the input data count is determined from the data count/2ⁿ. In this case, only the scaling coefficients stored in the first half of the data in step 276 serve as the next input data. In the case of FIG. 49, for the second-order DWT, 32 first-order (n=1) scaling coefficients serve as input data. From the data, 16 second-order scaling coefficients and 16 second-order wavelet coefficients are generated through second-order DWT. The scaling coefficients are stored in the first half of the data and the wavelet coefficients in the second half of the data.

Steps 274 through 276 are repeated until n reaches N (step 277). In the case of FIG. 49, when N=6, for the third-order DWT, 16 second-order scaling coefficients serve as input data. From the data, 8 third-order scaling coefficients and 8 third-order wavelet coefficients are generated through third-order DWT. For the fourth-order DWT, 8 third-order scaling coefficients serve as input data. From the data, 4 fourth-order scaling coefficients and 4 fourth-order wavelet coefficients are generated through 2 fourth-order DWT For the fifth-order DWT, 4 fourth-order scaling coefficients serve as input data. From the data, 2 fifth-order scaling coefficients and 2 fifth-order wavelet coefficients are generated through fifth-order DWT. For the sixth-order DWT, 2 fifth-order scaling coefficients serve as input data. From the data, one sixth-order scaling coefficient and one sixth-order wavelet coefficient are generated through sixth-order DVT.

FIG. 49E shows the data generated by up to sixth DWT. From top to bottom are arranged one sixth-order scaling coefficient, one sixth-order wavelet coefficient, 2 fifth-order wavelet coefficients, 4 fourth-order wavelet coefficients, 8 third-order wavelet coefficients, 16 second-order wavelet coefficients and 32 first-order wavelet coefficients.

Next, the DWT encoder 34 quantizes the scaling coefficients and wavelet coefficients by using the traffic information quantization table 53 determined by the quantization determination section 32 (step 278). The traffic information quantization table 53 specifies a value p used to divide a scaling coefficient and a value q (≧p) used to divide a wavelet coefficient. In the quantization processing, a scaling coefficient is divided by p and a wavelet coefficient is divided by q, and the data obtained is rounded (step 279). The quantization processing may be skipped (corresponding to a case where p=q=1) and only rounding of data may be made. Instead of quantization, inverse quantization may be performed to multiply a scaling coefficient and a wavelet coefficient by a predetermined integer.

In FIG. 49, the scaling coefficients and the wavelet coefficients are divided by the quantization sample value 1 specified in FIG. 49A and the fraction is rounded off to obtain the integral value in FIG. 49F. When the constant used for multiplication of the reciprocal of sampling data in step 270 is smaller, the integral value is smaller and the influence of rounding becomes greater so that the accuracy of information will drop.

When the constant is too large, the transmission data volume becomes larger. The influence of rounding becomes greater in case the integral value is smaller, that is, in case the speed is higher. For a road such as an ordinary road where the speed limit is inherently set to 40 km/h, it is not necessary to precisely grasp the data above 40 km/h. In consideration of background, it is necessary to define a constant used to multiply the reciprocal of speed. For an expressway, the speed limit is as high as 80 km/h so that the constant value may be changed depending on the road type and road control.

Referring to FIG. 45 again, the DWT encoder 34 variable-length encodes the quantized (or inverse-quantized) data by using the encoding table 52 determined by the quantization determination section 32 (step 29). The variable-length encoding may also be skipped.

The DWT encoder 34 executes the above processing for all the traffic-information-provided sections (steps 30, 31).

The information transmitter 35 converts the encoded data to transmit data (step 32) and transmits the data together with the encoding table (step 33).

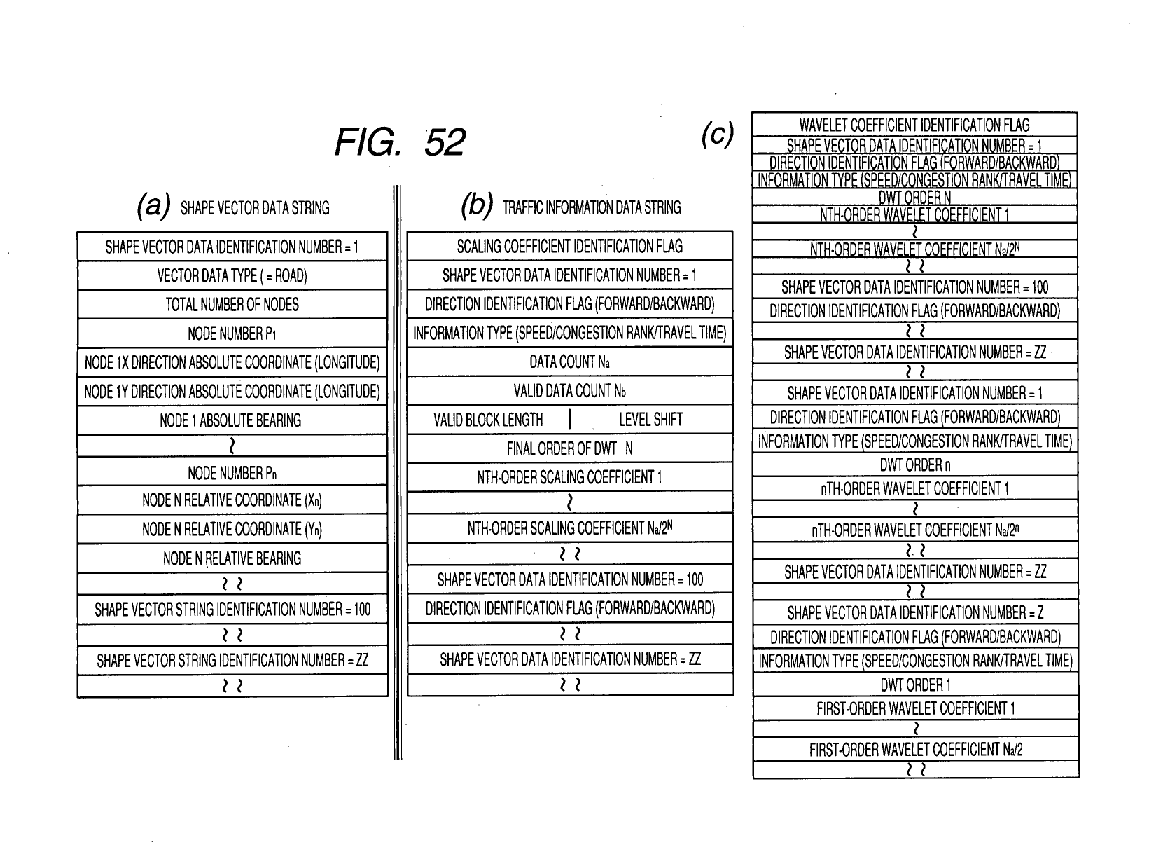

FIG. 52 shows an exemplary structure of data transmitted from the traffic information transmitter 30. FIG. 52A shows a shape vector data string representing the target road section of traffic information. FIG. 52B is a traffic information data string including only the scaling coefficients of the target road sections. This data string describes Nth-order scaling coefficients where N is the final order of DWT. In case the sampling data count is k×2^{N}, the number of the nth scaling coefficients is k.

FIG. 52C is a traffic information data string including only the wavelet coefficients of the target road sections. This data string describes wavelet coefficients used for each order of DWT The information transmitter 35 transmits the information of the shape vector data string (FIG. 52A) together with the traffic information describing the scaling coefficients of the target road sections (FIG. 52B), then transmits the traffic information concerning wavelet coefficients (FIG. 52C), from highest to lowest DWT order.

As shown in FIG. 45, in the receiving party apparatus 60, when the traffic information receiver 61 receives data (step 41), the decoder 62 decodes the shape vector for each traffic-information-provided section V (step 42) and the map matching and section determination section 63 performs map matching on its digital map database 65 to identify the target road section (step 43). The decoder 62 references an encoding table to perform variable-length decoding (step 44) or inverse quantization (quantization in case inverse quantization is has been made by the sending party) (step 45). FIG. 49G shows the speed information data dequantized by the receiving party.

The decoder 62 performs IDWT on the data obtained through inverse quantization (step 46).

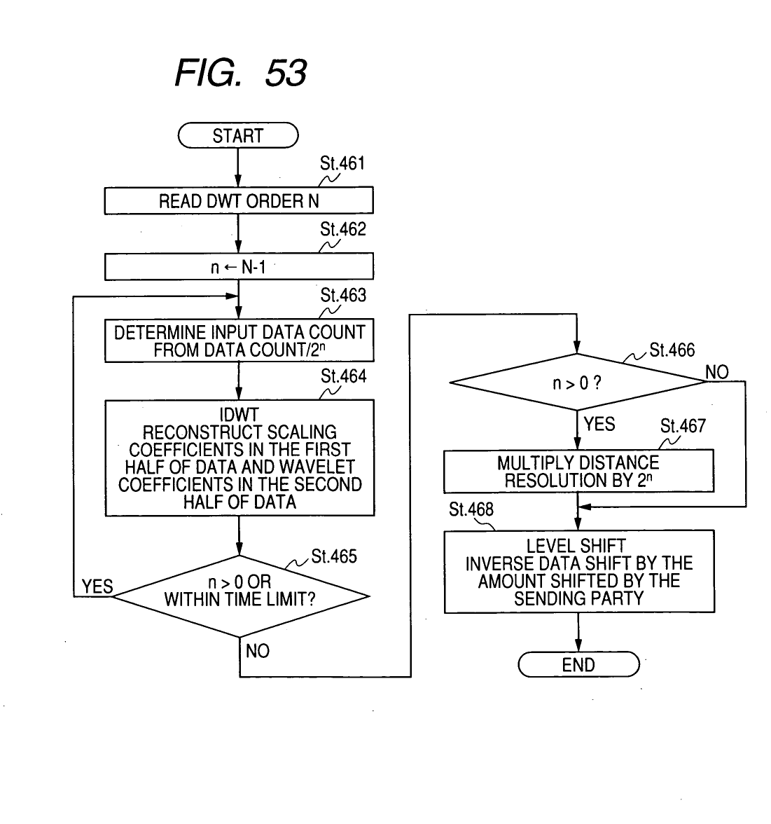

FIG. 53 shows a detailed IDWT procedure. The decoder 62 reads the DWT order N from the speed information data received (step 461), sets n to N−1 (step 462), and determines the input data count by way of data count/2ⁿ (step 463). Then, by storing the scaling coefficients in the first half of the input data and wavelet coefficients in the second half of the input data, the decoder 62 rearranges the data by way of (Expression 10) and (Expression 11) (step 464).

In the case of FIG. 49, N=6 so that the data count is 2 (64/22⁵), and 2 fifth-order scaling coefficients are reconstructed from one sixth-order scaling coefficient and one sixth-order wavelet coefficient received.

In case n>0 or within a time limit, execution returns to step 463, where the decoder 62 decrements n by 1 and repeats steps 463 and 464 (step 465). In the case of FIG. 49, assuming that time limit is not applied, 4 fourth-order scaling coefficients are generated from 2 fifth-order scaling coefficients generated and 2 fifth-order wavelet coefficients received; 8 third-order scaling coefficients are generated from the 4 fourth-order scaling coefficients and 4 fourth-order wavelet coefficients received; 16 second-order scaling coefficients are generated from the 8 third-order scaling coefficients and 8 third-order wavelet coefficients received; 32 first-order scaling coefficients are generated from the 16 second-order scaling coefficients and 16 second-order wavelet coefficients received; and 64 data items are restored from the 32 first-order scaling coefficients and 32 first-order wavelet coefficients received. FIG. 49H shows the speed data restored by repeating IDWT six times.

When n=0 and IDWT is over, the decoder 62 inverse-shifts the data by the amount the sending party has shifted the data (step 468). FIG. 491 shows the restored data which has been inverse-shifted. FIG. 51 shows a graph of this restored data in dotted lines. The restored data matches the original data almost perfectly.

When a predetermined time limit has elapsed, the encoder 62 completes IDWT even when n>0 and sets the unit length of the distance quantization unit (distance resolution) to 2ⁿ (step 467), then inverse-shifts the data by the amount the sending party has shifted the data (step 468) in order to display the lower-resolution speed information by using the speed data obtained so far.

The receiving party apparatus can restore the lower-resolution speed information even in case it has received the transmit data shown in FIG. 49F only partially because the time limit has elapsed. In case only the sixth order scaling coefficients are received data of ½⁶= 1/64 the distance resolution of original data can be restored.

When up to the sixth-order wavelet coefficients are received, data of ½⁵= 1/32 the distance resolution of original data can be restored by performing IDWT in combination with the received data to restore fifth-order scaling coefficients.

When up to the fifth-order wavelet coefficients are received, data of ½⁴= 1/16 the distance resolution of original data can be restored by performing IDWT in combination with the received data to restore fourth-order scaling coefficients.

When up to the fourth-order wavelet coefficients are received, data of ½³=⅛ of the distance resolution of original data can be restored by performing IDWT in combination with the received data to restore third-order scaling coefficients.

When up to the third-order wavelet coefficients are received, data of ½²=¼ the distance resolution of original data can be restored by performing IDWT in combination with the received data to restore second-order scaling coefficients.

When up to the second wavelet coefficients are received, data of ½ the distance resolution of original data can be restored by performing IDWT in combination with the received data to restore first-order scaling coefficients.

When up to the first wavelet coefficients are received, the distance resolution data of original data can be restored by performing IDWT in combination with the received data.

To facilitate data restoration at the receiving party, the sending party transmits data in the order of scaling coefficients, high-order wavelet coefficients and low-order wavelet coefficients.

The decoder 62 obtains the reciprocal of the restored data and multiplies the reciprocal by the constant used for multiplication by the sending party to reproduce speed information (step 347). FIG. 49J shows the restored speed data. FIG. 50 shows a graph of the restored speed data entitled “Wavelet transform (1) speed” although the restored speed data is overlapped on the original data so that both cannot be discriminated from each other. FIG. 50 shows the data restored using the data in the Nth- through first-order layers entitled “Wavelet transform (2) speed” in dotted lines. FIG. 50 further shows the data restered using the data in the Nth- through second order layers entitled “Wavelet transform (3) speed” in alternate long and short dashed lines.

The traffic information reflecting section 64 reflects the decoded speed information into the link cost of the system (step 48). This processing is executed for all traffic-information-provided sections (steps 49, 50). The information utilization section 67 utilizes the provided speed information to execute display of the required time and route guidance (step 51).

In this way, the DWT-processed data has layers. In case the receiving party ca use only the data in some of the layers, it is possible to restore speed information at a low resolution. In this case, the reciprocal of the original data of speed information is obtained and the reciprocal is multiplied by a constant to perform DWT. Thus, the receiving party can restore a value matching the level of congestion the driver is actually experiencing from speed information using data in some of the layers.

Graphs shown in FIGS. 43 and 44 show the restored data obtained in case the original data of speed information is DWT-processed without using the reciprocal, for the purpose of comparison. As understood from comparison between FIG. 50 and FIGS. 43 and 44, in a case where the reciprocal of speed information is obtained before performing DWT (FIG. 50), the data restored from the data in some of the layers have smaller values than in a case where conversion to the reciprocal is skipped (FIGS. 43 and 44). This tendency is noticeable in the elliptic area A in FIG. 50.

In this way, by obtaining the reciprocal of speed information before performing DWT, the average speed comes closer to a lower value although the average speed is closer to a speed the driver is actually experiencing.

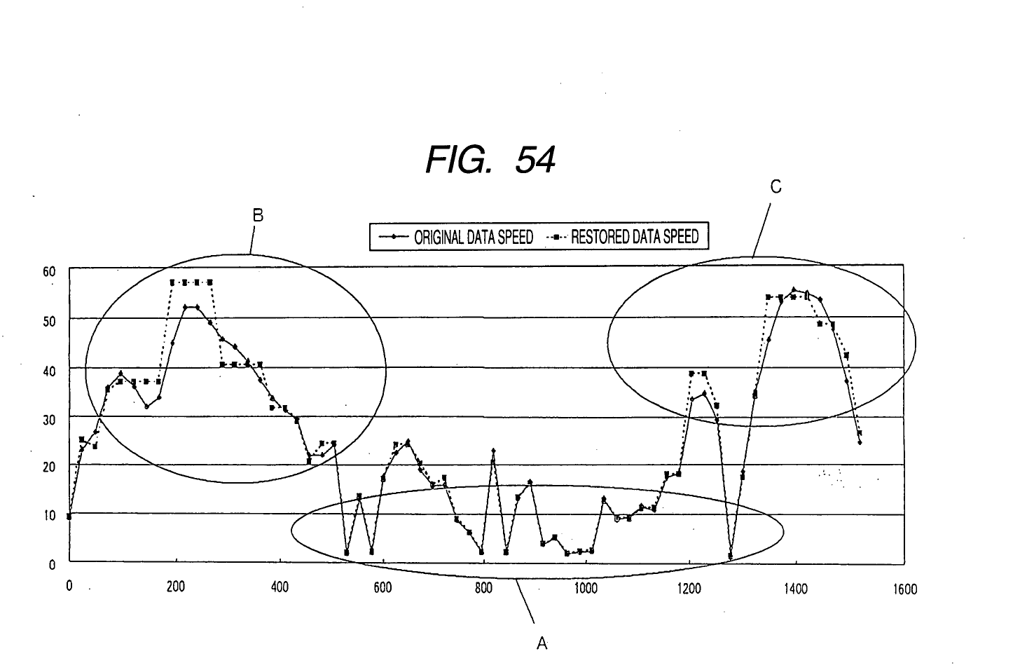

FIG. 54 shows the original data and restored data assumed in case the constant used for multiplication of the reciprocal of the original data is set to one-50th that in FIG. 50 (in other words, 100). When the constant used for multiplication of the reciprocal of the original data becomes smaller, the high-speed range information indicated by the elliptic areas B and C becomes very coarse while the restored data on the low-speed range well matches the original data. Traffic congestion information of interest is mainly a lower travel speed. Detailed information on a speed close to or above the speed limit of an ordinary road is not necessarily required. In consideration of this, a constant 100 used for multiplication of the reciprocal of the original data can restore sufficiently practical speed information. As mentioned earlier, the constant value may be changed depending on the road type and road control.

In this way, DWT processed data has layers. Data in all the layers may be used to perform lossless compression (reversible conversion). Data in some of the layers may be used to perform lossy compression (irreversible conversion). Even in case the receiving party can receive information with some data loss, it is possible to restore information at a low resolution. When the sending party sets priorities to the layers and transmits data in the order of scaling coefficients, high-order wavelet coefficients and low-order wavelet coefficients without considering the communications environment or reception performance, the receiving party can reproduce minute or coarse speed information depending on the received data.

The speed data is converted to its reciprocal before performing DWT. Thus, even in case an arithmetical averaging is made in restoration of speed information from data in some of the layers, there is no gap between the restored speed information and the level of congestion the driver is actually experiencing.

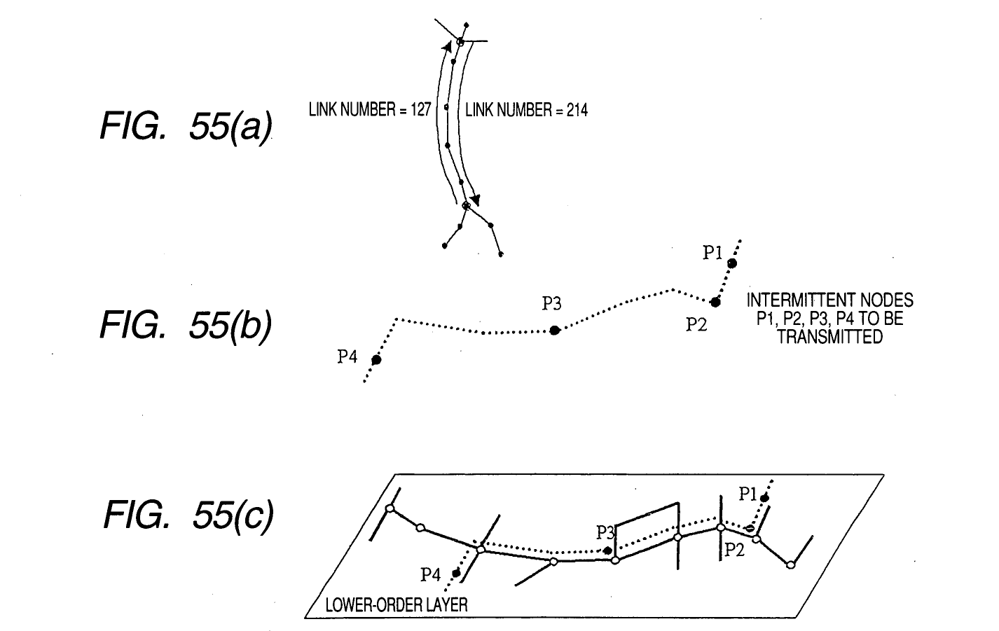

While a case has been described where a shape vector data string is communicated to the receiving party in order to notify the target road section, and the receiving party references the shape vector data string to identify the target road section of traffic information, the data to identify a road section (road section reference data) may be other than a shape vector data string. For example, as shown in FIG. 55A, a uniformly specified road section identifier (link number) or intersection identifier (nor number) may be used instead.

In case both the providing party and the receiving party reference the same map, the providing party can communicate the latitude/longitude data to the receiving party and the receiving party can used the data to identify the road section.

Or, as shown in FIG. 55B, the providing party may transmit to the receiving party the latitude/longitude data (data having attribute information such as names and road types) to reference positions of intermittent nodes P1, P2, P3, P4 extracted from an intersection or a road in the middle of a link in order to communicate the target road. In this example, P1 is a link midpoint, P2 is an intersection, P3 is a link midpoint, and P4 is a link midpoint. In this case, the receiving party identifies the position of each of P1, P2, P3 and P4 and interconnects each section through path search to identify the target road, as shown in FIG. 55C.

Road section reference data to identify a target road may be other than the aforementioned shape vector data string, road section identifier and intersection identifier. For example, an identifier assigned to each tile-shaped segment of a road map, a kilo post installed at a road, a road name, an address, and a ZIP code may be used as position reference information to identify a target road section of traffic information.

### Sixth Embodiment

Concerning the sixth embodiment of the invention, a method for removing noise included in traffic information is described.

Detailed traffic information on the state volume of the low-speed range which notifies congestion or traffic jam is useful while detailed information on the state volume of the high-speed range is unwanted noise which adds to the transmission volume.

Raw data which represents traffic information at a high resolution includes such noise. The noise is removed by the data sending party and the receiving party can perform decoding without considering the presence of noise.

In this method of the embodiment, speed data is converted to its reciprocal, which undergoes DWT to generate scaling coefficients and wavelet coefficients. When the resulting data is transmitted to the receiving party, a wavelet expansion coefficient having a small absolute value is assumed as a noise component and processed as a value of 0.

Removal (processing as a value of 0) of a wavelet expansion coefficient having a small absolute value has an influence on the speed data of the high-speed range, not on the peed data of the low-speed range.

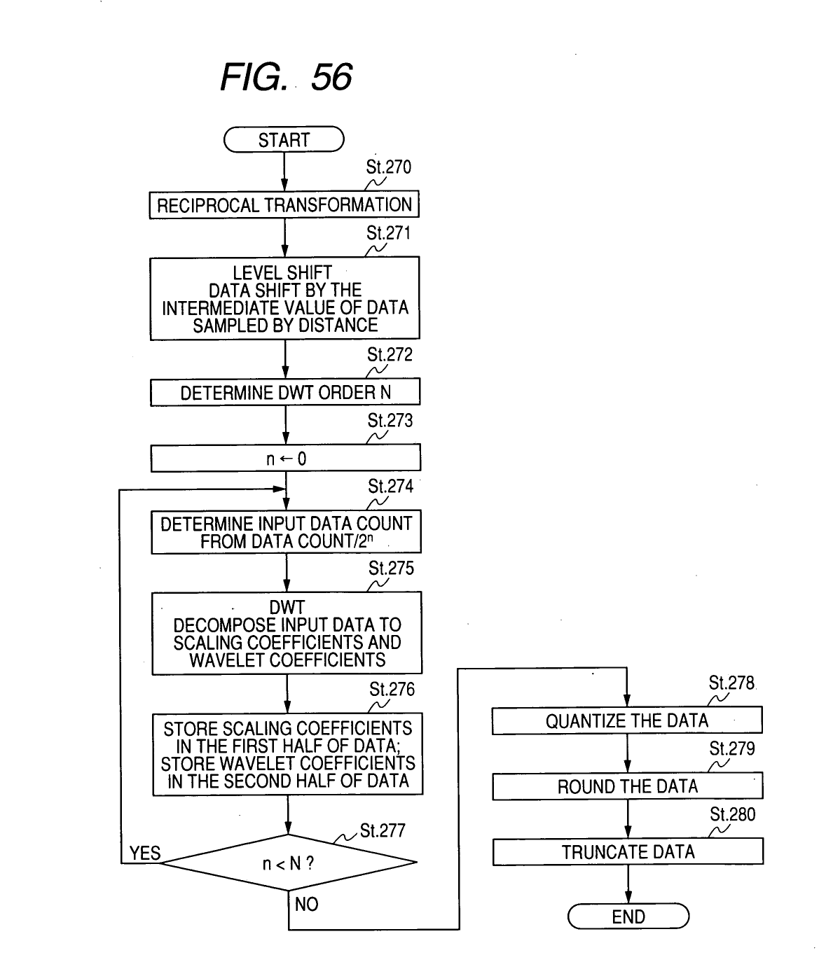

FIG. 56 shows a flowchart of DWT compression of speed information including noise removal procedure. By using steps 270 through 279 in FIG. 48, speed data converted to its reciprocal is DWT-processed to generate scaling coefficients and wavelet coefficients, and wavelet coefficients having small absolute values are truncated (step 280).

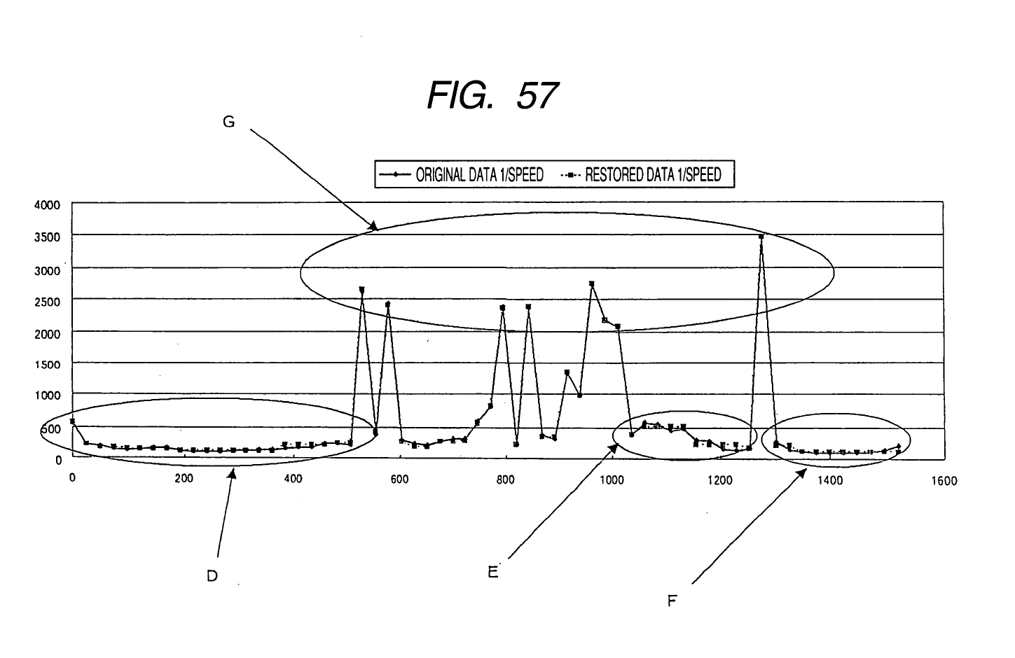

Truncation (processing as a value of 0) of data in step 280 removes as noise the movement of minute speeds of the high-speed range included in the elliptic areas D, E, F in the graph displaying the reciprocal of speed data (FIG. 57). The data of the high-speed range is thus influenced. However, the data of the low-speed range indicated by an elliptic area G is not influenced at all.

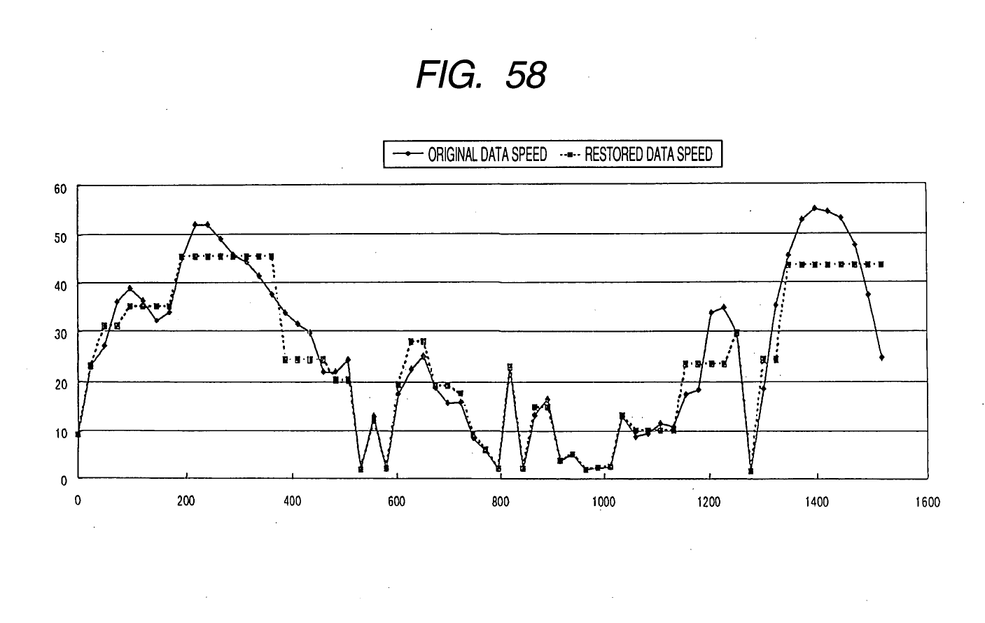

FIG. 58 shows the speed information of original data in solid lines and the speed information restored using the data with wavelet coefficients having small absolute values removed (processed as values of 0) in dotted lines. As understood from FIG. 58, the accuracy of data of the high-speed range is coarse although the data of the low-speed range of interest as traffic congestion information faithfully reproduces the original data.

The transmission volume is dramatically reduced through variable length encoding in step 29 of FIG. 45, by processing all the wavelet coefficients having small absolute values as values of 0.

In this way, the traffic information providing method which converts speed data to its reciprocal and performs DWT processes the wavelet expansion coefficients having small absolute values as values of 0 to remove noise components thereby reducing the overall data volume.

### Seventh Embodiment

While the fifth and sixth embodiments of the invention pertain to a case where the traffic information providing apparatus as a center provides traffic information to traffic information utilization apparatus such as a car-mounted machine, the traffic information providing method of the invention is also applicable to a system where a car-mounted machine on a probe car which provides travel data serves as traffic information providing apparatus and a center which collects information from the probe car serves as traffic information utilization apparatus. Concerning the seventh embodiment of the invention, this system is described.

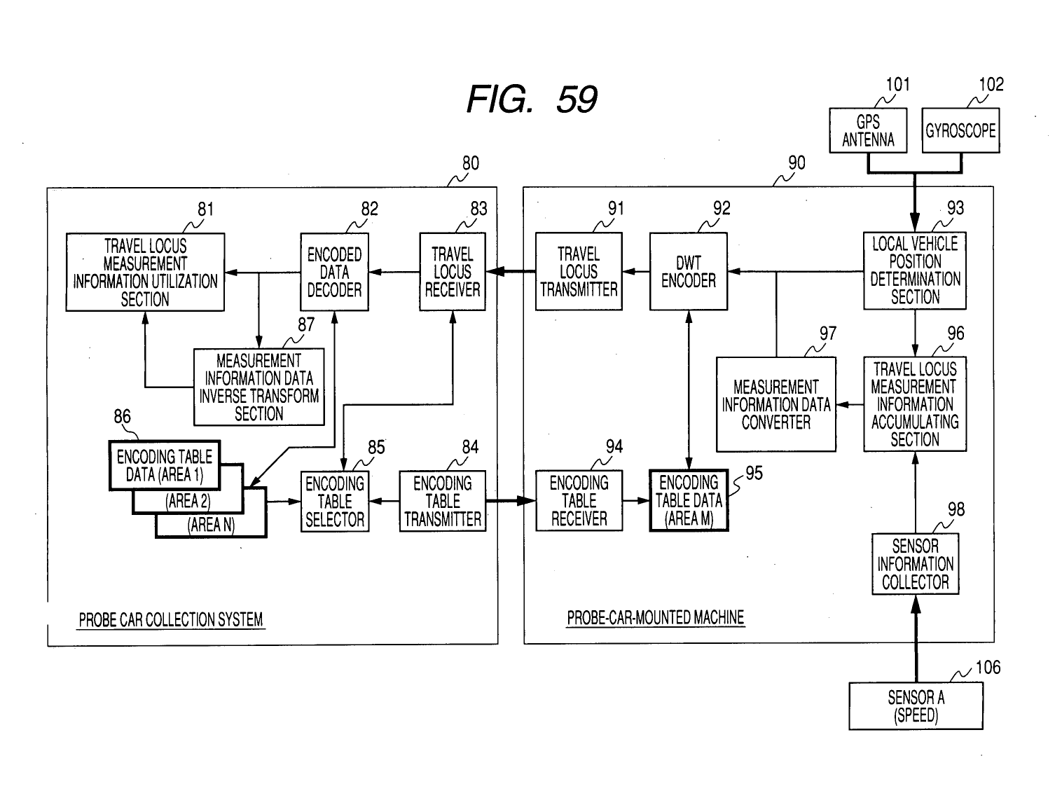

As shown in FIG. 59, the system comprises a probe-car-mounted machine 90 for measuring and providing travel data and a probe car collection system 80 for collecting data. The probe-car-mounted machine 90 comprises: an encoding table receiver 94 for receiving an encoding table used to encode transmit data from the probe car collection system 80; a sensor A for detecting a speed; a sensor information collector 98 for collecting information detected by the sensor A 106; a local vehicle position determination section 93 for determining the local vehicle position by using the information received by a GPS antenna 101 and information from a gyroscope 102; a travel locus measurement information accumulating section 96 for accumulating the travel locus of the local vehicle and the speed information detected by the sensor A 106; a measurement information data converter 97 for generating sampling data of speed information; a DWT encoder 92 for performing DWT on the reciprocal of speed data to convert the reciprocal to scaling coefficients and wavelet coefficients and encoding the scaling coefficients and wavelet coefficients as well as the travel locus data by using the received encoding table data 95; and a travel locus transmitter 91 for transmitting the encoded data to the probe car collection system 80.

The probe car collection system 80 comprises: a travel locus receiver 83 for receiving travel data from the probe-car-mounted machine 90; an encoded data decoder 82 for decoding the received data by using the encoding table data 86; a measurement information data inverse transform section 87 for performing IDWT on the scaling coefficients and wavelet coefficients and converting each coefficient to its reciprocal to restore speed information; a travel locus measurement information utilization section 81 for utilizing the restored speed information and travel locus data; an encoding table selector 85 for selecting an encoding table to be provided to the probe-car-mounted machine 90 depending on the current position of the probe car; and an encoding table transmitter 84 for transmitting the selected encoding table to the probe car.

The local vehicle position determination section 93 of the probe-car-mounted machine 90 identifies the local vehicle position by using the information received by the GSP antenna 101 and information from the gyroscope 102. The sensor information collector 98 collects measurement values of speed information detected by the sensor A 106. The collected speed information is stored into the travel locus measurement information accumulating section 96 in association with the local vehicle position identified by the local vehicle position determination section 93.

The measurement information data converter 97 represents the measurement information accumulated in the travel locus measurement information accumulating section 96 by a function of distance from a measurement start point (reference position) on the travel road and generates sampling data of measurement information. The DWT encoder 92 performs DWT on the reciprocal of the sampling data to convert the speed information to scaling coefficients and wavelet coefficients and encodes the travel locus data and converted scaling coefficients and wavelet coefficients by using the received encoding table data 95. The encoded travel locus data and measurement information are transmitted to the probe car collection system 80. The probe-car-mounted machine 90 transmits the speed information in the order of scaling coefficients, high-order wavelet coefficients and low-order wavelet coefficients.

In the probe car collection system 80 which has received data, the encoded data decoder 82 decodes the encoded travel locus data and measurement information by using the encoding table data 86. The measurement information data inverse transform section 87 performs IDWT on the decoded scaling coefficients and wavelet coefficients and converts each coefficient to its reciprocal to restore speed information. The travel locus measurement information utilization section 81 utilizes the restored speed information for creation of traffic information on the road on which the probe car has traveled.

In this way, the traffic information providing method of the invention is also applicable to information to be uploaded from a probe-car-mounted machine. Even in case the data processing capability of the probe-car-mounted machine or transmission capacity is insufficient and only scaling coefficients and part of wavelet coefficients can be transmitted from the probe-car-mounted machine, the probe car collection system can restore rough measurement information on the road on which the probe car has traveled from the received information.

In the system according to each embodiment, the data of traffic information to be provided may be bit plane decomposed before being transmitted. Bit plane decomposition represents data in binary numbers and sequentially transmits all data in the order of MSB, second bit, third bit, and LSB, that is, beginning with the data having the largest number of digits. In this case, the receiving party can display rough traffic situation while information reception is under way.

While the invention has been detailed with reference to specific embodiments, those skilled in the art will appreciate that that various changes and modifications can be made in it without departing the spirit and scope thereof.

This patent application is based on Japanese Patent Application No. 2003-013746 filed Jan. 22, 2003, Japanese Patent Application No. 2003-014802 filed Jan. 23, 2003, and Japanese Patent Application No. 2003-286748 filed Aug. 15, 2003, the disclosure of which is incorporated herein by reference.

### INDUSTRIAL APPLICABILITY

As mentioned above, the traffic information providing method of the invention can approximately restore traffic information even in case the receiving party can receive only some of the information provided due to insufficient communications environment or data reception capability, or even in case only data in some of the layers is transmitted due to insufficient transmission capability of the sending party. In such a case, an overshoot or undershoot does not occur at data restoration. This makes it possible to perform proper approximation irrespective of whether the collected traffic data is coarse or minute.

In the traffic information providing system of the invention, the receiving party can restore coarse or minute information within the range of the received information even in case the party which provides traffic information has provided traffic information without considering the communications environment and reception state.

The traffic information providing apparatus and traffic information utilization apparatus of the invention can implement the system.

Thus, the traffic information providing method, traffic information providing system and apparatus therefor can be applied to provision of various information such as provision of traffic information such as congestion information and travel time and provision of measurement information from a probe car to a center. This facilitates restoration of information at the receiving party.

As understood from the foregoing description, the traffic information providing method of the invention allows the receiving party to approximately reproduce speed information at a low resolution even in case only part of the provided speed information is received by the receiving party due to insufficient communications environment or data reception capability, or even in case only data in some of the layers is transmitted due to insufficient transmission capability of the sending party. In this case, it is possible to restore speed information which well matches the level of congestion the driver is actually experiencing.

It is also possible to reduce noise without a value of information thus reducing the overall data volume of speed information.

In the traffic information providing system of the invention, the receiving party can restore coarse or minute speed information within the range of the received information even in case the party which provides speed information has provided speed information without considering the communications environment and reception state. The party which provides speed information can provide noise reduced speed information.

The traffic information providing apparatus and traffic information utilization apparatus of the invention can implement the system.

1-31. (canceled)

32. A traffic information providing method comprising:
performing discrete wavelet transform on traffic information represented by a function of distance from a reference position on a road to convert the traffic information to scaling coefficients and wavelet coefficients; and
providing the resulting information.

33. The traffic information providing method according to claim 32, further comprising generating sampling data based on the traffic information represented by the function of distance from the reference position and performing discrete wavelet transform on the sampling data.

34. The traffic information providing method according to claim 33, further comprising performing one or more discrete wavelet transform processes on the sampling data.

35. The traffic information providing method according to claim 32, further comprising providing the scaling coefficients earlier than the wavelet coefficients, and providing, among the wavelet coefficients, high-order wavelet coefficients earlier than low-order wavelet coefficients.

36. The traffic information providing method according to claim 32, further comprising performing bit plane decomposition on the scaling coefficients and wavelet coefficients and providing the resulting coefficients.

37. The traffic information providing method according to claim 36, further comprising appending copyright information to the low-order bits of the scaling coefficients or wavelet coefficients and providing the resulting coefficients.

38. The traffic information providing method according to claim 36, further comprising encrypting part of the bit planes of the bit-plane decomposed scaling coefficients and wavelet coefficients and providing the resulting coefficients.

39. The traffic information providing method according to claim 32, further comprising processing the wavelet coefficients having absolute values equal to or below a predetermined value as values of 0 and provides the coefficients.

40. The traffic information providing method according to claim 39, further comprising providing the scaling coefficients earlier than the wavelet coefficients and providing, among the wavelet coefficients, high-order wavelet coefficients earlier than low-order wavelet coefficients.

41. A traffic information providing method comprising:
performing discrete wavelet transform on traffic information represented by a function of time to convert the traffic information to scaling coefficients and wavelet coefficients; and
providing the resulting information.

42. The traffic information providing method according to claim 41, further comprising using the traffic information sampled at a fixed time pitch as sampling data and performing discrete wavelet transform on the sampling data.

43. The traffic information providing method according to claim 42, further comprising performing one or more discrete wavelet transform processes on the sampling data.

44. The traffic information providing method according to claim 41, further comprising providing the scaling coefficients earlier than the wavelet coefficients, and providing, among the wavelet coefficients, high-order wavelet coefficients earlier than low-order wavelet coefficients.

45. The traffic information providing method according to claim 41, further comprising performing bit plane decomposition on the scaling coefficients and wavelet coefficients and providing the resulting coefficients.

46. The traffic information providing method according to claim 45, further comprising appending copyright information to the low-order bits of the scaling coefficients or wavelet coefficients and providing the resulting coefficients.

47. The traffic information providing method according to claim 45, further comprising encrypting part of the bit planes of the bit-plane decomposed scaling coefficients and wavelet coefficients and providing the resulting coefficients.

48. The traffic information providing method according to claim 41, further comprising performing one or more to N discrete wavelet transform processes on the reciprocal multiplied by the constant.

49. The traffic information providing method according to claim 41, further comprising processing the wavelet coefficients having absolute values equal to or below a predetermined value as values of 0 and provides the coefficients.

50. The traffic information providing method according to claims 49, further comprising providing the scaling coefficients earlier than the wavelet coefficients and providing, among the wavelet coefficients, high-order wavelet coefficients earlier than low-order wavelet coefficients.

51. A traffic information providing system comprising:
a traffic information providing apparatus for generating sampling data from traffic information represented by a function of distance from a reference position on a road, performing one or more discrete wavelet transform processes on the sampling data to convert the traffic information to scaling coefficients and wavelet coefficients, and providing the coefficients; and
a traffic information utilization apparatus for performing one or more inverse discrete wavelet transform processes on the scaling coefficients and wavelet coefficients received from the traffic information providing apparatus to restore the traffic information.

52. The traffic information providing system according to claim 51, wherein the traffic information providing apparatus provides the scaling coefficients earlier than the wavelet coefficients and provides, among the wavelet coefficients, high-order wavelet coefficients earlier than low-order wavelet coefficients and the traffic information utilization apparatus performs inverse discrete wavelet transform on the scaling coefficients and the received wavelet coefficients to restore the traffic information.

53. The traffic information providing system according to claim 52, wherein the traffic information providing apparatus performs bit plane decomposition on the scaling coefficients and wavelet coefficients and provides the coefficients and the traffic information utilization apparatus starts to restore the traffic information on receiving the bit information of part of the bit-plane-decomposed scaling coefficients and wavelet coefficients.

54. The traffic information providing system according to claim 51, wherein the traffic information providing apparatus performs bit plane decomposition on the scaling coefficients and wavelet coefficients, appends copyright information to the low-order bits of the scaling coefficients or wavelet coefficients, and provides the coefficients, and the traffic information utilization apparatus deletes the copyright information appended to the scaling coefficients or wavelet coefficients and performs the inverse discrete wavelet transform.

55. The traffic information providing system according to claim 51, wherein the traffic information providing apparatus performs bit plane decomposition on the scaling coefficients and wavelet coefficients, encrypts some of the bit planes of the scaling coefficients or wavelet coefficients, and provides the coefficients and that the traffic information utilization apparatus decodes the encrypted scaling coefficients or wavelet coefficients and performs the inverse discrete wavelet transform.

56. The traffic information providing system according to claim 51, wherein the traffic information providing apparatus processes the wavelet coefficients having absolute values equal to or below a predetermined value as values of 0 and provides the coefficients.

57. The traffic information providing method according to claim 56, wherein the traffic information providing apparatus provides the scaling coefficients earlier than the wavelet coefficients and provides, among the wavelet coefficients, high-order wavelet coefficients earlier than low-order wavelet coefficients.

58. A traffic information providing system comprising:
a traffic information providing apparatus for using traffic information measured at a fixed time pitch as sampling data, performing one or more discrete wavelet transform processes on the sampling data to convert the traffic information to scaling coefficients and wavelet coefficients, and providing the coefficients; and
a traffic information utilization apparatus for performing one or more inverse discrete wavelet transform processes on the scaling coefficients and wavelet coefficients received from the traffic information providing apparatus to restore the traffic information.

59. The traffic information providing system according to claim 58, wherein the traffic information providing apparatus provides the scaling coefficients earlier than the wavelet coefficients and provides, among the wavelet coefficients, high-order wavelet coefficients earlier than low-order wavelet coefficients and the traffic information utilization apparatus performs inverse discrete wavelet transform on the scaling coefficients and the received wavelet coefficients to restore the traffic information.

60. The traffic information providing system according to claim 59, wherein the traffic information providing apparatus performs bit plane decomposition on the scaling coefficients and wavelet coefficients and provides the coefficients and the traffic information utilization apparatus starts to restore the traffic information on receiving the bit information of part of the bit-plane-decomposed scaling coefficients and wavelet coefficients.

61. The traffic information providing system according to claim 58, wherein the traffic information providing apparatus performs bit plane decomposition on the scaling coefficients and wavelet coefficients, appends copyright information to the low-order bits of the scaling coefficients or wavelet coefficients, and provides the coefficients, and the traffic information utilization apparatus deletes the copyright information appended to the scaling coefficients or wavelet coefficients and performs the inverse discrete wavelet transform.

62. The traffic information providing system according to claim 58, wherein the traffic information providing apparatus performs bit plane decomposition on the scaling coefficients and wavelet coefficients, encrypts some of the bit planes of the scaling coefficients or wavelet coefficients, and provides the coefficients and that the traffic information utilization apparatus decodes the encrypted scaling coefficients or wavelet coefficients and performs the inverse discrete wavelet transform.

63. The traffic information providing method according to claim 58, wherein the traffic information providing apparatus processes the wavelet coefficients having absolute values equal to or below a predetermined value as values of 0 and provides the coefficients.

64. The traffic information providing method according to claim 59, wherein the traffic information providing apparatus provides the scaling coefficients earlier than the wavelet coefficients and providing, among the wavelet coefficients, high-order wavelet coefficients earlier than low-order wavelet coefficients.

65. A traffic information providing apparatus comprising:
traffic information conversion means for generating sampling data from the collected traffic information data;
traffic information encoding means for performing one or more discrete wavelet transform processes on the sampling data to convert the traffic information to scaling coefficients and wavelet coefficients; and
traffic information transmission means for transmitting the scaling coefficients earlier than the wavelet coefficients and transmitting, among the wavelet coefficients, high-order wavelet coefficients earlier than low-order wavelet coefficients.

66. The traffic information providing method according to claim 65, further comprising means for processing the wavelet coefficients having absolute values equal to or below a predetermined value as values of 0 and provides the coefficients.

67. The traffic information providing method according to claim 66, further comprising means for providing the scaling coefficients earlier than the wavelet coefficients and providing, among the wavelet coefficients, high-order wavelet coefficients earlier than low-order wavelet coefficients.

68. Traffic information utilization apparatus comprising:
traffic information reception means for receiving from a traffic information providing apparatus road section reference data representing a target road of traffic information and scaling coefficients and wavelet coefficients as traffic information;
target road determination means for identifying the target road of the traffic information by using the road section reference data; and
traffic information decoding means for performing one or more inverse discrete wavelet transform processes on the scaling coefficients and wavelet coefficients in order to restore the traffic information.

69. The traffic information providing method according to claim 68, further comprising means for processing the wavelet coefficients having absolute values equal to or below a predetermined value as values of 0 and provides the coefficients.

70. The traffic information providing method according to claim 69, further comprising means for providing the scaling coefficients earlier than the wavelet coefficients and providing, among the wavelet coefficients, high-order wavelet coefficients earlier than low-order wavelet coefficients.

71. A traffic information providing method comprising:
performing discrete wavelet transform on a reciprocal of speed information represented by a function of distance from a reference position on a road to convert the reciprocal of the speed information to scaling coefficients and wavelet coefficients; and
providing the coefficients.

72. The traffic information providing method according to claim 71, further comprising generating 2N sampling data items or a multiple of the 2N sampling data items from the speed information represented by the function of distance from the reference position and performing discrete wavelet transform on the reciprocal of the sampling data.

73. The traffic information providing method according to claim 71, further comprising multiplying the reciprocal of the sampling data by a constant, performing discrete wavelet transform on the reciprocal multiplied by the constant to convert the inverses to scaling coefficients and wavelet coefficients, converting the scaling coefficients and wavelet coefficients to integers and providing the integers.

74. The traffic information providing method according to claim 73, further comprising switching magnitude of the constant in response to a speed limit of the target road or average vehicle travel speed.

75. The traffic information providing method according to claim 71, further comprising processing the wavelet coefficients having absolute values equal to or below a predetermined value as values of 0 and provides the coefficients.

76. The traffic information providing method according to claim 75, further comprising providing the scaling coefficients earlier than the wavelet coefficients and providing, among the wavelet coefficients, high-order wavelet coefficients earlier than low-order wavelet coefficients.

77. A traffic information providing system comprising:
traffic information providing apparatus for generating sampling data from speed information represented by a function of distance from a reference position on a road, performing one or more discrete wavelet transform processes on the reciprocal of the sampling data to convert the reciprocal of the speed information to scaling coefficients and wavelet coefficients, and providing the coefficients; and
traffic information utilization apparatus for performing one or more inverse discrete wavelet transform processes on the scaling coefficients and wavelet coefficients received from the traffic information providing apparatus, converting the obtained value to its reciprocal, and restoring the speed information.

78. The traffic information providing system according to claim 77, wherein the traffic information providing apparatus multiplies the reciprocals of the sampling data by a constant, performs inverse wavelet transform on the reciprocals multiplied by the constant to convert the reciprocals to scaling coefficients and wavelet coefficients, converts the scaling coefficients and wavelet coefficients to integers and provides the integers to the traffic information utilization apparatus and the traffic information utilization apparatus performs inverse discrete wavelet transform on the scaling coefficients and wavelet coefficients, multiplies the reciprocal of an obtained value by the constant, and restores the speed information.

79. The traffic information providing system according to claim 77, wherein the traffic information providing apparatus provides the scaling coefficients earlier than the wavelet coefficients and provides, among the wavelet coefficients, high-order wavelet coefficients earlier than low-order wavelet coefficients and the traffic information utilization apparatus performs inverse discrete wavelet transform on the scaling coefficients and the received wavelet coefficients, converts an obtained value to a reciprocal and restores the speed information.

80. The traffic information providing system according to claim 79, wherein the traffic information providing apparatus switches magnitude of the constant in response to a speed limit of the target road or average vehicle travel speed.

81. The traffic information providing system according to claim 77, wherein the traffic information providing apparatus processes the wavelet coefficients having absolute values equal to or below a predetermined value as values of 0 and provides the coefficients.

82. A traffic information providing apparatus comprising:
traffic information conversion means for generating 2N sampling data items or a multiple of the 2N sampling data items from collected speed information data;
traffic information encoding means for performing one or more discrete wavelet transform processes on reciprocals of the sampling data to convert the reciprocals to scaling coefficients and wavelet coefficients; and
traffic information transmission means for transmitting the scaling coefficients earlier than the wavelet coefficients and transmitting, among the wavelet coefficients, high-order wavelet coefficients earlier than low-order wavelet coefficients.

83. A traffic information utilization apparatus comprising:
traffic information reception means for receiving from a traffic information providing apparatus a road section reference data representing a target road of traffic information and scaling coefficients and wavelet coefficients as traffic information;
target road determination means for identifying the target road of the traffic information by using the road section reference data; and
traffic information decoding means for performing one or more inverse discrete wavelet transform processes on the scaling coefficients and wavelet coefficients, converting an obtained value to reciprocals, and restoring the speed information.
